(19) United States
(12) Patent Application Publication
(10) Pub. No.: US 2014/0213693 A1
(43) Pub. Date: Jul. 31, 2014

(54) RUBBER COMPOSITION AND STUDLESS TIRE

(71) Applicants: Takahiro Mabuchi, Kobe-shi (JP); Ryuichi Tokimune, Kobe-shi (JP); Kazuya Torita, Kobe-shi (JP)

(72) Inventors: Takahiro Mabuchi, Kobe-shi (JP); Ryuichi Tokimune, Kobe-shi (JP); Kazuya Torita, Kobe-shi (JP)

(73) Assignee: SUMITOMO RUBBER INDUSTRIES, LTD., Kobe-shi, Hyogo (JP)

(21) Appl. No.: 14/346,845

(22) PCT Filed: Jun. 26, 2012
(86) PCT No.: PCT/JP2012/066217

§ 371 Date: Mar. 24, 2014

(30) Foreign Application Priority Data
Nov. 24, 2011 (JP) 2011-256622
Nov. 24, 2011 (JP) 2011-256623
Nov. 24, 2011 (JP) 2011-256624

(51) Int. Cl. C08L 9/00; C08L 7/00

(52) U.S. Cl. CPC C08L 9/00; C08L 7/00
USPC 523/156

(57) ABSTRACT

Provided are a rubber composition capable of achieving a balanced improvement in performance on ice and snow, fuel economy, abrasion resistance, rubber strength, wet-grip performance, and dry handling stability, and a studless winter tire including the rubber composition. The present invention relates to a rubber composition including a specific conjugated diene polymer obtained by using a polymerization initiator represented by the formula (I) below, a high-cis polybutadiene having a cis microstructure content of not less than 95% by mass, a polyisoprene-based rubber, and a silica having a N₂SA of 40-400 m²/g, wherein the rubber composition includes, based on 100% by mass of a rubber component, 1-45% by mass of the conjugated diene polymer, 20-64% by mass of the high-cis polybutadiene, and 35-60% by mass of the polyisoprene-based rubber, and the rubber composition includes 5-150 parts by mass of the silica for each 100 parts by mass of the rubber component.

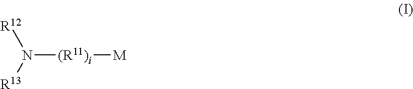

### TECHNICAL FIELD

The present invention relates to a rubber composition and a studless winter tire formed from the rubber composition.

### BACKGROUND ART

The use of spiked tires has been banned by law for the prevention of dust pollution caused by spiked tires. Thus, studless winter tires are now used instead of spiked tires in cold regions.

The grip performance of these studless winter tires on ice or snow may be enhanced by using a softer rubber to decrease the elastic modulus at low temperatures, thereby enhancing the traction. In particular, as the braking force on ice is greatly affected by the effective contact area between rubber and ice, flexible rubber needs to be used to increase the effective contact area.

However, simply reducing the hardness of rubber by, for example, using a larger amount of oil reduces the stiffness (rigidity) on ice or snow, unfortunately resulting in poor handling stability. Moreover, recent improvements in road construction lead to further demands for grip performance on not only ice or snow but also wet roads (wet-grip performance), handling stability on dry roads (dry handling stability), and fuel economy.

Not only for trucks, buses, and light trucks but also for passenger vehicles, typical rubbers for treads of studless winter tires are mainly based on natural rubber or polybutadiene rubber as such rubbers can achieve both flexibility at low temperatures and high strength. The combined use of natural rubber and polybutadiene rubber can improve the grip performance on ice or snow as well as fuel economy, abrasion resistance, and rubber strength; however, there still remains room for improvement in wet-grip performance and dry handling stability.

Moreover, Patent Literature 1 proposes a method for improving fuel economy and other properties by using a diene rubber (modified rubber) modified by an organosilicon compound containing an amino group and an alkoxy group. This method still has room for improvement in terms of the performance on ice and snow (e.g. grip performance, handling stability on ice and snow).

### CITATION LIST

### Patent Literature

Patent Literature 1: JP 2000-344955 A

### SUMMARY OF INVENTION

### Technical Problem

An object of the present invention is to solve the problems identified above by providing a rubber composition capable of not only improving performance on ice and snow, fuel economy, abrasion resistance, and rubber strength, but also achieving good wet-grip performance and dry handling stability, and by providing a studless winter tire including the rubber composition.

### Solution to Problem

The present invention relates to a rubber composition, including:

a conjugated diene polymer,

a high-cis polybutadiene having a cis microstructure content of not less than 95% by mass,

a polyisoprene-based rubber, and

a silica having a nitrogen adsorption specific surface area of 40 to 400 m²/g,

the conjugated diene polymer being obtained by polymerizing a monomer component including a conjugated diene compound and a silicon-containing vinyl compound in the presence of a polymerization initiator represented by the following formula (I):

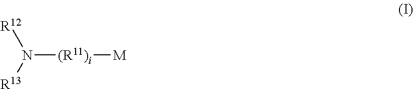

wherein i represents 0 or 1; R¹¹ represents a C₁₋₁₀₀ hydrocarbylene group; R¹² and R¹³ each represent an optionally substituted hydrocarbyl group or a trihydrocarbylsilyl group, or R¹² and R¹³ are bonded to each other to form a hydrocarbylene group optionally containing at least one, as a hetero atom, selected from the group consisting of a silicon atom, a nitrogen atom, and an oxygen atom; and M represents an alkali metal atom, to produce a copolymer, and

then reacting a compound containing at least one of a nitrogen atom and a silicon atom with an active terminal of the copolymer,

wherein the rubber composition includes, based on 100% by mass of a rubber component, 1 to 45% by mass of the conjugated diene polymer, 20 to 64% by mass of the high-cis polybutadiene, and 35 to 60% by mass of the polyisoprene-based rubber, and

the rubber composition includes 5 to 150 parts by mass of the silica for each 100 parts by mass of the rubber component.

R¹¹ in the formula (I) is preferably a group represented by the following formula (Ia):

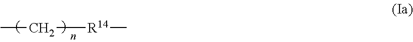

wherein R¹⁴ represents a hydrocarbylene group including at least one of a structural unit derived from a conjugated diene compound and a structural unit derived from an aromatic vinyl compound; and n represents an integer of 1 to 10.

R¹⁴ in the formula (Ia) is preferably a hydrocarbylene group including from one to ten isoprene-derived structural unit(s).

The silicon-containing vinyl compound is preferably a compound represented by the following formula (II):

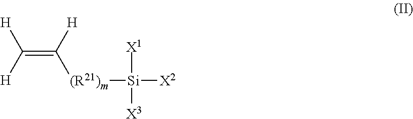

wherein m represents 0 or 1; R²¹ represents a hydrocarbylene group; and X¹, X², and X³ each represent a substituted amino group, a hydrocarbyloxy group, or an optionally substituted hydrocarbyl group.

The conjugated diene polymer preferably contains a structural unit derived from an aromatic vinyl compound.

The silica preferably includes silica (1) having a nitrogen adsorption specific surface area of at least 40 m²/g but less than 120 m²/g, and silica (2) having a nitrogen adsorption specific surface area of not less than 120 m²/g.

The rubber composition preferably includes a solid resin having a glass transition temperature of 60 to 120° C. in an amount of 1 to 30 parts by mass for each 100 parts by mass of the rubber component.

Preferably, the silica includes silica (1) having a nitrogen adsorption specific surface area of at least 40 m²/g but less than 120 m²/g, and silica (2) having a nitrogen adsorption specific surface area of not less than 120 m²/g, and the rubber composition includes a solid resin having a glass transition temperature of 60 to 120° C. in an amount of 1 to 30 parts by mass for each 100 parts by mass of the rubber component.

The rubber composition preferably includes a mercapto group-containing silane coupling agent in an amount of 0.5 to 20 parts by mass for each 100 parts by mass of the silica.

Preferably, the rubber composition includes a mercapto group-containing silane coupling agent in an amount of 0.5 to 20 parts by mass for each 100 parts by mass of the silica, and the silica includes silica (1) having a nitrogen adsorption specific surface area of at least 40 m²/g but less than 120 m²/g, and silica (2) having a nitrogen adsorption specific surface area of not less than 120 m²/g.

The rubber composition preferably includes a mercapto group-containing silane coupling agent in an amount of 0.5 to 20 parts by mass for each 100 parts by mass of the silica, and a solid resin having a glass transition temperature of 60 to 120° C. in an amount of 1 to 30 parts by mass for each 100 parts by mass of the rubber component.

Preferably, the rubber composition includes a mercapto group-containing silane coupling agent in an amount of 0.5 to 20 parts by mass for each 100 parts by mass of the silica, the silica includes silica (1) having a nitrogen adsorption specific surface area of at least 40 m²/g but less than 120 m²/g, and silica (2) having a nitrogen adsorption specific surface area of not less than 120 m²/g, and the rubber composition includes a solid resin having a glass transition temperature of 60 to 120° C. in an amount of 1 to 30 parts by mass for each 100 parts by mass of the rubber component.

Preferably, the rubber composition includes a mercapto group-containing silane coupling agent in an amount of 0.5 to 20 parts by mass for each 100 parts by mass of the silica, and the silane coupling agent is at least one of a compound represented by the formula (1) below, and a compound containing a linking unit A represented by the formula (2) below and a linking unit B represented by the formula (3) below,

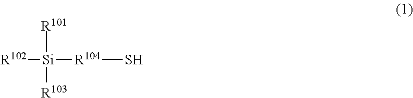

wherein R¹⁰¹ to R¹⁰³ each represent a branched or unbranched C₁₋₁₂ alkyl group, a branched or unbranched C₁₋₁₂ alkoxy group, or a group represented by —O—(R¹¹¹—O)_{z}—R¹¹² where z R¹¹¹s each represent a branched or unbranched C₁₋₃₀ divalent hydrocarbon group, and z R¹¹¹s may be the same as or different from one another; R¹¹² represents a branched or unbranched C₁₋₃₀ alkyl group, a branched or unbranched C₂₋₃₀ alkenyl group, a C₆₋₃₀ aryl group, or a C₇₋₃₀ aralkyl group; and z represents an integer of 1 to 30, and R¹⁰¹ to R¹⁰³ may be the same as or different from one another; and R¹⁰⁴ represents a branched or unbranched C₁₋₆ alkylene group;

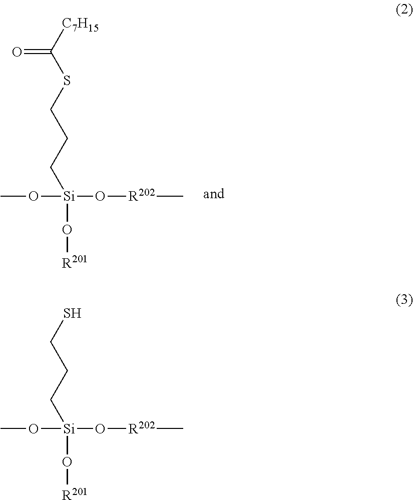

wherein R²⁰¹ represents a hydrogen atom, a halogen atom, a branched or unbranched C₁₋₃₀ alkyl group, a branched or unbranched C₂₋₃₀ alkenyl group, a branched or unbranched C₂₋₃₀ alkynyl group, or the alkyl group in which a terminal hydrogen atom is replaced with a hydroxy group or a carboxyl group; R²⁰² represents a branched or unbranched C₁₋₃₀ alkylene group, a branched or unbranched C₂₋₃₀ alkenylene group, or a branched or unbranched C₂₋₃₀ alkynylene group; and R²⁰¹ and R²⁰² may be joined together to form a cyclic structure.

Preferably, the silica includes silica (1) having a nitrogen adsorption specific surface area of at least 40 m²/g but less than 120 m²/g, and silica (2) having a nitrogen adsorption specific surface area of not less than 120 m²/g, and the nitrogen adsorption specific surface areas and amounts of the silica (1) and the silica (2) satisfy the following inequalities:

(Nitrogen adsorption specific surface area of silica (2))/(Nitrogen adsorption specific surface area of silica (1))≧1.4, and

(Amount of silica (1))×0.06≦(Amount of silica (2))≦(Amount of silica (1))×15.

The rubber composition is preferably for use in a tread of a studless winter tire.

The present invention also relates to a studless winter tire, formed from the rubber composition.

### Advantageous Effects of Invention

The rubber composition of the present invention is a rubber composition including specific amounts of a specific conjugated diene polymer, a high-cis polybutadiene having a cis microstructure content of not less than 95% by mass, a polyisoprene-based rubber, and a silica. Thus, the rubber composition enables to provide a studless winter tire capable of achieving a balanced improvement in performance on ice and snow, abrasion resistance, rubber strength, fuel economy, wet-grip performance, and dry handling stability.

### DESCRIPTION OF EMBODIMENTS

As used herein, a hydrocarbyl group denotes a monovalent group provided by removing one hydrogen atom from a hydrocarbon; a hydrocarbylene group denotes a divalent group provided by removing two hydrogen atoms from a hydrocarbon; a hydrocarbyloxy group denotes a monovalent group provided by replacing the hydrogen atom of a hydroxy group with a hydrocarbyl group; a substituted amino group denotes a group provided by replacing at least one hydrogen atom of an amino group with a monovalent atom other than a hydrogen atom or with a monovalent group, or denotes a group provided by replacing the two hydrogen atoms of an amino group with a divalent group; a hydrocarbyl group having a substituent (hereinafter, also referred to as substituted hydrocarbyl group) denotes a monovalent group provided by replacing at least one hydrogen atom of a hydrocarbyl group with a substituent; and a hydrocarbylene group containing a hetero atom (hereinafter, also referred to as hetero atom-containing hydrocarbylene group) denotes a divalent group provided by replacing a hydrogen atom and/or a carbon atom other than the carbon atoms from which a hydrogen atom has been removed in a hydrocarbylene group with a group containing a hetero atom (an atom other than carbon and hydrogen atoms).

The conjugated diene polymer in the present invention is obtained by

polymerizing a monomer component including a conjugated diene compound and a silicon-containing vinyl compound in the presence of a polymerization initiator represented by the following formula (I):

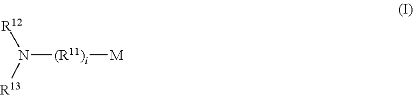

wherein i represents 0 or 1; R¹¹ represents a C₁₋₁₀₀ hydrocarbylene group; R¹² and R¹³ each represent an optionally substituted hydrocarbyl group or a trihydrocarbylsilyl group, or R¹² and R¹³ are bonded to each other to form a hydrocarbylene group optionally containing at least one, as a hetero atom, selected from the group consisting of a silicon atom, a nitrogen atom, and an oxygen atom; and M represents an alkali metal atom, to produce a copolymer, and

then reacting a compound containing a nitrogen atom and/or a silicon atom with an active terminal of the copolymer.

As used herein, the term “modifying” means bonding a copolymer derived from a diene compound alone or with an aromatic vinyl compound, to a compound other than the compounds. The above conjugated diene polymer has a structure in which the polymerization initiation terminal is modified by a polymerization initiator represented by the formula (I); the main chain is modified by copolymerization with a silicon-containing vinyl compound; and the termination terminal is modified by a compound containing a nitrogen atom and/or a silicon atom, a silicon-containing vinyl compound. The use of the conjugated diene polymer in combination with a high-cis polybutadiene having a cis microstructure content of not less than 95% by mass, and a polyisoprene-based rubber enables to disperse silica well while achieving both flexibility at low temperatures and high strength. This makes it possible to simultaneously improve not only the performance on ice and snow, abrasion resistance, rubber strength, and fuel economy, but also the wet-grip performance and dry handling stability, which are conventionally difficult to simultaneously improve. Moreover, the use of the conjugated diene polymer in which each of the initiation terminal, main chain and termination terminal is modified by a specific compound enables to synergistically enhance the effects of improving the properties. Due to these effects, balanced improvements in performance on ice and snow, abrasion resistance, rubber strength, fuel economy, wet-grip performance, and dry handling stability can be achieved at high levels.

In the formula (I), i is 0 or 1, and preferably 1.

R¹¹ in the formula (I) is a C₁₋₁₀₀ hydrocarbylene group, preferably a C₆₋₁₀₀ hydrocarbylene group, and more preferably a C₇₋₈₀ hydrocarbylene group. If R¹¹ has more than 100 carbon atoms, the polymerization initiator has an increased molecular weight, which may reduce the cost efficiency and the workability during the polymerization.

Plural kinds of compounds differing in the carbon number of R¹¹ may be used in combination as the polymerization initiator represented by the formula (I).

R¹¹ in the formula (I) is preferably a group represented by the following formula (Ia):

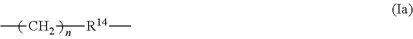

wherein R¹⁴ represents a hydrocarbylene group including a structural unit derived from a conjugated diene compound and/or a structural unit derived from an aromatic vinyl compound; and n represents an integer of 1 to 10.

R¹⁴ in the formula (Ia) represents a hydrocarbylene group including a structural unit derived from a conjugated diene compound and/or a structural unit derived from an aromatic vinyl compound, preferably a hydrocarbylene group including an isoprene-derived structural unit, and more preferably a hydrocarbylene group including from one to ten isoprene-derived structural unit(s).

The number of the structural unit derived from a conjugated diene compound and/or the structural unit derived from an aromatic vinyl compound in R¹⁴ preferably ranges from one to ten, and more preferably from one to five.

In the formula (Ia), n represents an integer of 1 to 10, and preferably an integer of 2 to 4.

Examples of R¹¹ include a group obtained by bonding from one to ten isoprene-derived structural unit(s) and a methylene group, a group obtained by bonding from one to ten isoprene-derived structural unit(s) and an ethylene group, and a group obtained by bonding from one to ten isoprene-derived structural unit(s) and a trimethylene group, preferably a group obtained by bonding from one to ten isoprene-derived structural unit(s) and a trimethylene group.

In the formula (I), R¹² and R¹³ each represent an optionally substituted hydrocarbyl group or a trihydrocarbylsilyl group, or R¹² and R¹³ are bonded to each other to form a hydrocarbylene group optionally containing an atom, as a hetero atom, selected from the group consisting of a silicon atom, a nitrogen atom, and an oxygen atom.

The optionally substituted hydrocarbyl group refers to a hydrocarbyl group or substituted hydrocarbyl group. The substituent in the substituted hydrocarbyl group may be a substituted amino group or a hydrocarbyloxy group. Examples of the hydrocarbyl groups include acyclic alkyl groups such as a methyl group, an ethyl group, an n-propyl group, an isopropyl group, an n-butyl group, an isobutyl group, a sec-butyl group, a tert-butyl group, an n-pentyl group, an n-hexyl group, an n-octyl group, and an n-dodecyl group; cyclic alkyl groups such as a cyclopentyl group and a cyclohexyl group; and aryl groups such as a phenyl group and a benzyl group, preferably acyclic alkyl groups, and more preferably C₁₋₄ acyclic alkyl groups. Examples of the substituted hydrocarbyl groups in which the substituent is a substituted amino group include an N,N-dimethylaminomethyl group, a 2-N,N-dimethylaminoethyl group, and a 3-N,N-dimethylaminopropyl group. Examples of the substituted hydrocarbyl groups in which the substituent is a hydrocarbyloxy group include a methoxymethyl group, a methoxyethyl group, and an ethoxymethyl group. Among the above examples, hydrocarbyl groups are preferred; C₁₋₄ acyclic alkyl groups are more preferred; and a methyl group or an ethyl group is still more preferred.

Examples of the trihydrocarbylsilyl groups include a trimethylsilyl group, and a tert-butyl-dimethylsilyl group. A trimethylsilyl group is preferred.

The hydrocarbylene group optionally containing at least one, as a hetero atom, selected from the group consisting of a silicon atom, a nitrogen atom, and an oxygen atom refers to a hydrocarbylene group, or a hetero atom-containing hydrocarbylene group in which the hetero atom is at least one selected from the group consisting of a silicon atom, a nitrogen atom and an oxygen atom. Examples of the hetero atom-containing hydrocarbylene groups in which the hetero atom is at least one selected from the group consisting of a silicon atom, a nitrogen atom and an oxygen atom include hetero atom-containing hydrocarbylene groups in which the hetero atom is a silicon atom, hetero atom-containing hydrocarbylene groups in which the hetero atom is a nitrogen atom, and hetero atom-containing hydrocarbylene groups in which the hetero atom is an oxygen atom. Examples of the hydrocarbylene groups include alkylene groups such as a tetramethylene group, a pentamethylene group, a hexamethylene group, a pent-2-ene-1,5-diyl group, and a 2,2,4-trimethylhexane-1,6-diyl group; and alkenediyl groups such as a pent-2-ene-1,5-diyl group, preferably alkylene groups, and more preferably C₄₋₇ alkylene groups. Examples of the hetero atom-containing hydrocarbylene groups in which the hetero atom is a silicon atom include a group represented by —Si(CH₃)₂—CH₂—CH₂—Si(CH₃)₂—. Examples of the hetero atom-containing hydrocarbylene groups in which the hetero atom is a nitrogen atom include a group represented by —CH═N—CH═CH— and a group represented by —CH═N—CH₂—CH₂—. Examples of the hetero atom-containing hydrocarbylene groups in which the hetero atom is an oxygen atom include a group represented by —CH₂—CH₂—O—CH₂—CH₂—. Among the above examples, hydrocarbylene groups are preferred; C₄₋₇ alkylene groups are more preferred; and a tetramethylene group, a pentamethylene group, and a hexamethylene group are still more preferred.

Preferably, each of R¹² and R¹³ is a hydrocarbyl group, or R¹² and R¹³ are bonded to each other to form a hydrocarbylene group. More preferably, each of R¹² and R¹³ is a C₁₋₄ acyclic alkyl group, or R¹² and R¹³ are bonded to each other to form a C₄₋₇ alkylene group. Still more preferably, each of R¹² and R¹³ is a methyl group or an ethyl group.

M in the formula (I) represents an alkali metal atom. Examples of the alkali metal atoms include Li, Na, K, and Cs, preferably Li.

The polymerization initiator represented by the formula (I) in which i is 1 may be a compound formed from one to five isoprene-derived structural unit(s) polymerized with an aminoalkyllithium compound. Examples of the aminoalkyllithium compounds include N,N-dialkylaminoalkyllithiums such as 3-(N,N-dimethylamino)-1-propyllithium, 3-(N,N-diethylamino)-1-propyllithium, 3-(N,N-di-n-butylamino)-1-propyllithium, 4-(N,N-dimethylamino)-1-butyllithium, 4-(N,N-diethylamino)-1-butyllithium, 4-(N,N-di-n-propylamino)-1-butyllithium, and 3-(N,N-di-n-butylamino)-1-butyllithium; hetero atom-free cyclic aminoalkyllithium compounds such as 3-(1-pyrrolidino)-1-propyllithium, 3-(1-piperidino)-1-propyllithium, 3-(1-hexamethyleneimino)-1-propyllithium, and 3-[1-(1,2,3,6-tetrahydropyridino)]-1-propyllithium; and hetero atom-containing cyclic aminoalkyllithium compounds such as 3-(1-morpholino)-1-propyllithium, 3-(1-imidazolyl)-1-propyllithium, 3-(4,5-dihydro-1-imidazolyl)-1-propyllithium, and 3-(2,2,5,5-tetramethyl-1-aza-2,5-disila-1-cyclopentyl)-1-propyllithium, preferably N,N-dialkylaminoalkyllithiums, and more preferably 3-(N,N-dimethylamino)-1-propyllithium or 3-(N,N-diethylamino)-1-propyllithium.

Examples of the polymerization initiators represented by the formula (I) in which i is 0 include lithium hexamethyleneimide, lithium pyrrolidide, lithium piperidide, lithium heptamethyleneimide, lithium dodecamethyleneimide, lithium dimethylamide, lithium diethylamide, lithium dipropylamide, lithium dibutylamide, lithium dihexylamide, lithium diheptylamide, lithium dioctylamide, lithium di-2-ethylhexylamide, lithium didecylamide, lithium-N-methylpiperadide, lithium ethylpropylamide, lithium ethylbutylamide, lithium methylbutylamide, lithium ethylbenzylamide, and lithium methylphenethylamide.

The polymerization initiator represented by the formula (I) in which i is 0 may be prepared in advance from a secondary amine and a hydrocarbyllithium compound before it is used in the polymerization reaction, or may be prepared in the polymerization system. Examples of the secondary amines include dimethylamine, diethylamine, dibutylamine, dioctylamine, dicyclohexylamine, and diisobutylamine. Other examples thereof include cyclic amines such as azacycloheptane (i.e. hexamethyleneimine), 2-(2-ethylhexyl)pyrrolidine, 3-(2-propyl)pyrrolidine, 3,5-bis(2-ethylhexyl)piperidine, 4-phenylpiperidine, 7-decyl-1-azacyclotridecane, 3,3-dimethyl-1-azacyclotetradecane, 4-dodecyl-1-azacyclooctane, 4-(2-phenylbutyl)-1-azacyclooctane, 3-ethyl-5-cyclohexyl-1-azacycloheptane, 4-hexyl-1-azacycloheptane, 9-isoamyl-1-azacycloheptadecane, 2-methyl-1-azacycloheptadec-9-ene, 3-isobutyl-1-azacyclododecane, 2-methyl-7-t-butyl-1-azacyclododecane, 5-nonyl-1-azacyclododecane, 8-(4-methylphenyl)-5-pentyl-3-azabicyclo[5.4.0]undecane, 1-butyl-6-azabicyclo[3.2.1]octane, 8-ethyl-3-azabicyclo[3.2.1]octane, 1-propyl-3-azabicyclo[3.2.2]nonane, 3-(t-butyl)-7-azabicyclo[4.3.0]nonane, and 1,5,5-trimethyl-3-azabicyclo[4.4.0]decane.

The polymerization initiator represented by the formula (I) is preferably a compound in which i is 1, more preferably a compound formed from one to five isoprene-derived structural unit(s) polymerized with an N,N-aminoalkyllithium, and still more preferably a compound formed from one to five isoprene-derived structural unit(s) polymerized with 3-(N,N-dimethylamino)-1-propyllithium or 3-(N,N-diethylamino)-1-propyllithium.

The amount of the polymerization initiator represented by the formula (1) to be used is preferably 0.01 to 15 mmol, and more preferably 0.1 to 10 mmol, for each 100 g of the monomer component used in the polymerization.

In the present invention, other polymerization initiators, such as n-butyllithium, may be used in combination, if necessary.

Examples of the conjugated diene compounds include 1,3-butadiene, isoprene, 1,3-pentadiene, 2,3-dimethyl-1,3-butadiene, 1,3-hexadiene, and myrcene. These may be used alone or two or more of these may be used in combination. In view of easy availability, the conjugated diene compound is preferably 1,3-butadiene or isoprene.

The silicon-containing vinyl compound is preferably a compound represented by the following formula (II):

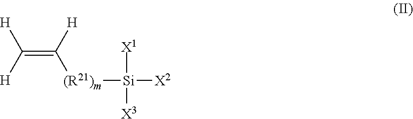

wherein m represents 0 or 1; R²¹ represents a hydrocarbylene group; and X¹, X², and X³ each represent a substituted amino group, a hydrocarbyloxy group, or an optionally substituted hydrocarbyl group.

In the formula (II), m is 0 or 1, and preferably 0.

The hydrocarbylene group in the formula (II) may be an alkylene group, an alkenediyl group, an arylene group, or a group in which an arylene group and an alkylene group are bonded. Examples of the alkylene groups include a methylene group, an ethylene group, and a trimethylene group. Examples of the alkenediyl groups include a vinylene group and an ethylene-1,1-diyl group. Examples of the arylene groups include a phenylene group, a naphthylene group, and a biphenylene group. Examples of the groups in which an arylene group and an alkylene group are bonded include a group in which a phenylene group and a methylene group are bonded, and a group in which a phenylene group and an ethylene group are bonded.

R²¹ is i preferably an arylene group, and more preferably a phenylene group.

In the formula (II), X¹, X² and X³ each represent a substituted amino group, a hydrocarbyloxy group, or an optionally substituted hydrocarbyl group. Preferably, at least one of X¹, X² and X³ is a substituted amino group. More preferably, two of X¹, X² and X³ are substituted amino groups.

In the formula (II), the substituted amino group is preferably a group represented by the following formula (IIa):

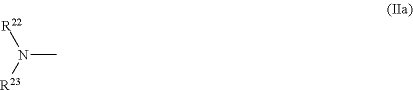

wherein R²² and R²³ each represent an optionally substituted hydrocarbyl group or a trihydrocarbylsilyl group, or R²² and R²³ are bonded to each other to form a hydrocarbylene group optionally containing a nitrogen atom and/or an oxygen atom as a hetero atom.

The optionally substituted hydrocarbyl group in the formula (IIa) refers to a hydrocarbyl group or a substituted hydrocarbyl group. The substituted hydrocarbyl group may be a substituted hydrocarbyl group in which the substituent is a hydrocarbyloxy group. Examples of the hydrocarbyl groups include acyclic alkyl groups such as a methyl group, an ethyl group, an n-propyl group, an isopropyl group, an n-butyl group, an isobutyl group, a sec-butyl group, a tert-butyl group, an n-pentyl group, an n-hexyl group, and an n-octyl group; cyclic alkyl groups such as a cyclopentyl group and a cyclohexyl group; and aryl groups such as a phenyl group, a benzyl group, and a naphthyl group, preferably acyclic alkyl groups, and more preferably a methyl group or an ethyl group. Examples of the substituted hydrocarbyl groups in which the substituent is a hydrocarbyloxy group include alkoxyalkyl groups such as a methoxymethyl group, an ethoxymethyl group, and a methoxyethyl group; and aryloxyalkyl groups such as a phenoxymethyl group.

Examples of the trihydrocarbylsilyl groups for the formula (IIa) include trialkylsilyl groups such as a trimethylsilyl group, a triethylsilyl group, and a tert-butyldimethylsilyl group.

The hydrocarbylene group optionally containing a nitrogen atom and/or an oxygen atom as a hetero atom in the formula (IIa) refers to a hydrocarbylene group, or a hetero atom-containing hydrocarbylene group in which the hetero atom is a nitrogen atom and/or an oxygen atom. The hetero atom-containing hydrocarbylene group in which the hetero atom is a nitrogen atom and/or an oxygen atom may be a hydrocarbylene group containing a nitrogen atom as a hetero atom, or a hydrocarbylene group containing an oxygen atom as a hetero atom. Examples of the hydrocarbylene groups include alkylene groups such as a trimethylene group, a tetramethylene group, a pentamethylene group, a hexamethylene group, a heptamethylene group, an octamethylene group, a decamethylene group, a dodecamethylene group, and a 2,2,4-trimethylhexane-1,6-diyl group; and alkenediyl groups such as a pent-2-ene-1,5-diyl group. Examples of the hetero atom-containing hydrocarbylene groups in which the hetero atom is a nitrogen atom include a group represented by —CH═N—CH═CH— and a group represented by —CH═N—CH₂—CH₂—. Examples of the hetero atom-containing hydrocarbylene groups in which the hetero atom is an oxygen atom include a group represented by —CH₂—CH₂—O—CH₂—CH₂—.

Preferably, each of R²² and R²³ is an alkyl group, or R²² and R²³ are bonded to each other to form an alkylene group. Each of R²² and R²³ is more preferably an alkyl group, and still more preferably a methyl group or an ethyl group.

Examples of the substituted amino groups represented by the formula (IIa) in which each of R²² and R²³ is a hydrocarbyl group include dialkylamino groups such as a dimethylamino group, a diethylamino group, an ethylmethylamino group, a di-n-propylamino group, a diisopropylamino group, a di-n-butylamino group, a diisobutylamino group, a di-sec-butylamino group, and a di-tert-butylamino group; and diarylamino groups such as a diphenylamino group, preferably dialkylamino groups, and more preferably a dimethylamino group, a diethylamino group, and a di-n-butylamino group. Examples of the substituted amino groups in which each of R²² and R²³ is a substituted hydrocarbyl group in which the substituent is a hydrocarbyloxy group include di(alkoxyalkyl)amino groups such as a di(methoxymethyl)amino group and a di(ethoxymethyl)amino group. Examples of the substituted amino groups in which R²² or R²³ is a trihydrocarbylsilyl group include trialkylsilyl group-containing amino groups such as a bis(trimethylsilyl)amino group, a bis(tert-butyldimethylsilyl)amino group, and an N-trimethylsilyl-N-methylamino group.

Examples of the substituted amino groups represented by the formula (IIa) in which R²² and R²³ are bonded to each other to form a hydrocarbylene group include 1-alkyleneimino groups such as a 1-trimethyleneimino group, a 1-pyrrolidino group, a 1-piperidino group, a 1-hexamethyleneimino group, a 1-heptamethyleneimino group, a 1-octamethyleneimino group, a 1-decamethyleneimino group, and a 1-dodecamethyleneimino group. Examples of the substituted amino groups with a hydrocarbylene group containing a nitrogen atom as a hetero atom include a 1-imidazolyl group and a 4,5-dihydro-1-imidazolyl group. Examples of the substituted amino groups with a hydrocarbylene group containing an oxygen atom as a hetero atom include a morpholino group.

The substituted amino group represented by the formula (IIa) is preferably a dialkylamino group or a 1-alkyleneimino group; more preferably a dialkylamino group; and still more preferably a dimethylamino group, a diethylamino group, or a di-n-butylamino group.

Examples of the hydrocarbyloxy groups for the formula (II) include alkoxy groups such as a methoxy group, an ethoxy group, an n-propoxy group, an isopropoxy group, an n-butoxy group, a sec-butoxy group, and a tert-butoxy group; and aryloxy groups such as a phenoxy group and a benzyloxy group.

The optionally substituted hydrocarbyl group in the formula (II) refers to a hydrocarbyl group or a substituted hydrocarbyl group. The substituted hydrocarbyl group may be a substituted hydrocarbyl group in which the substituent is a hydrocarbyloxy group. Examples of the hydrocarbyl groups include alkyl groups such as a methyl group, an ethyl group, an n-propyl group, an isopropyl group, an n-butyl group, a sec-butyl group, and a tert-butyl group; and aryl groups such as a phenyl group, a 4-methyl-1-phenyl group, and a benzyl group. Examples of the substituted hydrocarbyl groups in which the substituent is a hydrocarbyloxy group include alkoxyalkyl groups such as a methoxymethyl group, an ethoxymethyl group, and an ethoxyethyl group.

Examples of the silicon-containing vinyl compounds represented by the formula (II) in which one of X¹, X², and X³ is a substituted amino group, and m is 0 include:
(dialkylamino)dialkylvinylsilanes such as (dimethylamino)dimethylvinylsilane, (ethylmethylamino)dimethylvinylsilane, (di-n-propylamino)dimethylvinylsilane, (diisopropylamino)dimethylvinylsilane, (dimethylamino)diethylvinylsilane, (ethylmethylamino)diethylvinylsilane, (di-n-propylamino)diethylvinylsilane, and (diisopropylamino)diethylvinylsilane; [bis(trialkylsilyl)amino]dialkylvinylsilanes such as [bis(trimethylsilyl)amino]dimethylvinylsilane, [bis(t-butyldimethylsilyl)amino]dimethylvinylsilane, [bis(trimethylsilyl)amino]diethylvinylsilane, and [bis(t-butyldimethylsilyl)amino]diethylvinylsilane; (dialkylamino)di(alkoxyalkyl)vinylsilanes such as (dimethylamino)di(methoxymethyl)vinylsilane, (dimethylamino)di(methoxyethyl)vinylsilane, (dimethylamino)di(ethoxymethyl)vinylsilane, (dimethylamino)di(ethoxyethyl)vinylsilane, (diethylamino)di(methoxymethyl)vinylsilane, (diethylamino)di(methoxyethyl)vinylsilane, (diethylamino)di(ethoxymethyl)vinylsilane, and (diethylamino)di(ethoxyethyl)vinylsilane; and cyclic aminodialkylvinylsilane compounds such as pyrrolidinodimethylvinylsilane, piperidinodimethylvinylsilane, hexamethyleneiminodimethylvinylsilane, 4,5-dihydroimidazolyldimethylvinylsilane, and morpholinodimethylvinylsilane.

Examples of the silicon-containing vinyl compounds represented by the formula (II) in which one of X¹, X², and X³ is a substituted amino group, and m is 1 include:
(dialkylamino)dialkylvinylphenylsilanes such as (dimethylamino)dimethyl-4-vinylphenylsilane, (dimethylamino)dimethyl-3-vinylphenylsilane, (diethylamino)dimethyl-4-vinylphenylsilane, (diethylamino)dimethyl-3-vinylphenylsilane, (di-n-propylamino)dimethyl-4-vinylphenylsilane, (di-n-propylamino)dimethyl-3-vinylphenylsilane, (di-n-butylamino)dimethyl-4-vinylphenylsilane, (di-n-butylamino)dimethyl-3-vinylphenylsilane, (dimethylamino)diethyl-4-vinylphenylsilane, (dimethylamino)diethyl-3-vinylphenylsilane, (diethylamino)diethyl-4-vinylphenylsilane, (diethylamino)diethyl-3-vinylphenylsilane, (di-n-propylamino)diethyl-4-vinylphenylsilane, (di-n-propylamino)diethyl-3-vinylphenylsilane, (di-n-butylamino)diethyl-4-vinylphenylsilane, and (di-n-butylamino)diethyl-3-vinylphenylsilane.

Examples of the silicon-containing vinyl compounds represented by the formula (II) in which two of X¹, X², and X³ are substituted amino groups, and m is 0 include:
bis(dialkylamino)alkylvinylsilanes such as bis(dimethylamino)methylvinylsilane, bis(diethylamino)methylvinylsilane, bis(di-n-propylamino)methylvinylsilane, bis(di-n-butylamino)methylvinylsilane, bis(dimethylamino)ethylvinylsilane, bis(diethylamino)ethylvinylsilane, bis(di-n-propylamino)ethylvinylsilane, and bis(di-n-butylamino)ethylvinylsilane; bis[bis(trialkylsilyl)amino]alkylvinylsilanes such as bis[bis(trimethylsilyl)amino]methylvinylsilane, bis[bis(tert-butyldimethylsilyl)amino]methylvinylsilane, bis[bis(trimethylsilyl)amino]ethylvinylsilane, and bis[bis(tert-butyldimethylsilyl)amino]ethylvinylsilane; bis(dialkylamino)alkoxyalkylsilanes such as bis(dimethylamino)methoxymethylvinylsilane, bis(dimethylamino)methoxyethylvinylsilane, bis(dimethylamino)ethoxymethylvinylsilane, bis(dimethylamino)ethoxyethylvinylsilane, bis(diethylamino)methoxymethylvinylsilane, bis(diethylamino)methoxyethylvinylsilane, bis(diethylamino)ethoxymethylvinylsilane, and bis(dimethylamino)ethoxyethylvinylsilane; and bis(cyclic amino)alkylvinylsilane compounds such as bis(pyrrolidino)methylvinylsilane, bis(piperidino)methylvinylsilane, bis(hexamethyleneimino)methylvinylsilane, bis(4,5-dihydroimidazolyl)methylvinylsilane, and bis(morpholino)methylvinylsilane.

Examples of the silicon-containing vinyl compounds represented by the formula (II) in which two of X¹, X², and X³ are substituted amino groups, and m is 1 include bis(dialkylamino)alkylvinylphenylsilanes such as bis(dimethylamino)methyl-4-vinylphenylsilane, bis(dimethylamino)methyl-3-vinylphenylsilane, bis(diethylamino)methyl-4-vinylphenylsilane, bis(diethylamino)methyl-3-vinylphenylsilane, bis(di-n-propylamino)methyl-4-vinylphenylsilane, bis(di-n-propylamino)methyl-3-vinylphenylsilane, bis(di-n-butylamino)methyl-4-vinylphenylsilane, bis(di-n-butylamino)methyl-3-vinylphenylsilane, bis(dimethylamino)ethyl-4-vinylphenylsilane, bis(dimethylamino)ethyl-3-vinylphenylsilane, bis(diethylamino)ethyl-4-vinylphenylsilane, bis(diethylamino)ethyl-3-vinylphenylsilane, bis(di-n-propylamino)ethyl-4-vinylphenylsilane, bis(di-n-propylamino)ethyl-3-vinylphenylsilane, bis(di-n-butylamino)ethyl-4-vinylphenylsilane, and bis(di-n-butylamino)ethyl-3-vinylphenylsilane.

Examples of the silicon-containing vinyl compounds represented by the formula (II) in which the three of X¹, X², and X³ are substituted amino groups, and m is 0 include tris(dialkylamino)vinylsilanes such as tris(dimethylamino)vinylsilane, tris(diethylamino)vinylsilane, tris(di-n-propylamino)vinylsilane, and tris(di-n-butylamino)vinylsilane.

Examples of the silicon-containing vinyl compounds represented by the formula (II) in which the three of X¹, X², and X³ are substituted amino groups, and m is 1 include tris(dialkylamino)vinylphenylsilanes such as tris(dimethylamino)-4-vinylphenylsilane, tris(dimethylamino)-3-vinylphenylsilane, tris(diethylamino)-4-vinylphenylsilane, tris(diethylamino)-3-vinylphenylsilane, tris(di-n-propylamino)-4-vinylphenylsilane, tris(di-n-propylamino)-3-vinylphenylsilane, tris(di-n-butylamino)-4-vinylphenylsilane, and tris(di-n-butylamino)-3-vinylphenylsilane.

Examples of the silicon-containing vinyl compounds represented by the formula (II) in which each of X¹, X², and X³ is not a substituted amino group, and m is 0 include:
trialkoxyvinylsilanes such as trimethoxyvinylsilane, triethoxyvinylsilane, and tripropoxyvinylsilane; dialkoxyalkylvinylsilanes such as methyldimethoxyvinylsilane and methyldiethoxyvinylsilane; dialkoxyarylvinylsilanes such as di(tert-pentoxy)phenylvinylsilane and di(tert-butoxy)phenylvinylsilane; monoalkoxydialkylvinylsilanes such as dimethylmethoxyvinylsilane; monoalkoxydiarylvinylsilanes such as tert-butoxydiphenylvinylsilane and tert-pentoxydiphenylvinylsilane; monoalkoxyalkylarylvinylsilanes such as tert-butoxymethylphenylvinylsilane and tert-butoxyethylphenylvinylsilane; and substituted alkoxyvinylsilane compounds such as tris(β-methoxyethoxy)vinylsilane.

Other examples of the silicon-containing vinyl compounds include bis(trialkylsilyl)aminostyrenes such as 4-N,N-bis(trimethylsilyl)aminostyrene and 3-N,N-bis(trimethylsilyl)aminostyrene; and bis(trialkylsilyl)aminoalkylstyrenes such as 4-bis(trimethylsilyl)aminomethylstyrene, 3-bis(trimethylsilyl)aminomethylstyrene, 4-bis(trimethylsilyl)aminoethylstyrene, and 3-bis(trimethylsilyl)aminoethylstyrene.

The silicon-containing vinyl compound is preferably a compound represented by the formula (II), more preferably a compound represented by the formula (II) in which m is 0, and still more preferably a compound represented by the formula (II) in which two of X¹, X² and X³ are dialkylamino groups.

The silicon-containing vinyl compound is particularly preferably bis(dimethylamino)methylvinylsilane, bis(diethylamino)methylvinylsilane, or bis(di-n-butylamino)methylvinylsilane.

The amount of the silicon-containing vinyl compound used in the production of the conjugated diene polymer is preferably not less than 0.01% by mass, more preferably not less than 0.02% by mass, and still more preferably not less than 0.05% by mass, based on 100% by mass of the total amount of the monomer component used in the polymerization in terms of achieving a balanced enhancement in performance on ice and snow, abrasion resistance, rubber strength, fuel economy, wet-grip performance, and dry handling stability. The amount is preferably not more than 20% by mass, more preferably not more than 2% by mass, and still more preferably not more than 1% by mass in terms of increasing cost efficiency and rubber strength.

In the production of the conjugated diene polymer, the monomer component may further include polymerizable monomers, in addition to the conjugated diene compound and silicon-containing vinyl compound. Examples of these monomers include aromatic vinyl compounds, vinyl nitriles, and unsaturated carboxylic acid esters. Examples of the aromatic vinyl compounds include styrene, α-methylstyrene, vinyltoluene, vinylnaphthalene, divinylbenzene, trivinylbenzene, and divinylnaphthalene. Examples of the vinyl nitriles include acrylonitrile. Examples of the unsaturated carboxylic acid esters include methyl acrylate, ethyl acrylate, methyl methacrylate, and ethyl methacrylate. Aromatic vinyl compounds, more preferably styrene, are preferred among the above examples.

In the case where an aromatic vinyl compound is used in the production of the conjugated diene polymer, the amount of the aromatic vinyl compound based on 100% by mass of the combined amount of the conjugated diene compound and the aromatic vinyl compound is preferably not less than 10% by mass (the amount of the conjugated diene compound is not more than 90% by mass), and more preferably not less than 15% by mass (the amount of the conjugated diene compound is not more than 85% by mass). Moreover, from the viewpoint of the performance on ice and snow and fuel economy, the amount of the aromatic vinyl compound is preferably not more than 50% by mass (the amount of the conjugated diene compound is not less than 50% by mass), and more preferably not more than 45% by mass (the amount of the conjugated diene compound is not less than 55% by mass).

In the production of the conjugated diene polymer, polymerization is preferably performed in a hydrocarbon solvent. Hydrocarbon solvents do not inactivate the polymerization initiator represented by the formula (I). Examples of the hydrocarbon solvents include aliphatic hydrocarbons, aromatic hydrocarbons, and alicyclic hydrocarbons. Examples of the aliphatic hydrocarbons include propane, n-butane, iso-butane, n-pentane, iso-pentane, n-hexane, n-heptane, and n-octane. Examples of the aromatic hydrocarbons include benzene, toluene, xylene, and ethylbenzene. Examples of the alicyclic hydrocarbons include cyclopentane and cyclohexane. The hydrocarbon solvent may be a mixture of different components, such as industrial hexane. It is preferably a C₂₋₁₂ hydrocarbon.

The polymerization reaction may be performed in the presence of an agent for adjusting the vinyl bond content in conjugated diene units, or an agent for adjusting the distribution of a conjugated diene unit and a monomer unit based on a monomer other than conjugated dienes in conjugated diene polymer chains (hereinafter, referred to collectively as “adjusting agents”). Examples of the agents include ether compounds, tertiary amine compounds, and phosphine compounds. Examples of the ether compounds include cyclic ethers such as tetrahydrofuran, tetrahydropyran, and 1,4-dioxane; aliphatic monoethers such as diethyl ether and dibutyl ether; aliphatic diethers such as ethylene glycol dimethyl ether, ethylene glycol diethyl ether, ethylene glycol dibutyl ether, diethylene glycol diethyl ether, and diethylene glycol dibutyl ether; and aromatic ethers such as diphenyl ether and anisole. Examples of the tertiary amine compounds include triethylamine, tripropylamine, tributylamine, N,N,N′,N′-tetramethylethylenediamine, N,N-diethylaniline, pyridine, and quinoline. Examples of the phosphine compounds include trimethylphosphine, triethylphosphine, and triphenylphosphine. One or more of them may be used.

In the production of the conjugated diene polymer, the polymerization initiator may be supplied to a polymerization reactor before the monomer component is supplied to the polymerization reactor; or the polymerization initiator may be supplied to a polymerization reactor after the whole amount of the monomer component used in the polymerization is supplied to the polymerization reactor; or the polymerization initiator may be supplied to a polymerization reactor after a part of the monomer component used in the polymerization is supplied to the polymerization reactor. The polymerization initiator may be supplied at once or continuously to the polymerization reactor.

In the production of the conjugated diene polymer, the monomer component may be supplied at once, continuously, or intermittently to the polymerization reactor. Moreover, monomers may be supplied individually or simultaneously to the polymerization reactor.

In the production of the conjugated diene polymer, the polymerization temperature is usually 25 to 100° C., preferably 35 to 90° C., and more preferably 50 to 80° C. The polymerization time usually ranges from 10 minutes to 5 hours,

The conjugated diene polymer is obtained by polymerizing a monomer component including a conjugated diene compound and a silicon-containing vinyl compound in the presence of a polymerization initiator represented by the formula (I) to produce a copolymer, and then reacting a compound containing a nitrogen atom and/or a silicon atom with an active terminal of the copolymer (the active terminal of the copolymer is considered to contain an alkali metal derived from the polymerization initiator) (terminal modification reaction). More specifically, the conjugated diene polymer is obtained by adding the compound containing a nitrogen atom and/or a silicon atom to the polymerization solution and then mixing them. The amount of the compound containing a nitrogen atom and/or a silicon atom to be added to the polymerization solution is usually 0.1 to 3 mol, preferably 0.5 to 2 mol, and more preferably 0.7 to 1.5 mol, per mol of the alkali metal derived from the polymerization initiator represented by the formula (I).

The terminal modification reaction is usually performed at a temperature of 25 to 100° C., preferably 35 to 90° C., and more preferably 50 to 80° C. The time period for the reaction is usually 60 seconds to 5 hours, preferably 5 minutes to 1 hour, and more preferably 15 minutes to 1 hour.

Preferred examples of the compound containing a nitrogen atom and/or a silicon atom include compounds containing a nitrogen atom and a carbonyl group.

The compound containing a nitrogen atom and a carbonyl group is preferably a compound represented by the following formula (III):

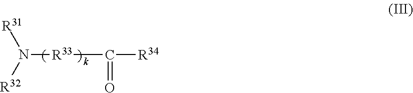

wherein R³¹ represents an optionally substituted hydrocarbyl group, or is joined to R³² to form a hydrocarbylene group optionally containing a nitrogen atom and/or an oxygen atom as a hetero atom, or is joined to R³⁴ to form a divalent group; R³² represents an optionally substituted hydrocarbyl group, or is joined to R³¹ to form a hydrocarbylene group optionally containing a nitrogen atom and/or an oxygen atom as a hetero atom; and R³⁴ represents an optionally substituted hydrocarbyl group or a hydrogen atom, or is joined to R³¹ to form a divalent group; R³³ represents a divalent group; and k represents 0 or 1.

In the formula (III), the optionally substituted hydrocarbyl group for R³¹, R³² or R³⁴ refers to a hydrocarbyl group or a substituted hydrocarbyl group. The substituted hydrocarbyl group may be a substituted hydrocarbyl group in which the substituent is a hydrocarbyloxy group, or a substituted hydrocarbyl group in which the substituent is a substituted amino group. Examples of the hydrocarbyl groups include alkyl groups such as a methyl group, an ethyl group, an n-propyl group, an isopropyl group, and an n-butyl group; alkenyl groups such as a vinyl group, an allyl group, and an isopropenyl group; and aryl groups such as a phenyl group. Examples of the substituted hydrocarbyl groups in which the substituent is a hydrocarbyloxy group include alkoxyalkyl groups such as a methoxymethyl group, an ethoxymethyl group, and an ethoxyethyl group. Examples of the substituted hydrocarbyl groups in which the substituent is a substituted amino group include (N,N-dialkylamino)alkyl groups such as a 2-(N,N-dimethylamino)ethyl group, a 2-(N,N-diethylamino)ethyl group, a 3-(N,N-dimethylamino)propyl group, and a 3-(N,N-diethylamino)propyl group; (N,N-dialkylamino)aryl groups such as a 4-(N,N-dimethylamino)phenyl group, a 3-(N,N-dimethylamino)phenyl group, a 4-(N,N-diethylamino)phenyl group, and a 3-(N,N-diethylamino)phenyl group; (N,N-dialkylamino)alkylaryl groups such as a 4-(N,N-dimethylamino)methylphenyl group and a 4-(N,N-dimethylamino)ethylphenyl group; cyclic amino group-containing alkyl groups such as a 3-pyrrolidinopropyl group, a 3-piperidinopropyl group, and a 3-imidazolylpropyl group; cyclic amino group-containing aryl groups such as a 4-pyrrolidinophenyl group, a 4-piperidinophenyl group, and a 4-imidazolylphenyl group; and cyclic amino group-containing alkylaryl groups such as a 4-pyrrolidinoethylphenyl group, a 4-piperidinoethylphenyl group, and a 4-imidazolylethylphenyl group.

In the formula (III), the hydrocarbylene group optionally containing a nitrogen atom and/or an oxygen atom as a hetero atom, formed by joining R³¹ and R³² refers to a hydrocarbylene group or a hetero atom-containing hydrocarbylene group in which the hetero atom is a nitrogen atom and/or an oxygen atom. The hetero atom-containing hydrocarbylene group in which the hetero atom is a nitrogen atom and/or an oxygen atom may be a hetero atom-containing hydrocarbylene group in which the hetero atom is a nitrogen atom or a hetero atom-containing hydrocarbylene group in which the hetero atom is an oxygen atom. Examples of the hydrocarbylene groups include alkylene groups such as a trimethylene group, a tetramethylene group, a pentamethylene group, a hexamethylene group, a pentan-2-en-1,5-diyl group, and a 2,2,4-trimethylhexane-1,6-diyl group; and arylene groups such as a 1,4-phenylene group. Examples of the hetero atom-containing hydrocarbylene groups in which the hetero atom is a nitrogen atom include a group represented by —CH═N—CH═CH— and a group represented by —CH═N—CH₂—CH₂—. Examples of the hetero atom-containing hydrocarbylene groups in which the hetero atom is an oxygen atom include groups represented by —(CH₂)ₛ—O—(CH₂)ₜ— where s and t each represent an integer of 1 or more.

In the formula (III), each of the divalent group formed by joining R³¹ and R³⁴, and the divalent group for R³³ may be a hydrocarbylene group, a hetero atom-containing hydrocarbylene group in which the hetero atom is a nitrogen atom, a hetero atom-containing hydrocarbylene group in which the hetero atom is an oxygen atom, a group in which a hydrocarbylene group and an oxygen atom are bonded, or a group in which a hydrocarbylene group and a group represented by —NR³⁵— (wherein R³⁵ represents a hydrocarbyl group or a hydrogen atom) are bonded. Examples of the hydrocarbylene groups include alkylene groups such as a trimethylene group, a tetramethylene group, a pentamethylene group, a hexamethylene group, a pentan-2-en-1,5-diyl group, and a 2,2,4-trimethylhexane-1,6-diyl group; and arylene groups such as a 1,4-phenylene group. Examples of the hetero atom-containing hydrocarbylene groups in which the hetero atom is a nitrogen atom include a group represented by —CH—N—CH═CH— and a group represented by —CH═N—CH₂—CH₂—. Examples of the hetero atom-containing hydrocarbylene groups in which the hetero atom is an oxygen atom include groups represented by —(CH₂)₅—O—(CH₂)ₜ— where s and t each represent an integer of 1 or more. Examples of the groups in which a hydrocarbylene group and an oxygen atom are bonded include groups represented by —(CH₂)ᵣ—O— where r represents an integer of 1 or more. Examples of the groups in which a hydrocarbylene group and a group represented by —NR³⁵— (wherein R³⁵ represents a hydrocarbyl group or a hydrogen atom) are bonded include groups represented by —(CH₂)ₚ—NR³⁵— where R³⁵ represents a hydrocarbyl group (preferably a C₁₋₆ hydrocarbyl group), or a hydrogen atom; and p represents an integer of 1 or more.

Preferred examples of the compound represented by the formula (III) include compounds represented by the formula

(III) in which k is 0, and R³⁴ is an optionally substituted hydrocarbyl group or a hydrogen atom, represented by the following formula (IIIa):

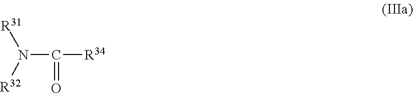

wherein R³¹ represents an optionally substituted hydrocarbyl group, or is joined to R³² to form a hydrocarbylene group optionally containing a nitrogen atom and/or an oxygen atom as a hetero atom; R³² represents an optionally substituted hydrocarbyl group, or is joined to R³¹ to form a hydrocarbylene group optionally containing a nitrogen atom and/or an oxygen atom as a hetero atom; and R³⁴ represents an optionally substituted hydrocarbyl group or a hydrogen atom.

In the formula (IIIa), the description and examples of the optionally substituted hydrocarbyl group for R³¹, R³² or R³⁴, and the hydrocarbylene group optionally containing a nitrogen atom and/or an oxygen atom as a hetero atom, formed by joining R³¹ and R³², are the same as described for the formula (III).

In the formula (IIIa), preferably, R³¹ is a C₁₋₁₀ hydrocarbyl group, or is joined to R³² to form a C₃₋₁₀ hydrocarbylene group or a hetero atom-containing C₃₋₁₀ hydrocarbylene group in which the hetero atom is a nitrogen atom. More preferably, R³¹ is a C₁₋₁₀ alkyl group or a C₆₋₁₀ aryl group, or is joined to R³² to form a C₃₋₁₀ alkylene group, a group represented by —CH═N—CH═CH—, or a group represented by —CH═N—CH₂—CH₂—. R³¹ is still more preferably a C₁₋₆ alkyl group, and particularly preferably a methyl group or an ethyl group.

In the formula (IIIa), preferably, R³² is a C₁₋₁₀ hydrocarbyl group, or is joined to R³¹ to form a C₃₋₁₀ hydrocarbylene group or a hetero atom-containing C₃₋₁₀ hydrocarbylene group in which the hetero atom is a nitrogen atom. More preferably, R³² is a C₁₋₁₀ alkyl group or a C₆₋₁₀ aryl group, or is joined to R³¹ to form a C₃₋₁₀ alkylene group, a group represented by —CH═N—CH═CH—, or a group represented by —CH═N—CH₂—CH₂—. R³² is still more preferably a C₁₋₆ alkyl group, and particularly preferably a methyl group or an ethyl group.

In the formula (IIIa), R³⁴ is preferably a hydrocarbyl group or a hydrogen atom, more preferably a C₁₋₁₀ hydrocarbyl group or a hydrogen atom, still more preferably a C₁₋₆ alkyl group or a hydrogen atom, and particularly preferably a hydrogen atom, a methyl group or an ethyl group.

Examples of the compounds represented by the formula (IIIa) in which R³⁴ is a hydrocarbyl group include N,N-dihydrocarbylacetamides such as N,N-dimethylacetamide, N,N-diethylacetamide, and N-methyl-N-ethylacetamide; N,N-dihydrocarbylacrylamides such as N-dimethylacrylamide, N,N-diethylacrylamide, and N-methyl-N-ethylacrylamide; and N,N-dihydrocarbylmethacrylamides such as N,N-dimethylmethacrylamide, N,N-diethylmethacrylamide, and N-methyl-N-ethylmethacrylamide.

Examples of the compounds represented by the formula (IIIa) in which R³⁴ is a hydrogen atom include N,N-dihydrocarbylformamides such as N,N-dimethylformamide, N,N-dimethylformamide, and N-methyl-N-ethylformamide.

Preferred examples of the compound represented by the formula (III) include compounds represented by the formula (III) in which k is 0, and R³⁴ is joined to R³¹ to form a divalent group, represented by the following formula (IIIb):

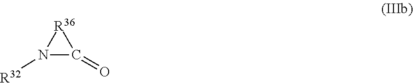

wherein R³² represents an optionally substituted hydrocarbyl group; and R³⁶ represents a hydrocarbylene group, or a group in which a hydrocarbylene group and a group represented by —NR³⁵— are bonded, where R³⁵ represents a hydrocarbyl group or a hydrogen atom.

In the formula (IIIb), the description and examples of the optionally substituted hydrocarbyl group for R³² are the same as described for the formula (III).

In the formula (IIIb), examples of the hydrocarbylene groups for R³⁶ include alkylene groups such as a trimethylene group, a tetramethylene group, a pentamethylene group, a hexamethylene group, a pentan-2-en-1,5-diyl group, and a 2,2,4-trimethylhexane-1,6-diyl group; and arylene groups such as a 1,4-phenylene group. Examples of the groups in which a hydrocarbylene group and a group represented by —NR³⁵— (wherein R³⁵ represents a hydrocarbyl group or a hydrogen atom) are bonded for R³⁶ include groups represented by —(CH₂)ₚ—NR³⁵— where R³⁵ represents a hydrocarbyl group or a hydrogen atom, and p represents an integer of 1 or more.

In the formula (IIIb), R³² is preferably a C₁₋₁₀ hydrocarbyl group, more preferably a C₁₋₁₀ alkyl group or a C₆₋₁₀ aryl group, still more preferably a C₁₋₆ alkyl group or a phenyl group, and particularly preferably a methyl group, an ethyl group, or a phenyl group.

In the formula (IIIb), R³⁶ is preferably a C₁₋₁₀ hydrocarbylene group, or a group in which a C₁₋₁₀ hydrocarbylene group and a group represented by —NR³⁵— (wherein R³⁵ represents a hydrocarbyl group (preferably a hydrocarbyl group) or a hydrogen atom) are bonded, more preferably a C₃₋₆ alkylene group or a group represented by —(CH₂)ₚ—NR³⁵— (wherein R³⁵ represents a hydrocarbyl group (preferably a C₁₋₁₀ hydrocarbyl group), and p represents an integer of 1 or more (preferably an integer of 2 to 5)), and further preferably a trimethylene group, a tetramethylene group, a pentamethylene group, or a group represented by —(CH₂)₂—N(CH₃)—.

Examples of the compounds represented by the formula (IIIb) in which R³⁶ is a hydrocarbylene group include N-hydrocarbyl-β-propiolactams such as N-methyl-β-propiolactam and N-phenyl-β-propiolactam; N-hydrocarbyl-2-pyrrolidones such as N-methyl-2-pyrrolidone, N-vinyl-2-pyrrolidone, N-phenyl-2-pyrrolidone, N-tert-butyl-2-pyrrolidone, and N-methyl-5-methyl-2-pyrrolidone; N-hydrocarbyl-2-piperidones such as N-methyl-2-piperidone, N-vinyl-2-piperidone, and N-phenyl-2-piperidone; N-hydrocarbyl-ε-caprolactams such as N-methyl-ε-caprolactam and N-phenyl-ε-caprolactam; and N-hydrocarbyl-ω-laurilolactams such as N-methyl-ω-laurilolactam and N-vinyl-ω-laurilolactam. N-phenyl-2-pyrrolidone and N-methyl-ε-caprolactam are preferred among the above examples.

Examples of the compounds represented by the formula (IIIb) in which R³⁶ is a group in which a hydrocarbylene group and a group represented by —NR³⁵— (wherein R³⁵ represents a hydrocarbyl group or a hydrogen atom) are bonded include 1,3-dihydrocarbyl-2-imidazolidinones such as 1,3-dimethyl-2-imidazolidinone, 1,3-diethyl-2-imidazolidinone, 1,3-divinyl-2-imidazolidinone, and 1-methyl-3-ethyl-2-imidazolidinone. Preferred among the above examples is 1,3-dimethyl-2-imidazolidinone.

Preferred examples of the compound represented by the formula (III) include compounds represented by the formula (III) in which k is 1, and R³³ is a hydrocarbylene group, represented by the following formula (IIIc):

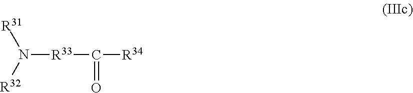

wherein R³¹ represents an optionally substituted hydrocarbyl group, or is joined to R³² to form a hydrocarbylene group optionally containing a nitrogen atom and/or an oxygen atom as a hetero atom; R³² represents an optionally substituted hydrocarbyl group, or is joined to R³¹ to form a hydrocarbylene group optionally containing a nitrogen atom and/or an oxygen atom as a hetero atom; R³³ represents a hydrocarbylene group; and R³⁴ represents an optionally substituted hydrocarbyl group or a hydrogen atom.

In the formula (IIIc), the description and examples of the optionally substituted hydrocarbyl group for R³¹, R³² or R³⁴, the hydrocarbylene group optionally containing a nitrogen atom and/or an oxygen atom as a hetero atom, formed by joining R³¹ and R³², and the hydrocarbylene group for R³³ are the same as described for the formula (III).

In the formula (IIIc), R³³ is preferably a C₁₋₁₀ hydrocarbylene group, more preferably a C₁₋₁₀ alkylene group or a C₆₋₁₀ arylene group, still more preferably a C₁₋₆ alkylene group or a phenylene group, and particularly preferably an ethylene group, a trimethylene group, or a 1,4-phenylene group.

In the formula (IIIc), R³⁴ is preferably a C₁₋₁₀ hydrocarbyl group, or a substituted C₁₋₁₀ hydrocarbyl group in which the substituent is a dialkylamino group, more preferably a C₁₋₆ alkyl group, a C₆₋₁₀ aryl group, a C₁₋₆ dialkylaminoalkyl group, or a C₆₋₁₀ dialkylaminoaryl group, and still more preferably a methyl group, an ethyl group, a phenyl group, a 3-dimethylaminoethyl group, or a 4-diethylaminophenyl group.

In the formula (IIIc), preferably, R³¹ is a C₁₋₁₀ hydrocarbyl group, or is joined to R³² to form a C₃₋₁₀ hydrocarbylene group, or a hetero atom-containing C₃₋₁₀ hydrocarbylene group in which the hetero atom is a nitrogen atom or an oxygen atom. More preferably, R³¹ is a C₁₋₁₀ alkyl group or a C₆₋₁₀ aryl group, or is joined to R³² to form a C₃₋₁₀ alkylene group, a group represented by —CH═N—CH═CH—, a group represented by —CH═N—CH₂—CH₂—, or a group represented by —(CH₂)₂—O—(CH₂)₂—. Still more preferably, R³¹ is a C₁₋₆ alkyl group, or is joined to R³² to form a C₃₋₆ alkylene group, a group represented by —CH═N—CH═CH—, or a group represented by —CH═N—CH₂—CH₂—. Particularly preferably, R³¹ is a methyl group or an ethyl group, or is joined to R³² to form a tetramethylene group, a hexamethylene group, or a group represented by —CH═N—CH═CH—.

In the formula (IIIc), preferably, R³² is a C₁₋₁₀ hydrocarbyl group, or is joined to R³¹ to form a C₃₋₁₀ hydrocarbylene group, or a hetero atom-containing C₃₋₁₀ hydrocarbylene group in which the hetero atom is a nitrogen atom or an oxygen atom. More preferably, R³² is a C₁₋₁₀ alkyl group or a C₆₋₁₀ aryl group, or is joined to R³¹ to form a C₃₋₁₀ alkylene group, a group represented by —CH═N—CH═CH—, a group represented by —CH═N—CH₂—CH₂—, or a group represented by —(CH₂)₂—O—(CH₂)₂—. Still more preferably, R³² is a C₁₋₆ alkyl group, or is joined to R³¹ to form a C₃₋₆ alkylene group, a group represented by —CH═N—CH═CH—, or a group represented by —CH═N—CH₂—CH₂—. Particularly preferably, R³² is a methyl group or an ethyl group, or is joined to R³¹ to form a tetramethylene group, a hexamethylene group, or a group represented by —CH═N—CH═CH—.

Examples of the compounds represented by the formula (IIIc) in which R³⁴ is a hydrocarbyl group include 4-N,N-dihydrocarbylaminoacetophenones such as 4-(N,N-dimethylamino)acetophenone, 4-N-methyl-N-ethylaminoacetophenone, and 4-N,N-diethylaminoacetophenone; and 4-cyclic-aminoacetophenone compounds such as 4′-(imidazol-1-yl)acetophenone and 4-pyrazolylacetophenone. Preferred among the above examples are 4-cyclic-aminoacetophenone compounds, with 4′-(imidazol-1-yl)acetophenone being more preferred.

Examples of the compounds represented by the formula (IIIc) in which R³⁴ is a substituted hydrocarbyl group include bis(dihydrocarbylaminoalkyl)ketones such as 1,7-bis(methylethylamino)-4-heptanone and 1,3-bis(diphenylamino)-2-propanone; 4-(dihydrocarbylamino)benzophenones such as 4-N,N-dimethylaminobenzophenone, 4-N,N-di-t-butylaminobenzophenone, and 4-N,N-diphenylaminobenzophenone; and 4,4′-bis(dihydrocarbylamino)benzophenones such as 4,4′-bis(dimethylamino)benzophenone, 4,4′-bis(diethylamino)benzophenone, and 4,4′-bis(diphenylamino)benzophenone. Preferred among the above examples are 4,4′-bis(dihydrocarbylamino)benzophenones, with 4,4′-bis(diethylamino)benzophenone being more preferred.

Preferred examples of the compound represented by the formula (III) include compounds represented by the formula (III) in which k is 1, and R³³ is a group in which a hydrocarbylene group and an oxygen atom are bonded, or a group in which a hydrocarbylene group and a group represented by —NR³⁵— (wherein R³⁵ represents a hydrocarbyl group or a hydrogen atom) are bonded, represented by the following formula (IIId):

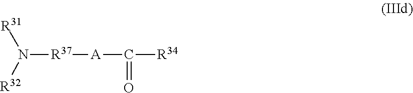

wherein R³¹ represents an optionally substituted hydrocarbyl group, or is joined to R³² to form a hydrocarbylene group optionally containing a nitrogen atom and/or an oxygen atom as a hetero atom; R³² represents an optionally substituted hydrocarbyl group, or is joined to R³¹ to form a hydrocarbylene group optionally containing a nitrogen atom and/or an oxygen atom as a hetero atom; R³⁷ represents a hydrocarbylene group; A represents an oxygen atom or —NR³⁵— wherein R³⁵ represents a hydrocarbyl group or a hydrogen atom; and R³⁴ represents an optionally substituted hydrocarbyl group or a hydrogen atom.

In the formula (IIId), the description and examples of the optionally substituted hydrocarbyl group for R³¹, R³² or R³⁴, and the hydrocarbylene group optionally containing a nitrogen atom and/or an oxygen atom as a hetero atom, formed by joining R³¹ and R³², are the same as described for the formula (III). The hydrocarbyl group for R³⁵ is as described for the hydrocarbyl group for R³¹, R³², or R³⁴.

In the formula (IIId), A is preferably an oxygen atom or a group represented by —NR³⁵— (wherein R³⁵ is a hydrocarbyl group (preferably a C₁₋₅ hydrocarbyl group) or a hydrogen atom), more preferably an oxygen atom or a group represented by —NH—, and still more preferably a group represented by —NH—.

In the formula (IIId), examples of the hydrocarbylene groups for R³⁷ include alkylene groups such as a trimethylene group, a tetramethylene group, a pentamethylene group, a hexamethylene group, a pentan-2-en-1,5-diyl group, and a 2,2,4-trimethylhexane-1,6-diyl group; and arylene groups such as a 1,4-phenylene group.

In the formula (IIId), R³⁴ is preferably a C₁₋₁₀ hydrocarbyl group, more preferably a C₂₋₅ alkenyl group, and still more preferably a vinyl group.

In the formula (IIId), R³⁷ is preferably a C₁₋₁₀ hydrocarbylene group, more preferably a C₁₋₆ alkylene group, still more preferably an ethylene group or a trimethylene group, and particularly preferably a trimethylene group.

In the formula (IIId), preferably, R³¹ is a C₁₋₁₀ hydrocarbyl group, or is joined to R³² to form a C₃₋₁₀ hydrocarbylene group, or a hetero atom-containing C₃₋₁₀ hydrocarbylene group in which the hetero atom is a nitrogen atom or an oxygen atom. More preferably, R³¹ is a C₁₋₁₀ alkyl group or a C₆₋₁₀ aryl group, or is joined to R³² to form a C₃₋₁₀ alkylene group, a group represented by —CH═N—CH═CH—, a group represented by —CH═N—CH₂—CH₂—, or a group represented by —(CH₂)₂—O—(CH₂)₂—. Still more preferably, R³¹ is a C₁₋₆ alkyl group, or is joined to R³² to form a C₃₋₆ alkylene group, a group represented by —CH═N—CH═CH—, or a group represented by —CH═N—CH₂—CH₂—. Particularly preferably, R³¹ is a methyl group or an ethyl group, or is joined to R³² to form a tetramethylene group, a hexamethylene group, or a group represented by —CH═N—CH═CH—.

In the formula (IIId), preferably, R³² is a C₁₋₁₀ hydrocarbyl group, or is joined to R³¹ to form a C₃₋₁₀ hydrocarbylene group, or a hetero atom-containing C₃₋₁₀ hydrocarbylene group in which the hetero atom is a nitrogen atom or an oxygen atom. More preferably, R³² is a C₁₋₁₀ alkyl group or a C₆₋₁₀ aryl group, or is joined to R³¹ to form a C₃₋₁₀ alkylene group, a group represented by —CH═N—CH═CH—, a group represented by —CH═N—CH₂—CH₂—, or a group represented by —(CH₂)₂O—(CH₂)₂—. Still more preferably, R³² is a C₁₋₆ alkyl group, or is joined to R³¹ to form a C₃₋₆ alkylene group, a group represented by —CH═N—CH═CH—, or a group represented by —CH═N—CH₂—CH₂—. Particularly preferably, R³² is a methyl group or an ethyl group, or is joined to R³¹ to form a tetramethylene group, a hexamethylene group, or a group represented by —CH═N—CH═CH—.

Examples of the compounds represented by the formula (IIId) in which A is an oxygen atom include 2-N,N-dihydrocarbylaminoethyl acrylates such as 2-N,N-dimethylaminoethyl acrylate and 2-N,N-diethylaminoethyl acrylate; 3-N,N-dihydrocarbylaminopropyl acrylates such as 3-N,N-dimethylaminopropyl acrylate; 2-N,N-dihydrocarbylaminoethyl methacrylates such as 2-N,N-dimethylaminoethyl methacrylate and 2-N,N-diethylaminoethyl methacrylate; and 3-N,N-dihydrocarbylaminopropyl methacrylates such as 3-N,N-dimethylaminopropyl methacrylate. Preferred are 3-N,N-dihydrocarbylaminopropyl acrylates, with 3-N,N-dimethylaminopropyl acrylate being more preferred.

Examples of the compounds represented by the formula (IIId) in which A is a group represented by —NR³⁵— (wherein R³⁵ represents a hydrocarbyl group or a hydrogen atom) include N,N-dihydrocarbylaminoethyl acrylamides such as N,N-dimethylaminoethyl acrylamide and N,N-diethylaminoethyl acrylamide; N,N-dihydrocarbylaminopropyl acrylamides such as N,N-dimethylaminopropyl acrylamide and N,N-diethylaminopropyl acrylamide; N,N-dihydrocarbylaminobutyl acrylamides such as N,N-dimethylaminobutyl acrylamide and N,N-diethylaminobutyl acrylamide; N,N-dihydrocarbylaminoethyl methacrylamides such as N,N-dimethylaminoethyl methacrylamide and N,N-diethylaminoethyl methacrylamide; N,N-dihydrocarbylaminopropyl methacrylamides such as N,N-dimethylaminopropyl methacrylamide and N,N-diethylaminopropyl methacrylamide; and N,N-dihydrocarbylaminobutyl methacrylamides such as N,N-dimethylaminobutyl methacrylamide and N,N-diethylaminobutyl methacrylamide. Preferred are N,N-dihydrocarbylaminopropyl acrylamides, with N,N-dimethylaminopropyl acrylamide being more preferred.

The compound represented by the formula (III) is preferably a compound represented by the formula (IIId), particularly preferably an N,N-dihydrocarbylaminopropyl acrylamide, and most preferably N,N-dimethylaminopropyl acrylamide.

In addition to those described above, preferred examples of the compound containing a nitrogen atom and/or a silicon atom include alkoxysilyl group-containing compounds.

The alkoxysilyl group-containing compound is preferably a compound containing a nitrogen atom and an alkoxysilyl group, and more preferably a compound represented by the following formula (IV):

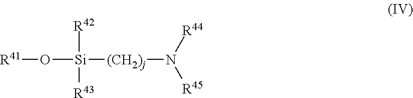

wherein R⁴¹ represents a hydrocarbyl group; R⁴² and R⁴³ each represent a hydrocarbyl group or a hydrocarbyloxy group; R⁴⁴ represents an optionally substituted hydrocarbyl group or a trihydrocarbylsilyl group, or is joined to R⁴⁵ to form a hydrocarbylene group optionally containing at least one, as a hetero atom, selected from the group consisting of a silicon atom, a nitrogen atom and an oxygen atom; R⁴⁵ represents an optionally substituted hydrocarbyl group or a trihydrocarbylsilyl group, or is joined to R⁴⁴ to form a hydrocarbylene group optionally containing at least one, as a hetero atom, selected from the group consisting of a silicon atom, a nitrogen atom and an oxygen atom; and j represents an integer of 1 to 5.

In the formula (IV), the optionally substituted hydrocarbyl group refers to a hydrocarbyl group or a substituted hydrocarbyl group. Examples of the hydrocarbyl groups include alkyl groups such as a methyl group, an ethyl group, an n-propyl group, an isopropyl group, and an n-butyl group; alkenyl groups such as a vinyl group, an allyl group, and an isopropenyl group; and aryl groups such as a phenyl group, preferably alkyl groups, and more preferably a methyl group or an ethyl group. Examples of the substituted hydrocarbyl groups include oxacycloalkyl groups such as an oxiranyl group and a tetrahydrofuranyl group, preferably a tetrahydrofuranyl group.

Herein, an oxacycloalkyl group refers to a group in which the CH₂ on an alicycle of a cycloalkyl group is replaced with an oxygen atom.

Examples of the hydrocarbyloxy groups include alkoxy groups such as a methoxy group, an ethoxy group, an n-propoxy group, an isopropoxy group, an n-butoxy group, a sec-butoxy group, and a tert-butoxy group; and aryloxy groups such as a phenoxy group and a benzyloxy group. Preferred are alkoxy groups, with a methoxy group or an ethoxy group being more preferred.

Examples of the trihydrocarbylsilyl groups include a trimethylsilyl group and a tert-butyl-dimethylsilyl group, preferably a trimethylsilyl group.

The hydrocarbylene group optionally containing at least one, as a hetero atom, selected from the group consisting of a silicon atom, a nitrogen atom and an oxygen atom refers to a hydrocarbylene group, or a hetero atom-containing hydrocarbylene group in which the hetero atom is at least one selected from the group consisting of a silicon atom, a nitrogen atom and an oxygen atom. The hetero atom-containing hydrocarbylene group in which the hetero atom is at least one selected from the group consisting of a silicon atom, a nitrogen atom and an oxygen atom may be a hetero atom-containing hydrocarbylene group in which the hetero atom is a silicon atom, a hetero atom-containing hydrocarbylene group in which the hetero atom is a nitrogen atom, or a hetero atom-containing hydrocarbylene group in which the hetero atom is an oxygen atom. Examples of the hydrocarbylene groups include alkylene groups such as a tetramethylene group, a pentamethylene group, a hexamethylene group, a pentan-2-en-1,5-diyl group, and a 2,2,4-trimethylhexane-1,6-diyl group. Preferred among them are C₄₋₇ alkylene groups, with a pentamethylene group or a hexamethylene group being particularly preferred. Examples of the hetero atom-containing hydrocarbylene groups in which the hetero atom is a silicon atom include a group represented by —Si(CH₃)₂—CH₂—CH₂—Si(CH₃)₂—. Examples of the hetero atom-containing hydrocarbylene groups in which the hetero atom is a nitrogen atom include a group represented by —CH═N—CH═CH—, and a group represented by —CH═N—CH₂—CH₂—. Examples of the hetero atom-containing hydrocarbylene groups in which the hetero atom is an oxygen atom include a group represented by —CH₂—CH₂—O—CH₂—CH₂—.

In the formula (IV), R⁴¹ is preferably a C₁₋₄ alkyl group, and more preferably a methyl group or an ethyl group. Each of R⁴² and R⁴³ is preferably a hydrocarbyloxy group, more preferably a C₁₋₄ alkoxy group, and still more preferably a methoxy group or an ethoxy group. Each of R⁴⁴ and R⁴⁵ is preferably a hydrocarbyl group, more preferably a alkyl group, and still more preferably a methyl group or an ethyl group. Moreover, j is preferably an integer of 2 to 4.

Examples of the compounds represented by the formula (IV) include [(dialkylamino)alkyl]alkoxysilane compounds such as 3-dimethylaminopropyltriethoxysilane, 3-dimethylaminopropyltrimethoxysilane, 3-diethylaminopropyltriethoxysilane, 3-diethylaminopropyltrimethoxysilane, 3-dimethylaminopropylmethyldiethoxysilane, 2-dimethylaminoethyltriethoxysilane, and 2-dimethylaminoethyltrimethoxysilane; cyclic aminoalkylalkoxysilane compounds such as hexamethyleneiminomethyltrimethoxysilane, 3-hexamethyleneiminopropyltriethoxysilane, N-(3-triethoxysilylpropyl)-4,5-dihydroimidazole, and N-(3-trimethoxysilylpropyl)-4,5-imidazole;
[di(tetrahydrofuranyl)amino]alkylalkoxysilane compounds such as 3-[di(tetrahydrofuranyl)amino]propyltrimethoxysilane and 3-[di(tetrahydrofuranyl)amino]propyltriethoxysilane; and N,N-bis(trialkylsilyl)aminoalkylalkoxysilane compounds such as N,N-bis(trimethylsilyl)aminopropylmethyldimethoxysilane and N,N-bis(trimethylsilyl)aminopropylmethyldiethoxysilane. Preferred among the above examples are [(dialkylamino)alkyl]alkoxysilane compounds, with 3-dimethylaminopropyltriethoxysilane, 3-dimethylaminopropyltrimethoxysilane, 3-diethylaminopropyltriethoxysilane, and 3-diethylaminopropyltrimethoxysilane being more preferred.

Examples of the alkoxysilyl group-containing compounds include, in addition to the aforementioned compounds containing a nitrogen atom and an alkoxysilyl group, tetraalkoxysilanes such as tetramethoxysilane, tetraethoxysilane, and tetra-n-propoxysilane; trialkoxyhydrocarbylsilanes such as methyltrimethoxysilane, methyltriethoxysilane, ethyltrimethoxysilane, and phenyltrimethoxysilane; trialkoxyhalosilanes such as trimethoxychlorosilane, triethoxychlorosilane, and tri-n-propoxychlorosilane; dialkoxydihydrocarbylsilanes such as dimethoxydimethylsilane, diethoxydimethylsilane, and dimethoxydiethylsilane; dialkoxydihalosilanes such as dimethoxydichlorosilane, diethoxydichlorosilane, and di-n-propoxydichlorosilane; monoalkoxytrihydrocarbylsilanes such as methoxytrimethylsilane; monoalkoxytrihalosilanes such as methoxytrichlorosilane and ethoxytrichlorosilane; (glycidoxyalkyl)alkoxysilane compounds such as 2-glycidoxyethyltrimethoxysilane, 2-glycidoxyethyltriethoxysilane, (2-glycidoxyethyl)methyldimethoxysilane, 3-glycidoxypropyltrimethoxysilane, 3-glycidoxypropyltriethoxysilane, and (3-glycidoxypropyl)methyldimethoxysilane; (3,4-epoxycyclohexyl)alkylalkoxysilane compounds such as 2-(3,4-epoxycyclohexyl)ethyltrimethoxysilane, 2-(3,4-epoxycyclohexyl)ethyltriethoxysilane, and 2-(3,4-epoxycyclohexyl)ethyl(methyl)dimethoxysilane; alkoxysilylalkylsuccinic anhydrides such as 3-trimethoxysilylpropylsuccinic anhydride and 3-triethoxysilylpropylsuccinic anhydride; and (methacryloyloxyalkyl)alkoxysilane compounds such as 3-methacryloyloxypropyltrimethoxysilane and 3-methacryloyloxypropyltriethoxysilane.

The alkoxysilyl group-containing compound may contain a nitrogen atom and a carbonyl group. Examples of the compounds containing a nitrogen atom and a carbonyl group as well as an alkoxysilyl group include tris[(alkoxysilyl)alkyl]isocyanurate compounds such as tris[3-(trimethoxysilyl)propyl]isocyanurate, tris[3-(triethoxysilyl)propyl]isocyanurate, tris[3-(tripropoxysilyl)propyl]isocyanurate, and tris[3-(tributoxysilyl)propyl]isocyanurate. Preferred among them is tris[3-(trimethoxysilyl)propyl]isocyanurate.

Other examples of the compounds containing a nitrogen atom and/or a silicon atom include N,N-dialkyl-substituted carboxylic acid amide dialkyl acetal compounds. Examples of the N,N-dialkyl-substituted carboxylic acid amide dialkyl acetal compounds include N,N-dialkylformamide dialkyl acetals such as N,N-dimethylformamide dimethyl acetal and N,N-diethylformamide dimethyl acetal; N,N-dialkylacetamide dialkyl acetals such as N,N-dimethylacetamide dimethyl acetal and N,N-diethylacetamide dimethyl acetal; and N,N-dialkylpropionamide dialkyl acetals such as N,N-dimethylpropionamide dimethyl acetal and N,N-diethylpropionamide dimethyl acetal. Preferred among them are N,N-dialkylformamide dialkyl acetals, with N,N-dimethylformamide dimethyl acetal being more preferred.

In the method of producing the conjugated diene polymer, a coupling agent may be added to a solution of the conjugated diene polymer in a hydrocarbon at any time from the initiation of the polymerization of monomers before the recovery of the polymer described later. Examples of the coupling agents include compounds represented by the following formula (V):

R⁵¹ₐML₄₋ₐ (V)

wherein R⁵¹ represents an alkyl group, an alkenyl group, a cycloalkenyl group, or an aryl group; M represents a silicon atom or a tin atom; L represents a halogen atom or a hydrocarbyloxy group; and a represents an integer of 0 to 2.

Examples of the coupling agents represented by the formula (V) include silicon tetrachloride, methyltrichlorosilane, dimethyldichlorosilane, trimethylchlorosilane, tin tetrachloride, methyltrichlorotin, dimethyldichlorotin, trimethylchlorotin, tetramethoxysilane, methyltrimethoxysilane, dimethoxydimethylsilane, methyltriethoxysilane, ethyltrimethoxysilane, dimethoxydiethylsilane, diethoxydimethylsilane, tetraethoxysilane, ethyltriethoxysilane, and diethoxydiethylsilane.

In terms of enhancing the processability of the conjugated diene polymer, the amount of the coupling agent to be added per mol of the alkali metal derived from an alkali metal catalyst is preferably not less than 0.03 mol and more preferably not less than 0.05 mol. In terms of enhancing fuel economy, the amount is preferably not more than 0.4 mol and more preferably not more than 0.3 mol.

In the method of producing the conjugated diene polymer, unreacted active terminals may be treated with alcohol, such as methanol or isopropyl alcohol, before the recovery of the polymer described later.

The conjugated diene polymer may be recovered from the solution of the conjugated diene polymer in a hydrocarbon by a known method. Examples of this method include (A) a method of adding a coagulant to the solution of the conjugated diene polymer in a hydrocarbon, and (B) a method of adding steam to the solution of the conjugated diene polymer in a hydrocarbon (steam stripping treatment). The recovered conjugated diene polymer may be dried with a known dryer, such as a band dryer or an extrusion dryer.

In terms of achieving a balanced enhancement in performance on ice and snow, abrasion resistance, rubber strength, fuel economy, wet-grip performance, and dry handling stability, the amount of the structural unit derived from the polymerization initiator represented by the formula (I) in the conjugated diene polymer, when expressed per unit mass of the polymer, is preferably not less than 0.0001 mmol/g polymer, and more preferably not less than 0.001 mmol/g polymer, whereas it is preferably not more than 0.15 mmol/g polymer, and more preferably not more than 0.1 mmol/g polymer.

In terms of achieving a balanced enhancement in performance on ice and snow, abrasion resistance, rubber strength, fuel economy, wet-grip performance, and dry handling stability, the amount of the structural unit derived from the silicon-containing vinyl compound in the conjugated diene polymer, when expressed per unit mass of the polymer, is preferably not less than 0.01 mmol/g polymer, and more preferably not less than 0.02 mmol/g polymer, whereas it is preferably not more than 0.4 mmol/g polymer, and more preferably not more than 0.2 mmol/g polymer.

In terms of achieving a balanced enhancement in performance on ice and snow, abrasion resistance, rubber strength, fuel economy, wet-grip performance, and dry handling stability, the conjugated diene polymer preferably contains a structural unit derived from the compound represented by the formula (II). The structural unit derived from the compound represented by the formula (II) in the conjugated diene polymer refers to a structural unit represented by the following formula (IIb):

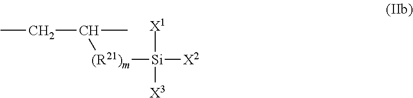

wherein m, R²¹, X¹; X², and X³ are as defined in the formula (II).

In the conjugated diene polymer in the present invention, preferably, at least one of X¹, X² and X³ in the structural unit derived from the compound represented by the formula (II) is replaced by a hydroxy group, more preferably two or more of X¹, X² and X³ are replaced by hydroxy groups, and still more preferably two of X¹, X² and X³ are replaced by hydroxy groups. This can enhance the effects of improving the performance on ice and snow, abrasion resistance, rubber strength, fuel economy, wet-grip performance, and dry handling stability. Non-limiting examples of the method of replacing at least one of X¹, X², and X³ with a hydroxy group include steam stripping treatment.

In terms of achieving a balanced enhancement in performance on ice and snow, abrasion resistance, rubber strength, fuel economy, wet-grip performance, and dry handling stability, the conjugated diene polymer preferably contains a structural unit (aromatic vinyl unit) derived from an aromatic vinyl compound. When the conjugated diene polymer contains an aromatic vinyl unit, the amount of the aromatic vinyl unit in the conjugated diene polymer, based on 100% by mass of the combined amount of the structural unit (conjugated diene unit) derived from the conjugated diene compound and the aromatic vinyl unit, is preferably not less than 10% by mass (the amount of the conjugated diene unit is not more than 90% by mass), and more preferably not less than 15% by mass (the amount of the conjugated diene unit is not more than 85% by mass). Also, from the viewpoint of the performance on ice and snow and fuel economy, the amount of the aromatic vinyl unit is preferably not more than 50% by mass (the amount of the conjugated diene unit is not less than 50% by mass), and more preferably not more than 45% by mass (the amount of the conjugated diene unit is not less than 55% by mass).

When the conjugated diene polymer contains a structural unit derived from an aromatic vinyl compound, in terms of fuel economy, the vinyl bond content (vinyl content) in the conjugated diene polymer is preferably not more than 80 mol %, and more preferably not more than 70 mol %, based on 100 mol % of the conjugated diene unit content. From the viewpoint of wet-grip performance, the vinyl bond content is preferably not less than 10 mol %, more preferably not less than 15 mol %, still more preferably not less than 20 mol %, and particularly preferably not less than 40 mol %.

Particularly in terms of enhancing abrasion resistance, the conjugated diene polymer preferably contains no structural unit derived from an aromatic vinyl compound. In this case, the vinyl bond content (vinyl content) in the conjugated diene polymer is preferably not more than 20 mol %, and more preferably not more than 15 mol %, based on 100 mol % of the conjugated diene unit content.

The vinyl bond content in the conjugated diene polymer can be measured by the method described later in examples.

In terms of enhancing fuel economy, the molecular weight distribution of the conjugated diene polymer is preferably 1 to 5, and more preferably 1 to 2. The molecular weight distribution can be determined by measuring a number-average molecular weight (Mn) and a weight-average molecular weight (Mw) using gel permeation chromatography (GPC), and dividing Mw by Mn.

The conjugated diene polymer can be used as the rubber component in the rubber composition of the present invention.

The amount of the conjugated diene polymer based on 100% by mass of the rubber component is not more than 45% by mass, preferably not more than 35% by mass, and more preferably not more than 25% by mass. An amount of more than 45% by mass tends to not only decrease abrasion resistance but also drive up the cost. The amount of the conjugated diene polymer is not less than 1% by mass, preferably not less than 5% by mass, more preferably not less than 10% by mass, and still more preferably not less than 15% by mass. An amount of less than 1% by mass tends not to easily improve fuel economy.

The rubber composition of the present invention includes a high-cis polybutadiene having a cis (cis-1,4) microstructure (bonding mode of monomer units) content (cis content) of not less than 95% by mass. The high-cis polybutadiene is not particularly limited as long as it has a cis content of not less than 95% by mass, and examples thereof include those generally used in the tire industry, for example, BR1220 (produced by ZEON Corporation), and BR130B and BR150B (produced by Ube Industries, Ltd.).

The cis content is calculated by infrared absorption spectrometry.

The amount of the high-cis polybutadiene based on 100% by mass of the rubber component is not less than 20% by mass, preferably not less than 25% by mass, and more preferably not less than 30% by mass. An amount of less than 20% by mass tends not to ensure sufficient flexibility at low temperatures and thus to reduce the performance on ice and snow, and also tends to result in reduced abrasion resistance. The amount of the high-cis polybutadiene is not more than 64% by mass, preferably not more than 60% by mass. An amount of more than 64% by mass tends to result in reduced wet-grip performance.

The rubber composition of the present invention includes a polyisoprene-based rubber. Examples of the polyisoprene-based rubbers include natural rubber (NR), and polyisoprene rubber (IR). The NR is not particularly limited, and examples thereof include those generally used in the tire industry, such as SIR20, RSS#3, TSR20, deproteinized natural rubber (DPNR), highly purified natural rubber (HPNR), and epoxidized natural rubber (ENR). Similarly, IRs generally used in the tire industry may be used.

The amount of the polyisoprene-based rubber based on 100% by mass of the rubber component is not less than 35% by mass, preferably not less than 40% by mass. If the amount is less than 35% by mass, the rubber strength may decrease and the cohesion of the rubber compound during mixing may be so poor that productivity can be deteriorated. The amount of the polyisoprene-based rubber is not more than 60% by mass, preferably not more than 50% by mass, and more preferably not more than 45% by mass. If the amount of the polyisoprene-based rubber exceeds 60% by mass, sufficient wet-grip performance may not be achieved.

Examples of materials that can be used in the rubber component, other than the high-cis polybutadiene and polyisoprene-based rubber, include conventional rubbers such as styrene-butadiene copolymer rubber (SBR), butadiene-isoprene copolymer rubber, and butyl rubber. Ethylene-propylene copolymers, and ethylene-octene copolymers may also be mentioned. Two or more kinds of the rubber materials may be used in combination.

The rubber composition of the present invention contains a silica having a nitrogen adsorption specific surface area (N₂SA) of 40 to 400 m²/g. Non-limiting examples of the silicas include dry silica (anhydrous silica) and wet silica (hydrous silica). Wet silica is preferred because it has more silanol groups.

The silica has a nitrogen adsorption specific surface area (N₂SA) of not less than 40 m²/g, preferably not less than 50 m²/g, and more preferably not less than 60 m²/g. If the silica has a N₂SA of less than 40 m²/g, the silica tends to have a little reinforcement, and thus the abrasion resistance and rubber strength tend to decrease. The silica has a N₂SA of not more than 400 m²/g, preferably not more than 360 m²/g, and more preferably not more than 300 m²/g. A silica with a N₂SA of more than 400 m²/g tends not to easily disperse, and thus the fuel economy tends to deteriorate.

The N₂SA of silica is determined by the BET method in accordance with ASTM D3037-93.

The amount of the silica (the combined amount if two or more kinds of silica are used) for each 100 parts by mass of the rubber component is not less than 5 parts by mass, preferably not less than 10 parts by mass, more preferably not less than 30 parts by mass, and still more preferably not less than 45 parts by mass. If the amount is less than 5 parts by mass, the effect of silica added tends not to be sufficiently achieved, and thus the abrasion resistance and rubber strength tend to decrease. The amount of the silica is not more than 150 parts by mass, preferably not more than 100 parts by mass. If the amount exceeds 150 parts by mass, the fuel economy tends to deteriorate.

Two or more kinds of silica are preferably used in combination although one kind of silica may be used alone. A combination of silica (1) having a nitrogen adsorption specific surface area of at least 40 m²/g but less than 120 m²/g and silica (2) having a nitrogen adsorption specific surface area of not less than 120 m²/g is more preferably used. When the silica (1) and the silica (2) are used together with the conjugated diene polymer, the silica (1) and the silica (2) disperse so well that the effects of improving the properties can be synergistically enhanced. Further, when the silica (1) and the silica (2) are used together with a mercapto group-containing silane coupling agent or a specific solid resin, which are described later, the effects of improving the properties can further be enhanced.

The N₂SAs of silica (1) and silica (2) preferably satisfy the inequality: (N₂SA of silica (2))/(N₂SA of silica (1))≧1.4, more preferably the inequality: (N₂SA of silica (2))/(N₂SA of silica (1))≧2.0. If the ratio is less than 1.4, the difference in particle size between the silica (1) and the silica (2) is small, and thus such a blend of two kinds of silica tends not to sufficiently provide a dispersibility-improving effect.

The silica (1) has a N₂SA of not less than 40 m²/g, preferably not less than 50 m²/g. If the silica (1) has a N₂SA of less than 40 m²/g, the silica may have an insufficient reinforcement, so that the rubber strength, abrasion resistance, and dry handling stability may be deteriorated. The silica (1) has a N₂SA of less than 120 m²/g, preferably not more than 100 m²/g, and more preferably not more than 80 m²/g. If the silica (1) has a N₂SA of not less than 120 m²/g, the effect of a combination of the silica (1) and the silica (2) may not be sufficiently achieved.

The silica (2) has a N₂SA of not less than 120 m²/g, preferably not less than 150 m²/g. If the silica (2) has a N₂SA of less than 120 m²/g, the effect of a combination of the silica (1) and the silica (2) may not be sufficiently achieved. The silica (2) preferably has a N₂SA of not more than 250 m²/g, more preferably not more than 220 m²/g. If the silica (2) has a N₂SA of more than 250 m²/g, the fuel economy tends to deteriorate.

The amounts of silica (1) and silica (2) preferably satisfy the following inequalities:

(Amount of silica (1))×0.06≦(Amount of silica (2))≦(Amount of silica (1))×15.

If the amount of silica (2) is less than 0.06 times the amount of silica (1), a sufficient rubber strength tends not to be achieved. If the amount of silica (2) is more than 15 times the amount of silica (1), the rolling resistance tends to increase. The amount of silica (2) is more preferably at least 0.3 times the amount of silica (1), and still more preferably at least 0.5 times the amount of silica (1). Also, the amount of silica (2) is more preferably at most 7 times the amount of silica (1), and still more preferably at most 4 times the amount of silica 1).

The amount of silica (1) for each 100 parts by mass of the rubber component is preferably not less than 5 parts by mass, and more preferably not less than 10 parts by mass. If the amount of silica (1) is less than 5 parts by mass, the fuel economy may not be sufficiently improved. Also, the amount of silica (1) is preferably not more than 60 parts by mass, and more preferably not more than 40 parts by mass. If the amount of silica (1) is more than 60 parts by mass, while good fuel economy is achieved, the rubber strength, abrasion resistance, and dry handling stability tend to decrease.

The amount of silica (2) for each 100 parts by mass of the rubber component is preferably not less than 5 parts by mass, more preferably not less than 20 parts by mass, and still more preferably not less than 40 parts by mass. If the amount of silica (2) is less than 5 parts by mass, sufficient rubber strength, abrasion resistance, and dry handling stability may not be achieved. Also, the amount of silica (2) is preferably not more than 90 parts by mass, and more preferably not more than 70 parts by mass. If the amount of silica (2) is more than 90 parts by mass, while good rubber strength, abrasion resistance, and dry handling stability are achieved, the fuel economy tends to deteriorate.

The combined amount of silica (1) and silica (2) for each 100 parts by mass of the rubber component is preferably not less than 5 parts by mass, more preferably not less than 10 parts by mass, still more preferably not less than 30 parts by mass, and particularly preferably not less than 45 parts by mass. If the combined amount is less than 5 parts by mass, the effect of the silica (1) and the silica (2) added tends not to be sufficiently achieved, and thus the abrasion resistance and rubber strength tend to decrease. The combined amount of silica (1) and silica (2) is preferably not more than 150 parts by mass, and more preferably not more than 100 parts by mass. If the combined amount exceeds 150 parts by mass, the processability tends to deteriorate.

The rubber composition of the present invention preferably includes a mercapto group-containing silane coupling agent. When a mercapto group-containing silane coupling agent is used together with the conjugated diene polymer and the silica, the properties can be synergistically improved. Further, when a mercapto group-containing silane coupling agent is used together with the silica (1) and the silica (2) or a specific solid resin mentioned later, the effects of improving the properties can further be enhanced.

The mercapto group-containing silane coupling agent may suitably be a compound represented by the formula (1) below, and/or a compound containing a linking unit A represented by the formula (2) below and a linking unit B represented by the formula (3) below,

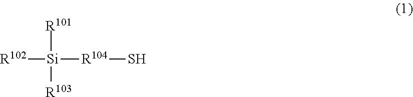

wherein R¹⁰¹ to R¹⁰³ each represent a branched or unbranched C₁₋₁₂ alkyl group, a branched or unbranched C₁₋₁₂ alkoxy group, or a group represented by (R¹¹¹—O)_{z}—R¹¹² where z R¹¹¹s each represent a branched or unbranched C₁₋₃₀ divalent hydrocarbon group, and z R¹¹¹s may be the same as or different from one another; R¹¹² represents a branched or unbranched C₁₋₃₀ alkyl group, a branched or unbranched C₂₋₃₀ alkenyl group, a C₆₋₃₀ aryl group, or a C₇₋₃₀ aralkyl group; and z represents an integer of 1 to 30, and R¹⁰¹ to R¹⁰³ may be the same as or different from one another; and R¹⁰⁴ represents a branched or unbranched C₁₋₆ alkylene group;

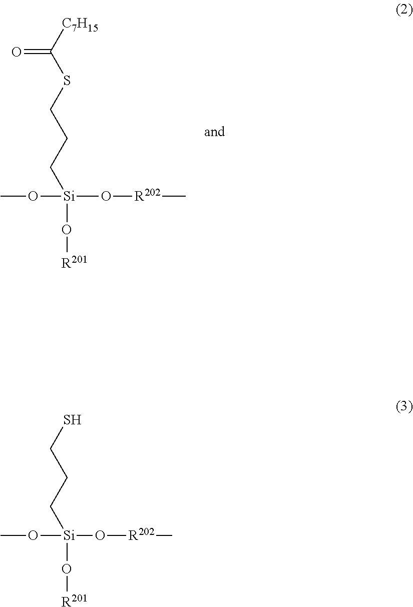

wherein R²⁰¹ represents a hydrogen atom, a halogen atom, a branched or unbranched C₁₋₃₀ alkyl group, a branched or unbranched C₂₋₃₀ alkenyl group, a branched or unbranched C₂₋₃₀ alkynyl group, or the alkyl group in which a terminal hydrogen atom is replaced with a hydroxy group or a carboxyl group; R²⁰² represents a branched or unbranched C₁₋₃₀ alkylene group, a branched or unbranched C₂₋₃₀ alkenylene group, or a branched or unbranched C₂₋₃₀ alkynylene group; and R²⁰¹ and R²⁰² may be joined together to form a cyclic structure.

The following describes the compound represented by the formula (I).

The use of the compound represented by the formula (1) allows the silica to disperse well, and thus the effects of the present invention can be well achieved. In particular, the use of this compound can greatly improve wet-grip performance.

R¹⁰¹ to R¹⁰³ each represent a branched or unbranched C₁₋₁₂ alkyl group, a branched or unbranched C₁₋₁₂ alkoxy group, or a group represented by —O—(R¹¹¹—O)_{z}—R¹¹². In terms of achieving the effects of the present invention well, preferably at least one of R¹⁰¹ to R¹⁰³ is a group represented by —O—(R¹¹¹—O)_{z}—R¹¹², and more preferably two of R¹⁰¹ to R¹⁰³ are groups represented by —O—(R¹¹¹—O)_{z}—R¹¹² while the other is a branched or unbranched C₁₋₁₂ alkoxy group.

Examples of the branched or unbranched C₁₋₁₂ (preferably C₁₋₅) alkyl groups for R¹⁰¹ to R¹⁰³ include a methyl group, an ethyl group, an n-propyl group, an isopropyl group, an n-butyl group, an iso-butyl group, a sec-butyl group, a tert-butyl group, a pentyl group, a hexyl group, a heptyl group, a 2-ethylhexyl group, an octyl group, and a nonyl group.

Examples of the branched or unbranched C₁₋₁₂ (preferably C₁₋₅) alkoxy groups for R¹⁰¹ to R¹⁰³ include a methoxy group, an ethoxy group, an n-propoxy group, an isopropoxy group, an n-butoxy group, an iso-butoxy group, a sec-butoxy group, a tert-butoxy group, a pentyloxy group, a hexyloxy group, a heptyloxy group, a 2-ethylhexyloxy group, an octyloxy group, and a nonyloxy group.

R¹¹¹ in the group represented by —O—(R¹¹¹—O)_{z}—R¹¹² for R¹⁰¹ to R¹⁰³ represents a branched or unbranched C₁₋₃₀ (preferably C₁₋₁₅, more preferably C₁₋₃) divalent hydrocarbon group.

Examples of these hydrocarbon groups include branched or unbranched C₁₋₃₀ alkylene groups, branched or unbranched C₂₋₃₀ alkenylene groups, branched or unbranched C₂₋₃₀ alkynylene groups, and C₆₋₃₀ arylene groups. Branched or unbranched C₁₋₃₀ alkylene groups are preferred among the examples.

Examples of the branched or unbranched C₁₋₃₀ (preferably C₁₋₁₅, more preferably C₁₋₃) alkylene groups for R¹¹¹ include a methylene group, an ethylene group, a propylene group, a butylene group, a pentylene group, a hexylene group, a heptylene group, an octylene group, a nonylene group, a decylene group, an undecylene group, a dodecylene group, a tridecylene group, a tetradecylene group, a pentadecylene group, a hexadecylene group, a heptadecylene group, and an octadecylene group.

Examples of the branched or unbranched C₂₋₃₀ (preferably C₂₋₁₅, more preferably C₂₋₃) alkenylene groups for R¹¹¹ include a vinylene group, a 1-propenylene group, a 2-propenylene group, a 1-butenylene group, a 2-butenylene group, a 1-pentenylene group, a 2-pentenylene group, a 1-hexenylene group, a 2-hexenylene group, and a 1-octenylene group.

Examples of the branched or unbranched C₂₋₃₀ (preferably C₂₋₁₅, more preferably C₂₋₃) alkynylene groups for R¹¹¹ include an ethynylene group, a propynylene group, a butynylene group, a pentynylene group, a hexynylene group, a heptynylene group, an octynylene group, a nonynylene group, a decynylene group, an undecynylene group, and a dodecynylene group.

Examples of the C₆₋₃₀ (preferably C₆₋₁₅) arylene groups for R¹¹¹ include a phenylene group, a tolylene group, a xylylene group, and a naphthylene group.

Here, z represents an integer of 1 to 30 (preferably 2 to 20, more preferably 3 to 7, and still more preferably 5 or 6).

R¹¹² represents a branched or unbranched C₁₋₃₀ alkyl group, a branched or unbranched C₂₋₃₀ alkenyl group, a C₆₋₃₀ aryl group, or a C₇₋₃₀ aralkyl group. R¹¹² is especially preferably a branched or unbranched C₁₋₃₀ alkyl group.

Examples of the branched or unbranched C₁₋₃₀ (preferably C₃₋₂₅, more preferably C₁₀₋₁₅) alkyl groups for R¹¹² include a methyl group, an ethyl group, an n-propyl group, an isopropyl group, an n-butyl group, an iso-butyl group, a sec-butyl group, a tert-butyl group, a pentyl group, a hexyl group, a heptyl group, a 2-ethylhexyl group, an octyl group, a nonyl group, a decyl group, an undecyl group, a dodecyl group, a tridecyl group, a tetradecyl group, a pentadecyl group, and an octadecyl group.

Examples of the branched or unbranched C₂₋₃₀ (preferably C₃₋₂₅, more preferably C₁₀₋₁₅) alkenyl groups for R¹¹² include a vinyl group, a 1-propenyl group, a 2-propenyl group, a 1-butenyl group, a 2-butenyl group, a 1-pentenyl group, a 2-pentenyl group, a 1-hexenyl group, a 2-hexenyl group, a 1-octenyl group, a decenyl group, an undecenyl group, a dodecenyl group, a tridecenyl group, a tetradecenyl group, a pentadecenyl group, and an octadecenyl group.

Examples of the C₆₋₃₀ (preferably C₁₀₋₂₀) aryl groups for R¹¹² include a phenyl group, a tolyl group, a xylyl group, a naphthyl group, and a biphenyl group.

Examples of the C₇₋₃₀ (preferably C₁₀₋₂₀) aralkyl groups for R¹¹² include a benzyl group and a phenethyl group.

Specific examples of the group represented by —O—(R¹¹¹—O)_{z}—R¹¹² include groups represented by —O—(C₂H₄—O)₅—C₁₁H₂₃, —O—(C₂H₄—O)₅—C₁₂H₂₅, —O—(C₂H₄—O)₅—C₁₃H₂₇, —O—(C₂H₄—O)₅—C₁₄H₂₉, —O—(C₂H₄—O)₅—C₁₅H₃₁, —O—(C₂H₄—O)₃—C₁₃H₂₇, —O—(C₂H₄—O)₄—C₁₃H₂₇, —O—(C₂H₄—))₆—C₁₃H₂₇ and —O—(C₂H₄—O)₇—C₁₃H₂₇. Preferred among the examples are groups represented by O—(C₂H₄—O)₅—C₁₁H₂₃, —O—(C₂H₄—O)₅—C₁₃H₂₇, —O—(C₂H₄—O)₅—C₁₅H₃₁, and —O—(C₂H₄—O)₆—C₁₃H₂₇.

Examples of the branched or unbranched C₁₋₆ (preferably C₁₋₅) alkylene groups for R¹⁰⁴ include groups as mentioned for the branched or unbranched C₁₋₃₀ alkylene group for R¹¹¹.

Examples of the compounds represented by the formula (1) include 3-mercaptopropyltrimethoxysilane, 3-mercaptopropyltriethoxysilane, 2-mercaptoethyl-trimethoxysilane, 2-mercaptoethyltriethoxysilane, and a compound represented by the following formula (Si363 produced by Evonik Degussa). The compound represented by the following formula may be suitably used. These compounds may be used alone or two or more of these may be used in combination.

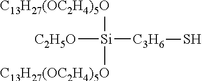

The following describes the compound containing a linking unit A represented by the formula (2) and a linking unit B represented by the formula (3).

In the case where the compound containing a linking unit A represented by the formula (2) and a linking unit B represented by the formula (3) is used, the increase in viscosity during the processing is suppressed as compared to the case where polysulfide silane such as bis-(3-triethoxysilylpropyl)tetrasulfide is used. This is presumably because, since the sulfide moiety of the linking unit A is a C—S—C bond, the compound is thermally more stable than tetrasulfide or disulfide, and thus the Mooney viscosity is less likely to greatly increase.

Further, the decrease in scorch time is suppressed as compared to the case where mercapto silane such as 3-mercaptopropyltrimethoxysilane is used. This is presumably because, though the linking unit B has a mercaptosilane structure, the —C₇H₁₅ moiety of the linking unit A covers the —SH group of the linking unit B, as a result of which the SH group is less likely to react with polymers and therefore scorch is less likely to occur.

From the viewpoint of enhancing the effects of suppressing the increase in viscosity during the processing and of suppressing the decrease in scorch time as mentioned above, the linking unit A content in the silane coupling agent having the aforementioned structure is preferably not less than 30 mol %, and more preferably not less than 50 mol %, whereas it is preferably not more than 99 mol %, and more preferably not more than 90 mol %. The linking unit B content is preferably not less than 1 mol %, more preferably not less than 5 mol %, and still more preferably not less than 10 mol %, whereas it is preferably not more than 70 mol %, more preferably not more than 65 mol %, and still more preferably not more than 55 mol %. The combined content of the linking unit A and the linking unit B is preferably not less than 95 mol %, more preferably not less than 98 mol %, and particularly preferably 100 mol %.

The linking unit A or B content refers to the amount including the linking unit A or B that is present at the terminals of the silane coupling agent, if any. In the case where the linking unit A or B is present at the terminal of the silane coupling agent, its form is not particularly limited as long as it forms a unit corresponding to the formula (2) representing the linking unit A or the formula (3) representing the linking unit B.

Examples of the halogen atoms for R²⁰¹ include chlorine, bromine, and fluorine.

Examples of the branched or unbranched C₁₋₃₀ alkyl groups for R²⁰¹ include a methyl group, an ethyl group, an n-propyl group, an isopropyl group, an n-butyl group, an iso-butyl group, a sec-butyl group, a tert-butyl group, a pentyl group, a hexyl group, a heptyl group, a 2-ethylhexyl group, an octyl group, a nonyl group, and a decyl group. The alkyl group preferably has 1 to 12 carbon atom(s).

Examples of the branched or unbranched C₂₋₃₀ alkenyl groups for R²⁰¹ include a vinyl group, a 1-propenyl group, a 2-propenyl group, a 1-butenyl group, a 2-butenyl group, a 1-pentenyl group, a 2-pentenyl group, a 1-hexenyl group, a 2-hexenyl group, and a 1-octenyl group. The alkenyl group preferably has 2 to 12 carbon atoms.

Examples of the branched or unbranched C₂₋₃₀ alkynyl groups for R²⁰¹ include an ethynyl group, a propynyl group, a butynyl group, a pentynyl group, a hexynyl group, a heptynyl group, an octynyl group, a nonynyl group, a decynyl group, an undecynyl group, and a dodecynyl group. The alkynyl group preferably has 2 to 12 carbon atoms.

Examples of the branched or unbranched C₁₋₃₀ alkylene groups for R²⁰² include an ethylene group, a propylene group, a butylene group, a pentylene group, a hexylene group, a heptylene group, an octylene group, a nonylene group, a decylene group, an undecylene group, a dodecylene group, a tridecylene group, a tetradecylene group, a pentadecylene group, a hexadecylene group, a heptadecylene group, and an octadecylene group. The alkylene group preferably has 1 to 12 carbon atom(s).

Examples of the branched or unbranched C₂₋₃₀ alkenylene groups for R²⁰² include a vinylene group, a 1-propenylene group, a 2-propenylene group, a 1-butenylene group, a 2-butenylene group, a 1-pentenylene group, a 2-pentenylene group, a 1-hexenylene group, a 2-hexenylene group, and a 1-octenylene group. The alkenylene group preferably has 2 to 12 carbon atoms.

Examples of the branched or unbranched C₂₋₃₀ alkynylene groups for R²⁰² include an ethynylene group, a propynylene group, a butynylene group, a pentynylene group, a hexynylene group, a heptynylene group, an octynylene group, a nonynylene group, a decynylene group, an undecynylene group, and a dodecynylene group. The alkynylene group preferably has 2 to 12 carbon atoms.

In the compound containing the linking unit A represented by the formula (2) and the linking unit B represented by the formula (3), the total number of repetitions (x+y) of the number of repetitions (x) of the linking unit A and the number of repetitions (y) of the linking unit B is preferably in the range of 3 to 300. When the total number of repetitions falls within the range mentioned above, the —C₇H₁₅ moiety of the linking unit A covers the mercaptosilane of the linking unit B, which makes it possible not only to suppress the decrease in scorch time but also to ensure good reactivity to silica and the rubber component.

Examples of the compounds containing the linking unit A represented by the formula (2) and the linking unit B represented by the formula (3) include NXT-Z30, NXT-Z45, and NXT-Z60 (produced by Momentive Performance Materials). These may be used alone, or two or more of these may be used in combination.

The amount of the mercapto group-containing silane coupling agent for each 100 parts by mass of silica is preferably not less than 0.5 parts by mass, more preferably not less than 2 parts by mass, and still more preferably not less than 3 parts by mass. If the amount is less than 0.5 parts by mass, the effect of the mercapto group-containing silane coupling agent added tends not to be sufficiently achieved. Also, the amount of the mercapto group-containing silane coupling agent is preferably not more than 20 parts by mass, and more preferably not more than 10 parts by mass. If the amount exceeds 20 parts by mass, the rubber strength and abrasion resistance tend to decrease.

The rubber composition of the present invention may preferably contain another silane coupling agent together with the mercapto group-containing silane coupling agent. This can enhance the effects of improving the properties. Examples of other silane coupling agents include bis(3-triethoxysilylpropyl)tetrasulfide, bis(3-triethoxysilylpropyl)trisulfide, bis(3-triethoxysilylpropyl)disulfide, bis(2-triethoxysilylethyl)tetrasulfide, 3-trimethoxysilylpropyl-N,N-dimethylthiocarbamoyl tetrasulfide, bis(3-trimethoxysilylpropyl)tetrasulfide, bis(2-trimethoxysilylethyl)tetrasulfide, 3-triethoxysilylpropyl-N,N-dimethylthiocarbamoyl tetrasulfide, 2-triethoxysilylethyl-N,N-dimethylthiocarbamoyl tetrasulfide, 3-trimethoxysilylpropylbenzothiazole tetrasulfide, 3-triethoxysilylpropylbenzothiazolyl tetrasulfide, 3-triethoxysilylpropylmethacrylate monosulfide, 3-trimethoxysilylpropylmethacrylate monosulfide, bis(3-diethoxymethylsilylpropyl)tetrasulfide, 3-mercaptopropyldimethoxymethylsilane, dimethoxymethylsilylpropyl-N,N-dimethylthiocarbamoyl tetrasulfide, and dimethoxymethylsilylpropylbenzothiazole tetrasulfide, with bis(3-triethoxysilylpropyl)tetrasulfide being suitable.

The amount of the other silane coupling agents for each 100 parts by mass of silica is preferably not less than 0.5 parts by mass, and more preferably not less than 3 parts by mass. If the amount is less than 0.5 parts by mass, the effects of the other silane coupling agents added tend not to be sufficiently achieved. The amount of the other silane coupling agents is preferably not more than 20 parts by mass, and more preferably not more than 10 parts by mass. If the amount exceeds 20 parts by mass, the rubber strength and abrasion resistance tend to decrease.

The total amount of silane coupling agents for each 100 parts by mass of silica is preferably not less than 0.5 parts by mass, and more preferably not less than 3 parts by mass. If the total amount is less than 0.5 parts by mass, the resulting unvulcanized rubber composition may have so high viscosity that good processability cannot be ensured. Also, the total amount of silane coupling agents is preferably not more than 20 parts by mass, and more preferably not more than 10 parts by mass. If the total amount exceeds 20 parts by mass, the rubber strength and abrasion resistance tend to decrease.

The rubber composition of the present invention preferably includes a solid resin having a glass transition temperature of 60 to 120° C. When the solid resin is used together with the conjugated diene polymer, the effects of improving the properties can be synergistically enhanced. Further, when the solid resin is used together with the mercapto group-containing silane coupling agent, or the silica (1) and the silica (2), the effects of improving the properties can further be enhanced.

The solid resin has a glass transition temperature (Tg) of not lower than 60° C., preferably not lower than 75° C. If the solid resin has a glass transition temperature lower than 60° C., the effect of improving wet-grip performance may not be sufficiently achieved. The solid resin has a Tg of not higher than 120° C., preferably not higher than 100° C. If the solid resin has a Tg of higher than 120° C., the loss elastic modulus at high temperature ranges tends to increase so greatly that the fuel economy can be deteriorated.

The Tg (midpoint glass transition temperature) values of the solid resin are measured at a rate of temperature rise of 10° C./min. with a differential scanning calorimeter Q200 (produced by TA Instruments Japan Inc.) in accordance with JIS-K7121.

Any solid resin may be used as the solid resin as long as it has a Tg mentioned above. Examples of the solid resins include aromatic resins such as aromatic vinyl polymers formed by polymerizing α-methylstyrene and/or styrene, coumarone-indene resins, and indene resins; terpene resins; and rosin resins. Derivatives of these resins may also be used. Aromatic resins are preferred among the examples mentioned above, and aromatic vinyl polymers formed by polymerizing α-methylstyrene and/or styrene and coumarone-indene resins are more preferred, as the use of such a solid resin provides good adhesion properties to the unvulcanized rubber composition and also provides good fuel economy.

Styrene and/or α-methylstyrene is used as an aromatic vinyl monomer (unit) of the aromatic vinyl polymer formed by polymerizing α-methylstyrene and/or styrene (resin formed by polymerizing α-methylstyrene and/or styrene). The aromatic vinyl polymer may be a homopolymer of one monomer, or a copolymer of both monomers. Preferably, the aromatic vinyl polymer is a homopolymer of α-methylstyrene, or a copolymer of α-methylstyrene and styrene as the use of such a polymer is cost efficient, and provides good processability and excellent wet-grip performance.

The aromatic vinyl polymer preferably has a weight-average molecular weight (Mw) of not less than 500, more preferably not less than 800. If the Mw is less than 500, the effect of improving wet-grip performance is less likely to be sufficiently achieved. The aromatic vinyl polymer preferably has a weight-average molecular weight of not more than 3000, more preferably not more than 2000. If the Mw is more than 3000, the dispersibility of filler tends to decrease so that the fuel economy can be deteriorated.

Herein, the weight-average molecular weight can be measured using gel permeation chromatography (GPC) (GPC-8000 series produced by Tosoh Corporation, detector: differential refractometer) and expressed relative to polystyrene standards.

The coumarone-indene resin and the indene resin refer to coal or petroleum resins derived from coumarone having eight carbon atoms and indene having nine carbon atoms, and indene, respectively, as principal monomer. Specific examples thereof include vinyltoluene-α-methylstyrene-indene resin, vinyltoluene-indene resin, α-methylstyrene-indene resin, and α-methylstyrene-vinyltoluene-indene copolymer resin.

The terpene resin refers to a resin derived from, as principal monomer, a terpene compound having a terpene backbone, such as a monoterpene, a sesquiterpene or a diterpene. Examples thereof include α-pinene resin, β-pinene resin, limonene resin, dipentene resin, β-pinene/limonene resin, aromatic modified terpene resin, terpene phenolic resin, and hydrogenated terpene resin. Examples of the rosin resins include natural rosin resins (polymerized rosins) such as gum rosin, wood rosin and tall oil rosin, which can be produced by processing pine resin, and mainly contain a resin acid such as abietic acid or pimaric acid; hydrogenated rosin resins, maleic acid-modified rosin resins, rosin-modified phenolic resins, rosin glycerol esters, and disproportionated rosin resins.

The amount of the solid resin for each 100 parts by mass of the rubber component is preferably not less than 1 part by mass, more preferably not less than 3 parts by mass, and still more preferably not less than 5 parts by mass. If the amount is less than 1 part by mass, the effect of improving wet-grip performance tends not to be sufficiently achieved. The amount of the solid resin is preferably not more than 30 parts by mass, and more preferably not more than 15 parts by mass. If the amount is more than 30 parts by mass, the elastic modulus of the rubber composition at low temperature ranges tends to increase so greatly that the performance on ice and snow can be reduced.

Known additives may be used, and examples thereof include vulcanizing agents such as sulfur; vulcanization accelerators such as thiazole vulcanization accelerators, thiuram vulcanization accelerators, sulfenamide vulcanization accelerators, and guanidine vulcanization accelerators; vulcanization activators such as stearic acid and zinc oxide; organic peroxides; fillers such as carbon black, calcium carbonate, talc, alumina, clay, aluminum hydroxide, and mica; processing aids such as extender oils and lubricants; and antioxidants.

Examples of the carbon black include furnace black (furnace carbon black) such as SAF, ISAF, HAF, MAF, FEF, SRF, GPF, APF, FF, CF, SCF or ECF; acetylene black (acetylene carbon black); thermal black (thermal carbon black) such as FT or MT; channel black (channel carbon black) such as EPC, MPC or CC; and graphite. These may be used alone or two or more of these may be used in combination.

The amount of carbon black for each 100 parts by mass of the rubber component is preferably not less than 1 part by mass, and more preferably not less than 3 parts by mass. If the amount is less than 1 part by mass, sufficient reinforcement may not be achieved. Also, the amount of carbon black is preferably not more than 60 parts by mass, more preferably not more than 30 parts by mass, still more preferably not more than 15 parts by mass, and particularly preferably not more than 10 parts by mass. If the amount is more than 60 parts by mass, the fuel economy tends to deteriorate.

The nitrogen adsorption specific surface area (N₂SA) of carbon black is usually 5 to 200 m²/g; preferably, the lower limit and the upper limit thereof are 50 m²/g and 150 m²/g, respectively. The dibutyl phthalate (DBP) absorption of carbon black is usually 5 to 300 mL/100 g; preferably, the lower limit and the upper limit thereof are 80 mL/100 g and 180 mL/100 g, respectively. If the N₂SA or DBP absorption of carbon black is lower than the lower limit of the range mentioned above, the reinforcement effect tends to be so small that the abrasion resistance can be decreased. If the N₂SA or DBP absorption of carbon black is larger than the upper limit of the range mentioned above, the carbon black tends to poorly disperse, and thus the hysteresis loss tends to increase so that the fuel economy can be reduced. The nitrogen adsorption specific surface area is measured in accordance with ASTM D4820-93. The DBP absorption is measured in accordance with ASTM D2414-93. Examples of commercially available carbon black include SEAST 6, SEAST 7HM, and SEAST KH (trade name, produced by Tokai Carbon Co., Ltd.), and CK 3 and Special Black 4A (trade name, produced by Evonik Degussa).

Examples of the extender oils include aromatic mineral oils (viscosity-gravity constant (V.G.C. value): 0.900 to 1.049), naphthenic mineral oils (V.G.C. value: 0.850 to 0.899), and paraffinic mineral oils (V.G.C. value: 0.790 to 0.849). The polycyclic aromatics content in the extender oil is preferably less than 3% by mass, and more preferably less than 1% by mass. The polycyclic aromatics content is measured according to the British Institute of Petroleum 346/92 method. The aromatic compound content (CA) in the extender oil is preferably not less than 20% by mass. Two or more kinds of these extender oils may be used in combination.

From the viewpoint of achieving the effects of the present invention well, the amount of extender oil (oil) for each 100 parts by mass of the rubber component is preferably not less than 25 parts by mass, more preferably not less than 35 parts by mass, whereas it is preferably not more than 100 parts by mass, and more preferably not more than 80 parts by mass.

Examples of the vulcanization accelerators include thiazole vulcanization accelerators such as 2-mercaptobenzothiazole, dibenzothiazyl disulfide, and N-cyclohexyl-2-benzothiazylsulfenamide; thiuram vulcanization accelerators such as tetramethylthiuram monosulfide and tetramethylthiuram disulfide; sulfenamide vulcanization accelerators such as N-cyclohexyl-2-benzothiazolesulfenamide, N-t-butyl-2-benzothiazolesulfenamide, N-oxyethylene-2-benzothiazolesulfenamide, N-oxyethylene-2-benzothiazolesulfenamide, and N,N′-diisopropyl-2-benzothiazolesulfenamide; and guanidine vulcanization accelerators such as diphenylguanidine, diorthotolylguanidine, and orthotolylbiguanidine. The amount thereof to be used is preferably 0.1 to 5 parts by mass, and more preferably 0.2 to 3 parts by mass, for each 100 parts by mass of the rubber component.

The rubber composition may be prepared from the conjugated diene polymer combined with other rubber materials, additives and the like according to a known method, for example, by kneading components with a known mixer such as a roll mill or a Banbury mixer.

With regard to the kneading conditions when additives other than vulcanizing agents and vulcanization accelerators are mixed, the kneading temperature is usually 50 to 200° C., and preferably 80 to 190° C., and the kneading time is usually 30 seconds to 30 minutes, and preferably 1 minute to 30 minutes.

When a vulcanizing agent and a vulcanization accelerator are mixed, the kneading temperature is usually not higher than 100° C., and preferably ranges from room temperature to 80° C. The composition containing a vulcanizing agent and a vulcanization accelerator is usually used after it is vulcanized by press vulcanization or the like. The vulcanization temperature is usually 120 to 200° C., and preferably 140 to 180° C.

The rubber composition of the present invention is excellent in the balance among the performance on ice and snow, abrasion resistance, rubber strength, fuel economy, wet-grip performance, and dry handling stability, and thus provides effects of significantly improving these properties.

The rubber composition of the present invention can be used for various components of a tire, suitably in a tread of a studless winter tire.

The studless winter tire of the present invention can be formed from the rubber composition by a conventional method. Specifically, the unvulcanized rubber composition optionally containing additives is extruded and processed into the shape of a tire component (e.g. tread), and then formed in a conventional manner on a tire building machine and assembled with other tire components to build an unvulcanized tire. Then, the unvulcanized tire is heated and pressed in a vulcanizer to produce a studless winter tire of the present invention.

The studless winter tire of the present invention can be suitably used as studless winter tires for passenger vehicles.

### EXAMPLES

The present invention is more specifically described with reference to examples. However, the present invention is not limited thereto.

The following is a list of chemical agents used in the synthesis or polymerization. The chemical agents were purified, if needed, by usual methods.

THF: anhydrous tetrahydrofuran, produced by Kanto Chemical Co., Inc.
Sodium hydride: produced by Kanto Chemical Co., Inc.
Diethylamine: produced by Kanto Chemical Co., Inc.
Methylvinyldichlorosilane: produced by Shin-Etsu Chemical Co., Ltd.
Anhydrous hexane: produced by Kanto Chemical Co., Inc.
Styrene: produced by Kanto Chemical Co., Inc.
Butadiene: 1,3-butadiene, produced by Tokyo Chemical Industry Co., Ltd.
TMEDA: tetramethylethylenediamine, produced by Kanto Chemical Co., Inc.
n-Butyllithium solution: 1.6 M n-butyllithium in hexane, produced by Kanto Chemical Co., Inc.
Initiator (1): AI-200CE2 (compound formed by bonding 3-(N,N-dimethylamino)-1-propyllithium and two isoprene-derived structural units, represented by the following formula) (0.9 M), produced by FMC

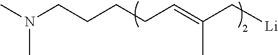

Piperidine: produced by Tokyo Chemical Industry Co., Ltd.
Diamylamine: produced by Tokyo Chemical Industry Co., Ltd.
2,6-Di-tert-butyl-p-cresol: Nocrac 200, produced by Ouchi Shinko Chemical Industrial Co., Ltd.
Bis(dimethylamino)methylvinylsilane: produced by Shin-Etsu Chemical Co., Ltd.
N,N-dimethylaminopropyl acrylamide: produced by Tokyo Chemical Industry Co., Ltd.
3-Diethylaminopropyltriethoxysilane: produced by Azmax Co
1,3-Dimethyl-2-imidazolidinone: produced by Tokyo Chemical Industry Co., Ltd.
N-phenyl-2-pyrrolidone: produced by Tokyo Chemical Industry Co., Ltd.
N-methyl-ε-caprolactam: produced by Tokyo Chemical Industry Co., Ltd.
Tris[3-(trimethoxysilyl)propyl]isocyanurate: produced by Shin-Etsu Chemical Co., Ltd.
N,N-dimethylformamide dimethyl acetal: produced by Tokyo Chemical Industry Co., Ltd.
1,3-Diisopropenylbenzene: produced by Tokyo Chemical Industry Co., Ltd.
sec-Butyllithium solution: produced by Kanto Chemical Co., Inc. (1.0 mol/L)
Cyclohexane: produced by Kanto Chemical Co., Inc.

### <Preparation of Modifier (1) (Main-Chain Modifier)>

In a nitrogen atmosphere, 15.8 g of bis(dimethylamino)methylvinylsilane was charged into a 100-mL volumetric flask, and anhydrous hexane was also added to increase the total amount to 100 mL. In this manner, a modifier (1) was prepared.

### <Preparation of Modifier (2) (Terminal Modifier)>

In a nitrogen atmosphere, 15.6 g of N,N-dimethylaminopropyl acrylamide was charged into a 100-mL volumetric flask, and anhydrous hexane was also added to increase the total amount to 100 mL. In this manner, a modifier (2) was prepared.

### <Preparation of Modifier (3) (Main-Chain Modifier)>

THF (1000 mL) and sodium hydride (13 g) were charged into a sufficiently nitrogen-purged 2-L three-necked flask, and diethylamine (36.5 g) was slowly added dropwise thereto on an ice water bath while stirring. After stirring for 30 minutes, methylvinyldichlorosilane (36 g) was added dropwise over 30 minutes, followed by stirring for 2 hours. The resulting solution was concentrated, filtered, and purified by distillation under reduced pressure to synthesize bis(diethylamino)methylvinylsilane. The bis(diethylamino)methylvinylsilane (21.4 g) was charged into a 100-mL volumetric flask in a nitrogen atmosphere, and anhydrous hexane was also added to increase the total amount to 100 mL.

### <Preparation of Initiator (2)>

Anhydrous hexane (127.6 mL) and piperidine (8.5 g) were charged into a sufficiently nitrogen-purged 200-mL recovery flask, and cooled to 0° C. Then, an n-butyllithium solution (62.5 mL) was slowly added over 1 hour to prepare an initiator (2).

### <Preparation of Initiator (3)>

Anhydrous hexane (117 mL) and diamylamine (15.7 g) were charged into a sufficiently nitrogen-purged 200-mL recovery flask, and cooled to 0° C. Then, an n-butyllithium solution (62.5 mL) was slowly added over 1 hour to prepare an initiator (3).

### <Preparation of Modifier (4) (Terminal Modifier)>

In a nitrogen atmosphere, 3-diethylaminopropyltriethoxysilane (27.7 g) was charged into a 100-mL volumetric flask, and anhydrous hexane was also added to increase the total amount to 100 mL. In this manner, a modifier (4) was prepared.

### <Preparation of Initiator (4) (Bifunctional Initiator)>

Cyclohexane (550 mL), TMEDA (27 mL), and a sec-butyllithium solution (200 mL) were charged into a sufficiently dried and nitrogen-purged 1-L recovery flask. While the mixture was stirred at 45° C., 1,3-diisopropenylbenzene (17 mL) was slowly added thereto over 30 minutes. The resulting mixed solution was further stirred for 1 hour, and then cooled to room temperature to prepare an initiator (4).

### <Preparation of Modifier (5) (Terminal Modifier)>

In a nitrogen atmosphere, 1,3-dimethyl-2-imidazolidinone (11.4 g) was charged into a 100-mL volumetric flask, and anhydrous hexane was also added to increase the total amount to 100 mL. In this manner, a modifier (5) was prepared.

### <Preparation of Modifier (6) (Terminal Modifier)>

In a nitrogen atmosphere, N-phenyl-2-pyrrolidone (16.1 g) was charged into a 100-mL volumetric flask, and anhydrous hexane was also added to increase the total amount to 100 mL. In this manner, a modifier (6) was prepared.

### <Preparation of Modifier (7) (Terminal Modifier)>

In a nitrogen atmosphere, N-methyl-ε-caprolactam (12.7 g) was charged into a 100-mL volumetric flask, and anhydrous hexane was also added to increase the total amount to 100 mL. In this manner, a modifier (7) was prepared.

### <Preparation of Modifier (8) (Terminal Modifier)>

In a nitrogen atmosphere, tris[3-(trimethoxysilyl)propyl]isocyanurate (30.7 g) was charged into a 100-mL volumetric flask, and anhydrous hexane was also added to increase the total amount to 200 ml. In this manner, a modifier (8) was prepared.

### <Preparation of Modifier (9) (Terminal Modifier)>

In a nitrogen atmosphere, N,N-dimethylformamide dimethyl acetal (11.9 g) was charged into a 100-mL volumetric flask, and anhydrous hexane was also added to increase the total amount to 200 mL. In this manner, a modifier (9) was prepared.

### <Copolymer Analysis>

Copolymers (conjugated diene polymers) obtained as mentioned later were analyzed by the following methods.

### <Measurement of Weight-Average Molecular Weight (Mw) and Number-Average Molecular Weight (Mn)>

The weight-average molecular weight (Mw) and number-average molecular weight (Mn) of each copolymer were measured using gel permeation chromatography (GPC) (GPC-8000 series produced by Tosoh Corporation, detector: differential refractometer, column: TSKGEL SUPERMULTIPORE HZ-M produced by Tosoh Corporation), and expressed relative to polystyrene standards. A molecular weight distribution Mw/Mn was calculated from the measurement results.

### <Structural Identification of Copolymers>

The structures (styrene content, vinyl content) of copolymers were identified with a device of JNM-ECA series produced by JEOL Ltd. Each polymer (0.1 g) was dissolved in toluene (15 mL), and the solution was slowly poured in methanol (30 mL) for reprecipitation. The resulting precipitate was dried under reduced pressure and then measured.

### <Synthesis of Copolymer (1)>

n-Hexane (18 L), styrene (600 g), butadiene (1400 g), the modifier (1) (40 mL), and TMEDA (10 mmol) were charged into a sufficiently nitrogen-purged 30-L pressure resistant container, and heated to 40° C. After further addition of the initiator (2) (34 mL), the mixture was heated to 50° C., and stirred for 3 hours. Next, the modifier (2) (20 mL) was added, followed by stirring for 30 minutes. The reaction solution was mixed with methanol (15 mL) and 2,6-tert-butyl-p-cresol (0.1 g). Then, a coagulum was recovered from the polymer solution by steam stripping treatment, and the coagulum was dried under reduced pressure for 24 hours to give a copolymer (1). Here, 0.32 g of the silicon-containing vinyl compound (modifier (1)) was introduced for each 100 g of the monomer component; 0.85 mmol of the polymerization initiator (initiator (2)) was introduced for each 100 g of the monomer component; and 1.18 mol of the compound (modifier (2)) containing a nitrogen atom and/or a silicon atom was introduced per mol of the alkali metal derived from the polymerization initiator introduced.

<Synthesis of copolymer (2)>

A copolymer (2) was produced based on the same formulation as that for the synthesis of the copolymer (1), except that the initiator (3) (34 mL) was used instead of the initiator (2) (34 mL). Here, 0.32 g of the silicon-containing vinyl compound (modifier (1)) was introduced for each 100 g of the monomer component; 0.85 mmol of the polymerization initiator (initiator (3)) was introduced for each 100 g of the monomer component; and 1.18 mol of the compound (modifier (2)) containing a nitrogen atom and/or a silicon atom was introduced per mol of the alkali metal derived from the polymerization initiator introduced.

### <Synthesis of Copolymer (3)>

A copolymer (3) was produced based on the same formulation as that for the synthesis of the copolymer (1), except that the amounts of styrene and butadiene were changed to 900 g and 1100 g, respectively. Here, 0.32 g of the silicon-containing vinyl compound (modifier (1)) was introduced for each 100 g of the monomer component; 0.85 mmol of the polymerization initiator (initiator (2)) was introduced for each 100 g of the monomer component; and 1.18 mol of the compound (modifier (2)) containing a nitrogen atom and/or a silicon atom was introduced per mol of the alkali metal derived from the polymerization initiator introduced.

### <Synthesis of Copolymer (4)>

A copolymer (4) was produced based on the same formulation as that for the synthesis of the copolymer (1), except that the initiator (1) (19 mL) was used instead of the initiator (2) (34 mL). Here, 0.32 g of the silicon-containing vinyl compound (modifier (1)) was introduced for each 100 g of the monomer component; 0.85 mmol of the polymerization initiator (initiator (1)) was introduced for each 100 g of the monomer component; and 1.18 mol of the compound (modifier (2)) containing a nitrogen atom and/or a silicon atom was introduced per mol of the alkali metal derived from the polymerization initiator introduced.

### <Synthesis of Copolymer (5)>

n-Hexane (18 L), styrene (600 g), butadiene (1400 g), the modifier (1) (75 mL), and TMEDA (10 mmol) were charged into a sufficiently nitrogen-purged 30-L pressure resistant container, and heated to 40° C. After further addition of the initiator (1) (19 mL), the mixture was heated to 50° C. and stirred for 30 minutes. Further, the modifier (1) (75 mL) was added, and the mixture was then stirred for 2.5 hours. Next, the modifier (2) (20 mL) was added, followed by stirring for 30 minutes. The reaction solution was mixed with methanol (1 mL) and 2,6-tert-butyl-p-cresol (0.1 g). Then, a coagulum was recovered from the polymer solution by steam stripping treatment, and the coagulum was dried under reduced pressure for 24 hours to give a copolymer (5). Here, 1.19 g of the silicon-containing vinyl compound (modifier (1)) was introduced for each 100 g of the monomer component; 0.85 mmol of the polymerization initiator (initiator (1)) was introduced for each 100 g of the monomer component; and 1.18 mol of the compound (modifier (2)) containing a nitrogen atom and/or a silicon atom was introduced per mol of the alkali metal derived from the polymerization initiator introduced.

### <Synthesis of Copolymer (6)>

A copolymer (6) was produced based on the same formulation as that for the synthesis of the copolymer (4), except that the amounts of styrene and butadiene were changed to 0 g and 2000 g, respectively; THF (5 mmol) was used instead of TMEDA (10 mmol); and the initiator (1) (23 mL) was used instead of the initiator (1) (19 mL). Here, 0.32 g of the silicon-containing vinyl compound (modifier (1)) was introduced for each 100 g of the monomer component; 1.05 mmol of the polymerization initiator (initiator (1)) was introduced for each 100 g of the monomer component; and 0.95 mol of the compound (modifier (2)) containing a nitrogen atom and/or a silicon atom was introduced per mol of the alkali metal derived from the polymerization initiator introduced.

### <Synthesis of Copolymer (7)>

A copolymer (7) was produced based on the same formulation as that for the synthesis of the copolymer (4), except that the modifier (3) (40 mL) was used instead of the modifier (1) (40 mL). Here, 0.43 g of the silicon-containing vinyl compound (modifier (3)) was introduced for each 100 g of the monomer component; 0.85 mmol of the polymerization initiator (initiator (1)) was introduced for each 100 g of the monomer component; and 1.18 mol of the compound (modifier (2)) containing a nitrogen atom and/or a silicon atom was introduced per mol of the alkali metal derived from the polymerization initiator introduced.

### <Synthesis of Copolymer (8)>

A copolymer (8) was produced based on the same formulation as that for the synthesis of the copolymer (7), except that an n-butyllithium solution (10.6 mL) was used instead of the initiator (1) (19 mL). Here, 0.43 g of the silicon-containing vinyl compound (modifier (3)) was introduced for each 100 g of the monomer component; and 1.18 mol of the compound (modifier (2)) containing a nitrogen atom and/or a silicon atom was introduced per mol of the alkali metal derived from the polymerization initiator introduced.

### <Synthesis of Copolymer (9)>

A copolymer (9) was produced based on the same formulation as that for the synthesis of the copolymer (6), except that an n-butyllithium solution (13 mL) was used instead of the initiator (1) (23 mL). Here, 0.43 g of the silicon-containing vinyl compound (modifier (1)) was introduced for each 100 g of the monomer component; and 0.95 mol of the compound (modifier (2)) containing a nitrogen atom and/or a silicon atom was introduced per mol of the alkali metal derived from the polymerization initiator introduced.

### <Synthesis of Copolymer (10)>

A copolymer (10) was produced based on the same formulation as that for the synthesis of the copolymer (1), except that the amount of the modifier (1) was changed from 40 mL to 0 mL. Here, 0.85 mmol of the polymerization initiator (initiator (2)) was introduced for each 100 g of the monomer component; and 1.18 mol of the compound (modifier (2)) containing a nitrogen atom and/or a silicon atom was introduced per mol of the alkali metal derived from the polymerization initiator introduced.

### <Synthesis of Copolymer (11)>

A copolymer (11) was produced based on the same formulation as that for the synthesis of the copolymer (1), except that the amount of the modifier (2) was changed from 20 mL to 0 mL. Here, 0.32 g of the silicon-containing vinyl compound (modifier (1)) was introduced for each 100 g of the monomer component; and 0.85 mmol of the polymerization initiator (initiator (2)) was introduced for each 100 g of the monomer component.

### <Synthesis of Copolymer (12)>

n-Hexane (18 L), styrene (600 g), butadiene (1400 g), and TMEDA (10 mmol) were charged into a sufficiently nitrogen-purged 30-L pressure resistant container, and heated to 40° C. After further addition of an n-butyllithium solution (11 mL), the mixture was heated to 50° C., and stirred for 3 hours. Next, the reaction solution was mixed with methanol (1 mL) and 2,6-tert-butyl-p-cresol (0.1 g). Then, a coagulum was recovered from the polymer solution by steam stripping treatment, and the coagulum was dried under reduced pressure for 24 hours to give a copolymer (12).

### <Synthesis of Copolymer (13)>

A copolymer (13) was produced based on the same formulation as that for the synthesis of the copolymer (7), except that a coagulum was recovered from the polymer solution by, instead of steam stripping treatment, evaporating the polymer solution at room temperature for 24 hours, followed by drying under reduced pressure. Here, 0.43 g of the silicon-containing vinyl compound (modifier (3)) was introduced for each 100 g of the monomer component; 0.85 mmol of the polymerization initiator (initiator (1)) was introduced for each 100 g of the monomer component; and 1.18 mol of the compound (modifier (2)) containing a nitrogen atom and/or a silicon atom was introduced per mol of the alkali metal derived from the polymerization initiator introduced.

### <Synthesis of Copolymer (14)>

A copolymer (14) was produced based on the same formulation as that for the synthesis of the copolymer (7), except that the amounts of the modifier (3) (40 mL) and the modifier (2) (20 mL) were both changed to 0 mL. Here, 8.5 mmol of the polymerization initiator (initiator (1)) was introduced for each 100 g of the monomer component.

### <Synthesis of Copolymer (15)>

A copolymer (15) was produced based on the same formulation as that for the synthesis of the copolymer (7), except that an n-butyllithium solution (6.8 mL) was used instead of the initiator (1) (19 mL), and the amount of the modifier (2) was changed from 20 mL to 0 mL. Here, 0.43 g of the silicon-containing vinyl compound (modifier (3)) was introduced for each 100 g of the monomer component.

### <Synthesis of Copolymer (16)>

A copolymer (16) was produced based on the same formulation as that for the synthesis of the copolymer (7), except that an n-butyllithium solution (6.8 mL) was used instead of the initiator (1) (19 mL), and the amount of the modifier (3) was changed from 40 mL to 0 mL. Here, 1.18 mol of the compound (modifier (2)) containing a nitrogen atom and/or a silicon atom was introduced per mol of the alkali metal derived from the polymerization initiator introduced.

### <Synthesis of Copolymer (17)>

A copolymer (17) was produced based on the same formulation as that for the synthesis of the copolymer (1), except that the initiator (4) (bifunctional initiator, 68 mL) was used instead of the initiator (2) (34 mL), and the amount of the modifier (2) was changed from 20 mL to 40 mL. Here, 0.32 g of the silicon-containing vinyl compound (modifier (1)) was introduced for each 100 g of the monomer component; and 2.28 mol (1.14 mol for each terminal) of the compound (modifier (2)) containing a nitrogen atom and/or a silicon atom was introduced per mol of the alkali metal derived from the polymerization initiator introduced.

### <Synthesis of Copolymer (18)>

A copolymer (18) was produced based on the same formulation as that for the synthesis of the copolymer (7), except that the amounts of styrene and butadiene were changed to 0 g and 2000 g, respectively; THF (5 mmol) was used instead of TMEDA (10 mmol); and the amount of the initiator (1) was changed from 19 mL to 23 mL. Here, 0.43 g of the silicon-containing vinyl compound (modifier (3)) was introduced for each 100 g of the monomer component; 0.85 mmol of the polymerization initiator (initiator (1)) was introduced for each 100 g of the monomer component; and 1.18 mol of the compound (modifier (2)) containing a nitrogen atom and/or a silicon atom was introduced per mol of the alkali metal derived from the polymerization initiator introduced.

### <Synthesis of Copolymer (19)>

A copolymer (19) was produced based on the same formulation as that for the synthesis of the copolymer (8), except that the amounts of styrene and butadiene were changed to 0 g and 2000 g, respectively, and THF (5 mmol) was used instead of TMEDA (10 mmol). Here, 0.43 g of the silicon-containing vinyl compound (modifier (3)) was introduced for each 100 g of the monomer component; and 1.18 mol of the compound (modifier (2)) containing a nitrogen atom and/or a silicon atom was introduced per mol of the alkali metal derived from the polymerization initiator introduced.

### <Synthesis of Copolymer (20)>

n-Hexane (18 L), butadiene (2000 g), and THF (5 mmol) were charged into a sufficiently nitrogen-purged 30-L pressure resistant container, and heated to 40° C. After further addition of an n-butyllithium solution (11 mL), the mixture was heated to 50° C., and stirred for 3 hours. Next, the reaction solution was mixed with methanol (1 mL) and 2,6-tert-butyl-p-cresol (0.1 g). Then, a coagulum was recovered from the polymer solution by steam stripping treatment, and the coagulum was dried under reduced pressure for 24 hours to give a copolymer (20).

### <Synthesis of Copolymer (21)>

A copolymer (21) was produced based on the same formulation as that for the synthesis of the copolymer (18), except that a coagulum was recovered from the polymer solution by, instead of steam stripping treatment, evaporating the polymer solution at room temperature for 24 hours, followed by drying under reduced pressure. Here, 0.43 g of the silicon-containing vinyl compound (modifier (3)) was introduced for each 100 g of the monomer component; 0.85 mmol of the polymerization initiator (initiator (1)) was introduced for each 100 g of the monomer component; and 1.18 mol of the compound (modifier (2)) containing a nitrogen atom and/or a silicon atom was introduced per mol of the alkali metal derived from the polymerization initiator introduced.

### <Synthesis of Copolymer (22)>

A copolymer (22) was produced based on the same formulation as that for the synthesis of the copolymer (1), except that the modifier (4) (20 mL) was used instead of the modifier (2) (20 mL). Here, 0.32 g of the silicon-containing vinyl compound (modifier (1)) was introduced for each 100 g of the monomer component; 0.85 mmol of the polymerization initiator (initiator (2)) was introduced for each 100 g of the monomer component; and 1.18 mol of the compound (modifier (4)) containing a nitrogen atom and/or a silicon atom was introduced per mol of the alkali metal derived from the polymerization initiator introduced.

### <Synthesis of Copolymer (23)>

A copolymer (23) was produced based on the same formulation as that for the synthesis of the copolymer (2), except that the modifier (4) (20 mL) was used instead of the modifier (2) (20 mL). Here, 0.32 g of the silicon-containing vinyl compound (modifier (1)) was introduced for each 100 g of the monomer component; 0.85 mmol of the polymerization initiator (initiator (3)) was introduced for each 100 g of the monomer component; and 1.18 mol of the compound (modifier (4)) containing a nitrogen atom and/or a silicon atom was introduced per mol of the alkali metal derived from the polymerization initiator introduced.

### <Synthesis of Copolymer (24)>

A copolymer (24) was produced based on the same formulation as that for the synthesis of the copolymer (3), except that the modifier (4) (20 mL) was used instead of the modifier (2) (20 mL). Here, 0.32 g of the silicon-containing vinyl compound (modifier (1)) was introduced for each 100 g of the monomer component; 0.85 mmol of the polymerization initiator (initiator (2)) was introduced for each 100 g of the monomer component; and 1.18 mol of the compound (modifier (4)) containing a nitrogen atom and/or a silicon atom was introduced per mol of the alkali metal derived from the polymerization initiator introduced.

### <Synthesis of Copolymer (25)>

A copolymer (25) was produced based on the same formulation as that for the synthesis of the copolymer (4), except that the modifier (4) (20 mL) was used instead of the modifier (2) (20 mL). Here, 0.32 g of the silicon-containing vinyl compound (modifier (1)) was introduced for each 100 g of the monomer component; 0.85 mmol of the polymerization initiator (initiator (1)) was introduced for each 100 g of the monomer component; and 1.18 mol of the compound (modifier (4)) containing a nitrogen atom and/or a silicon atom was introduced per mol of the alkali metal derived from the polymerization initiator introduced.

### <Synthesis of Copolymer (26)>

A copolymer (26) was produced based on the same formulation as that for the synthesis of the copolymer (5), except that the modifier (4) (20 mL) was used instead of the modifier (2) (20 mL). Here, 1.19 g of the silicon-containing vinyl compound (modifier (1)) was introduced for each 100 g of the monomer component; 0.85 mmol of the polymerization initiator (initiator (1)) was introduced for each 100 g of the monomer component; and 1.18 mol of the compound (modifier (4)) containing a nitrogen atom and/or a silicon atom was introduced per mol of the alkali metal derived from the polymerization initiator introduced.

### <Synthesis of Copolymer (27)>

A copolymer (27) was produced based on the same formulation as that for the synthesis of the copolymer (6), except that the modifier (4) (20 mL) was used instead of the modifier (2) (20 mL). Here, 0.32 g of the silicon-containing vinyl compound (modifier (1)) was introduced for each 100 g of the monomer component; 1.05 mmol of the polymerization initiator (initiator (1)) was introduced for each 100 g of the monomer component; and 0.95 mol of the compound (modifier (4)) containing a nitrogen atom and/or a silicon atom was introduced per mol of the alkali metal derived from the polymerization initiator introduced.

### <Synthesis of Copolymer (28)>

A copolymer (28) was produced based on the same formulation as that for the synthesis of the copolymer (7), except that the modifier (4) (20 mL) was used instead of the modifier (2) (20 mL). Here, 0.32 g of the silicon-containing vinyl compound (modifier (3)) was introduced for each 100 g of the monomer component; 0.85 mmol of the polymerization initiator (initiator (1)) was introduced for each 100 g of the monomer component; and 1.18 mol of the compound (modifier (4)) containing a nitrogen atom and/or a silicon atom was introduced per mol of the alkali metal derived from the polymerization initiator introduced.

### <Synthesis of Copolymer (29)>

A copolymer (29) was produced based on the same formulation as that for the synthesis of the copolymer (28), except that a coagulum was recovered from the polymer solution by, instead of steam stripping treatment, evaporating the polymer solution at room temperature for 24 hours, followed by drying under reduced pressure. Here, 0.32 g of the silicon-containing vinyl compound (modifier (3)) was introduced for each 100 g of the monomer component; 0.85 mmol of the polymerization initiator (initiator (1)) was introduced for each 100 g of the monomer component; and 1.18 mol of the compound (modifier (4)) containing a nitrogen atom and/or a silicon atom was introduced per mol of the alkali metal derived from the polymerization initiator introduced.

### <Synthesis of Copolymer (30)>

A copolymer (30) was produced based on the same formulation as that for the synthesis of the copolymer (28), except that an n-butyllithium solution (10.6 mL) was used instead of the initiator (1) (19 mL), and the amount of the modifier (3) was changed from 40 mL to 0 mL. Here, 1.18 mol of the compound (modifier (4)) containing a nitrogen atom and/or a silicon atom was introduced per mol of the alkali metal derived from the polymerization initiator introduced.

### <Synthesis of Copolymer (31)>

A copolymer (31) was produced based on the same formulation as that for the synthesis of the copolymer (18), except that the modifier (4) (20 mL) was used instead of the modifier (2) (20 mL). Here, 0.32 g of the silicon-containing vinyl compound (modifier (3)) was introduced for each 100 g of the monomer component; 0.85 mmol of the polymerization initiator (initiator (1)) was introduced for each 100 g of the monomer component; and 1.18 mol of the compound (modifier (4)) containing a nitrogen atom and/or a silicon atom was introduced per mol of the alkali metal derived from the polymerization initiator introduced.

### <Synthesis of Copolymer (32)>

A copolymer (32) was produced based on the same formulation as that for the synthesis of the copolymer (31), except that a coagulum was recovered from the polymer solution by, instead of steam stripping treatment, evaporating the polymer solution at room temperature for 24 hours, followed by drying under reduced pressure. Here, 0.32 g of the silicon-containing vinyl compound (modifier (3)) was introduced for each 100 g of the monomer component; 0.85 mmol of the polymerization initiator (initiator (1)) was introduced for each 100 g of the monomer component; and 1.18 mol of the compound (modifier (4)) containing a nitrogen atom and/or a silicon atom was introduced per mol of the alkali metal derived from the polymerization initiator introduced.

### <Synthesis of Copolymer (33)>

A copolymer (33) was produced based on the same formulation as that for the synthesis of the copolymer (1), except that the modifier (5) (20 mL) was used instead of the modifier (2) (20 mL). Here, 0.32 g of the silicon-containing vinyl compound (modifier (1)) was introduced for each 100 g of the monomer component; 0.85 mmol of the polymerization initiator (initiator (2)) was introduced for each 100 g of the monomer component; and 1.18 mol of the compound (modifier (5)) containing a nitrogen atom and/or a silicon atom was introduced per mol of the alkali metal derived from the polymerization initiator introduced.

### <Synthesis of Copolymer (34)>

A copolymer (34) was produced based on the same formulation as that for the synthesis of the copolymer (2), except that the modifier (5) (20 mL) was used instead of the modifier (2) (20 mL). Here, 0.32 g of the silicon-containing vinyl compound (modifier (1)) was introduced for each 100 g of the monomer component; 0.85 mmol of the polymerization initiator (initiator (3)) was introduced for each 100 g of the monomer component; and 1.18 mol of the compound (modifier (5)) containing a nitrogen atom and/or a silicon atom was introduced per mol of the alkali metal derived from the polymerization initiator introduced.

### <Synthesis of Copolymer (35)>

A copolymer (35) was produced based on the same formulation as that for the synthesis of the copolymer (3), except that the modifier (5) (20 mL) was used instead of the modifier (2) (20 mL). Here, 0.32 g of the silicon-containing vinyl compound (modifier (1)) was introduced for each 100 g of the monomer component; 0.85 mmol of the polymerization initiator (initiator (2)) was introduced for each 100 g of the monomer component; and 1.18 mol of the compound (modifier (5)) containing a nitrogen atom and/or a silicon atom was introduced per mol of the alkali metal derived from the polymerization initiator introduced.

### <Synthesis of Copolymer (36)>

A copolymer (36) was produced based on the same formulation as that for the synthesis of the copolymer (4), except that the modifier (5) (20 mL) was used instead of the modifier (2) (20 mL). Here, 0.32 g of the silicon-containing vinyl compound (modifier (1)) was introduced for each 100 g of the monomer component; 0.85 mmol of the polymerization initiator (initiator (1)) was introduced for each 100 g of the monomer component; and 1.18 mol of the compound (modifier (5)) containing a nitrogen atom and/or a silicon atom was introduced per mol of the alkali metal derived from the polymerization initiator introduced.

### <Synthesis of Copolymer (37)>

A copolymer (37) was produced based on the same formulation as that for the synthesis of the copolymer (5), except that the modifier (5) (20 mL) was used instead of the modifier (2) (20 mL). Here, 1.19 g of the silicon-containing vinyl compound (modifier (1)) was introduced for each 100 g of the monomer component; 0.85 mmol of the polymerization initiator (initiator (1)) was introduced for each 100 g of the monomer component; and 1.18 mol of the compound (modifier (5)) containing a nitrogen atom and/or a silicon atom was introduced per mol of the alkali metal derived from the polymerization initiator introduced.

### <Synthesis of Copolymer (38)>

A copolymer (38) was produced based on the same formulation as that for the synthesis of the copolymer (7), except that the modifier (5) (20 mL) was used instead of the modifier (2) (20 mL). Here, 0.32 g of the silicon-containing vinyl compound (modifier (3)) was introduced for each 100 g of the monomer component; 0.85 mmol of the polymerization initiator (initiator (1)) was introduced for each 100 g of the monomer component; and 1.18 mol of the compound (modifier (5)) containing a nitrogen atom and/or a silicon atom was introduced per mol of the alkali metal derived from the polymerization initiator introduced.

### <Synthesis of Copolymer (39)>

A copolymer (39) was produced based on the same formulation as that for the synthesis of the copolymer (38), except that a coagulum was recovered from the polymer solution by, instead of steam stripping treatment, evaporating the polymer solution at room temperature for 24 hours, followed by drying under reduced pressure. Here, 0.32 g of the silicon-containing vinyl compound (modifier (3)) was introduced for each 100 g of the monomer component; 0.85 mmol of the polymerization initiator (initiator (1)) was introduced for each 100 g of the monomer component; and 1.18 mol of the compound (modifier (5)) containing a nitrogen atom and/or a silicon atom was introduced per mol of the alkali metal derived from the polymerization initiator introduced.

### <Synthesis of Copolymer (40)>

A copolymer (40) was produced based on the same formulation as that for the synthesis of the copolymer (7), except that the modifier (6) (20 mL) was used instead of the modifier (2) (20 mL). Here, 0.32 g of the silicon-containing vinyl compound (modifier (3)) was introduced for each 100 g of the monomer component; 0.85 mmol of the polymerization initiator (initiator (1)) was introduced for each 100 g of the monomer component; and 1.18 mol of the compound (modifier (6)) containing a nitrogen atom and/or a silicon atom was introduced per mol of the alkali metal derived from the polymerization initiator introduced.

### <Synthesis of Copolymer (41)>

A copolymer (41) was produced based on the same formulation as that for the synthesis of the copolymer (7), except that the modifier (7) (20 mL) was used instead of the modifier (2) (20 mL). Here, 0.32 g of the silicon-containing vinyl compound (modifier (3)) was introduced for each 100 g of the monomer component; 0.85 mmol of the polymerization initiator (initiator (1)) was introduced for each 100 g of the monomer component; and 1.18 mol of the compound (modifier (7)) containing a nitrogen atom and/or a silicon atom was introduced per mol of the alkali metal derived from the polymerization initiator introduced.

### <Synthesis of Copolymer (42)>

A copolymer (42) was produced based on the same formulation as that for the synthesis of the copolymer (38), except that a butyllithium solution (10.6 mL) was used instead of the initiator (1) (19 mL), and the amount of the modifier (3) was changed from 40 mL to 0 mL. Here, 1.18 mol of the compound (modifier (5)) containing a nitrogen atom and/or a silicon atom was introduced per mol of the alkali metal derived from the polymerization initiator introduced.

### <Synthesis of Copolymer (43)>

A copolymer (43) was produced based on the same formulation as that for the synthesis of the copolymer (1), except that the modifier (8) (20 mL) was used instead of the modifier (2) (20 mL). Here, 0.32 g of the silicon-containing vinyl compound (modifier (1)) was introduced for each 100 g of the monomer component; 0.85 mmol of the polymerization initiator (initiator (2)) was introduced for each 100 g of the monomer component; and 1.18 mol of the compound (modifier (8)) containing a nitrogen atom and/or a silicon atom was introduced per mol of the alkali metal derived from the polymerization initiator introduced.

### <Synthesis of Copolymer (44)>

A copolymer (44) was produced based on the same formulation as that for the synthesis of the copolymer (2), except that the modifier (8) (20 mL) was used instead of the modifier (2) (20 mL). Here, 0.32 g of the silicon-containing vinyl compound (modifier (1)) was introduced for each 100 g of the monomer component; 0.85 mmol of the polymerization initiator (initiator (3)) was introduced for each 100 g of the monomer component; and 1.18 mol of the compound (modifier (8)) containing a nitrogen atom and/or a silicon atom was introduced per mol of the alkali metal derived from the polymerization initiator introduced.

### <Synthesis of Copolymer (45)>

A copolymer (45) was produced based on the same formulation as that for the synthesis of the copolymer (3), except that the modifier (8) (20 mL) was used instead of the modifier (2) (20 mL). Here, 0.32 g of the silicon-containing vinyl compound (modifier (1)) was introduced for each 100 g of the monomer component; 0.85 mmol of the polymerization initiator (initiator (2)) was introduced for each 100 g of the monomer component; and 1.18 mol of the compound (modifier (8)) containing a nitrogen atom and/or a silicon atom was introduced per mol of the alkali metal derived from the polymerization initiator introduced.

### <Synthesis of Copolymer (46)>

A copolymer (46) was produced based on the same formulation as that for the synthesis of the copolymer (4), except that the modifier (8) (20 mL) was used instead of the modifier (2) (20 mL). Here, 0.32 g of the silicon-containing vinyl compound (modifier (1)) was introduced for each 100 g of the monomer component; 0.85 mmol of the polymerization initiator (initiator (1)) was introduced for each 100 g of the monomer component; and 1.18 mol of the compound (modifier (8)) containing a nitrogen atom and/or a silicon atom was introduced per mol of the alkali metal derived from the polymerization initiator introduced.

### <Synthesis of Copolymer (47)>

A copolymer (47) was produced based on the same formulation as that for the synthesis of the copolymer (5), except that the modifier (8) (20 mL) was used instead of the modifier (2) (20 mL). Here, 1.19 g of the silicon-containing vinyl compound (modifier (1)) was introduced for each 100 g of the monomer component; 0.85 mmol of the polymerization initiator (initiator (1)) was introduced for each 100 g of the monomer component; and 1.18 mol of the compound (modifier (8)) containing a nitrogen atom and/or a silicon atom was introduced per mol of the alkali metal derived from the polymerization initiator introduced.

### <Synthesis of Copolymer (48)>

A copolymer (48) was produced based on the same formulation as that for the synthesis of the copolymer (7), except that the modifier (8) (20 mL) was used instead of the modifier (2) (20 mL). Here, 0.32 g of the silicon-containing vinyl compound (modifier (3)) was introduced for each 100 g of the monomer component; 0.85 mmol of the polymerization initiator (initiator (1)) was introduced for each 100 g of the monomer component; and 1.18 mol of the compound (modifier (8)) containing a nitrogen atom and/or a silicon atom was introduced per mol of the alkali metal derived from the polymerization initiator introduced.

### <Synthesis of Copolymer (49)>

A copolymer (49) was produced based on the same formulation as that for the synthesis of the copolymer (48), except that a coagulum was recovered from the polymer solution by, instead of steam stripping treatment, evaporating the polymer solution at room temperature for 24 hours, followed by drying under reduced pressure. Here, 0.32 g of the silicon-containing vinyl compound (modifier (3)) was introduced for each 100 g of the monomer component; 0.85 mmol of the polymerization initiator (initiator (1)) was introduced for each 100 g of the monomer component; and 1.18 mol of the compound (modifier (8)) containing a nitrogen atom and/or a silicon atom was introduced per mol of the alkali metal derived from the polymerization initiator introduced.

### <Synthesis of Copolymer (50)>

A copolymer (50) was produced based on the same formulation as that for the synthesis of the copolymer (48), except that a butyllithium solution (10.6 mL) was used instead of the initiator (1) (19 mL), and the amount of the modifier (3) was changed from 40 mL to 0 mL. Here, 1.18 mol of the compound (modifier (8)) containing a nitrogen atom and/or a silicon atom was introduced per mol of the alkali metal derived from the polymerization initiator introduced.

### <Synthesis of Copolymer (51)>

A copolymer (51) was produced based on the same formulation as that for the synthesis of the copolymer (1), except that the modifier (9) (20 mL) was used instead of the modifier (2) (20 mL). Here, 0.32 g of the silicon-containing vinyl compound (modifier (1)) was introduced for each 100 g of the monomer component; 0.85 mmol of the polymerization initiator (initiator (2)) was introduced for each 100 g of the monomer component; and 1.18 mol of the compound (modifier (9)) containing a nitrogen atom and/or a silicon atom was introduced per mol of the alkali metal derived from the polymerization initiator introduced.

### <Synthesis of Copolymer (52)>

A copolymer (52) was produced based on the same formulation as that for the synthesis of the copolymer (2), except that the modifier (9) (20 mL) was used instead of the modifier (2) (20 mL). Here, 0.32 g of the silicon-containing vinyl compound (modifier (1)) was introduced for each 100 g of the monomer component; 0.85 mmol of the polymerization initiator (initiator (3)) was introduced for each 100 g of the monomer component; and 1.18 mol of the compound (modifier (9)) containing a nitrogen atom and/or a silicon atom was introduced per mol of the alkali metal derived from the polymerization initiator introduced.

### <Synthesis of Copolymer (53)>

A copolymer (53) was produced based on the same formulation as that for the synthesis of the copolymer (3), except that the modifier (9) (20 mL) was used instead of the modifier (2) (20 mL). Here, 0.32 g of the silicon-containing vinyl compound (modifier (1)) was introduced for each 100 g of the monomer component; 0.85 mmol of the polymerization initiator (initiator (2)) was introduced for each 100 g of the monomer component; and 1.18 mol of the compound (modifier (9)) containing a nitrogen atom and/or a silicon atom was introduced per mol of the alkali metal derived from the polymerization initiator introduced.

### <Synthesis of Copolymer (54)>

A copolymer (54) was produced based on the same formulation as that for the synthesis of the copolymer (4), except that the modifier (9) (20 mL) was used instead of the modifier (2) (20 mL). Here, 0.32 g of the silicon-containing vinyl compound (modifier (1)) was introduced for each 100 g of the monomer component; 0.85 mmol of the polymerization initiator (initiator (1)) was introduced for each 100 g of the monomer component; and 1.18 mol of the compound (modifier (9)) containing a nitrogen atom and/or a silicon atom was introduced per mol of the alkali metal derived from the polymerization initiator introduced.

### <Synthesis of Copolymer (55)>

A copolymer (55) was produced based on the same formulation as that for the synthesis of the copolymer (5), except that the modifier (9) (20 mL) was used instead of the modifier (2) (20 mL). Here, 1.19 g of the silicon-containing vinyl compound (modifier (1)) was introduced for each 100 g of the monomer component; 0.85 mmol of the polymerization initiator (initiator (1)) was introduced for each 100 g of the monomer component; and 1.18 mol of the compound (modifier (9)) containing a nitrogen atom and/or a silicon atom was introduced per mol of the alkali metal derived from the polymerization initiator introduced.

### <Synthesis of Copolymer (56)>

A copolymer (56) was produced based on the same formulation as that for the synthesis of the copolymer (7), except that the modifier (9) (20 mL) was used instead of the modifier (2) (20 mL). Here, 0.32 g of the silicon-containing vinyl compound (modifier (3)) was introduced for each 100 g of the monomer component; 0.85 mmol of the polymerization initiator (initiator (1)) was introduced for each 100 g of the monomer component; and 1.18 mol of the compound (modifier (9)) containing a nitrogen atom and/or a silicon atom was introduced per mol of the alkali metal derived from the polymerization initiator introduced.

### <Synthesis of Copolymer (57)>

A copolymer (57) was produced based on the same formulation as that for the synthesis of the copolymer (56), except that a coagulum was recovered from the polymer solution by, instead of steam stripping treatment, evaporating the polymer solution at room temperature for 24 hours, followed by drying under reduced pressure. Here, 0.32 g of the silicon-containing vinyl compound (modifier (3)) was introduced for each 100 g of the monomer component; 0.85 mmol of the polymerization initiator (initiator (1)) was introduced for each 100 g of the monomer component; and 1.18 mol of the compound (modifier (9)) containing a nitrogen atom and/or a silicon atom was introduced per mol of the alkali metal derived from the polymerization initiator introduced.

### <Synthesis of Copolymer (58)>

A copolymer (58) was produced based on the same formulation as that for the synthesis of the copolymer (56), except that a butyllithium solution (10.6 mL) was used instead of the initiator (1) (19 mL), and the amount of the modifier (3) was changed from 40 mL to 0 mL. Here, 1.18 mol of the compound (modifier (9)) containing a nitrogen atom and/or a silicon atom was introduced per mol of the alkali metal derived from the polymerization initiator introduced.

Tables 1 to 5 summarize the monomer components and others of the copolymers (1) to (58).

TABLE 1
Examples in which a compound represented by the formula (IIId) is used as a Terminal modifier

| | | | | | | Molecular | Molecular |
|---|---|---|---|---|---|---|---|
| | | | | Styrene | | weight | weight |
| | | | | content | Vinyl | distri- | Mw (unit: |
| | | | Terminal | (% by | content | bution | ten |
| Copolymer | Initiator | Monomer component | modifier | mass) | (mol %) | Mw/Mn | thousand) |
| Copolymer (1) | Initiator (2) | Styrene, 1,3-Butadiene, Modifier (1) | Modifier (2) | 30 | 56 | 1.21 | 26.5 |
| Copolymer (2) | Initiator (3) | Styrene, 1,3-Butadiene, Modifier (1) | Modifier (2) | 30 | 57 | 1.23 | 26.8 |
| Copolymer (3) | Initiator (2) | Styrene, 1,3-Butadiene, Modifier (1) | Modifier (2) | 45 | 56 | 1.23 | 26.9 |
| Copolymer (4) | Initiator (1) | Styrene, 1,3-Butadiene, Modifier (1) | Modifier (2) | 30 | 56 | 1.13 | 24.8 |
| Copolymer (5) | Initiator (1) | Styrene, 1,3-Butadiene, Modifier (1) | Modifier (2) | 30 | 56 | 1.20 | 27.1 |
| Copolymer (6) | Initiator (1) | 1,3-Butadiene, Modifier (1) | Modifier (2) | 0 | 14.2 | 1.17 | 28.9 |
| Copolymer (7) | Initiator (1) | Styrene, 1,3-Butadiene, Modifier (3) | Modifier (2) | 30 | 56 | 1.18 | 26.0 |
| Copolymer (8) | n-Butyllithium solution | Styrene, 1,3-Butadiene, Modifier (3) | Modifier (2) | 30 | 55 | 1.17 | 24.5 |
| Copolymer (9) | n-Butyllithium solution | 1,3-Butadiene, Modifier (1) | Modifier (2) | 0 | 13.5 | 1.16 | 29.3 |
| Copolymer (10) | Initiator (2) | Styrene, 1,3-Butadiene | Modifier (2) | 30 | 56 | 1.19 | 25.0 |
| Copolymer (11) | Initiator (2) | Styrene, 1,3-Butadiene, Modifier (1) | Not added | 30 | 56 | 1.25 | 25.4 |
| Copolymer (12) | n-Butyllithium solution | Styrene, 1,3-Butadiene | Not added | 30 | 56 | 1.09 | 26.5 |
| Copolymer (13) | Initiator (1) | Styrene, 1,3-Butadiene, Modifier (3) | Modifier (2) | 30 | 57 | 1.19 | 25.2 |
| Copolymer (14) | Initiator (1) | Styrene, 1,3-Butadiene | Not added | 30 | 57 | 1.16 | 26.1 |
| Copolymer (15) | n-Butyllithium solution | Styrene, 1,3-Butadiene, Modifier (3) | Not added | 30 | 56 | 1.13 | 27.9 |
| Copolymer (16) | n-Butyllithium solution | Styrene, 1,3-Butadiene | Modifier (2) | 30 | 55 | 1.10 | 27.4 |
| Copolymer (17) | Initiator (4) | Styrene, 1,3-Butadiene, Modifier (1) | Modifier (2) | 30 | 55 | 1.29 | 28.9 |
| Copolymer (18) | Initiator (1) | 1,3-Butadiene, Modifier (3) | Modifier (2) | 0 | 14.2 | 1.19 | 26.2 |
| Copolymer (19) | n-Butyllithium solution | 1,3-Butadiene, Modifier (3) | Modifier (2) | 0 | 13.7 | 1.16 | 25.2 |
| Copolymer (20) | n-Butyllithium solution | 1,3-Butadiene | Not added | 0 | 13.9 | 1.11 | 27.1 |
| Copolymer (21) | Initiator (1) | 1,3-Butadiene, Modifier (3) | Modifier (2) | 0 | 14 | 1.21 | 26.3 |

TABLE 2
Examples in which a compound represented by the formula (IV) is used as a Terminal modifier

| | | | | | | Molecular | Molecular |
|---|---|---|---|---|---|---|---|
| | | | | Styrene | | weight | weight |
| | | | | content | Vinyl | Distri- | Mw (unit: |
| | | | Terminal | (% by | content | bution | ten |
| Copolymer | Initiator | Monomer component | modifier | mass) | (mol %) | Mw/Mn | thousand) |
| Copolymer (22) | Initiator (2) | Styrene, 1,3-Butadiene, Modifier (1) | Modifier (4) | 30 | 57 | 1.26 | 28.3 |
| Copolymer (23) | Initiator (3) | Styrene, 1,3-Butadiene, Modifier (1) | Modifier (4) | 30 | 57 | 1.28 | 28.0 |
| Copolymer (24) | Initiator (2) | Styrene, 1,3-Butadiene, Modifier (1) | Modifier (4) | 45 | 56 | 1.25 | 29.2 |
| Copolymer (25) | Initiator (1) | Styrene, 1,3-Butadiene, Modifier (1) | Modifier (4) | 30 | 56 | 1.19 | 27.2 |
| Copolymer (26) | Initiator (1) | Styrene, 1,3-Butadiene, Modifier (1) | Modifier (4) | 30 | 57 | 1.17 | 26.1 |
| Copolymer (27) | Initiator (1) | 1,3-Butadiene, Modifier (1) | Modifier (4) | 0 | 13.9 | 1.17 | 25.9 |
| Copolymer (28) | Initiator (1) | Styrene, 1,3-Butadiene, Modifier (3) | Modifier (4) | 30 | 56 | 1.20 | 25.8 |
| Copolymer (29) | Initiator (1) | Styrene, 1,3-Butadiene, Modifier (3) | Modifier (4) | 30 | 58 | 1.18 | 26.2 |
| Copolymer (30) | n-Butyllithium solution | Styrene, 1,3-Butadiene | Modifier (4) | 30 | 56 | 1.14 | 27.1 |
| Copolymer (31) | Initiator (1) | 1,3-Butadiene, Modifier (3) | Modifier (4) | 0 | 14.1 | 1.21 | 26.2 |
| Copolymer (32) | Initiator (1) | 1,3-Butadiene, Modifier (3) | Modifier (4) | 0 | 14.2 | 1.18 | 26.8 |

TABLE 3
Examples in which a compound represented by the formula (IIIb) is used as a Terminal modifier

| | | | | | | Molecular | Molecular |
|---|---|---|---|---|---|---|---|
| | | | | Styrene | | weight | weight |
| | | | | content | Vinyl | distri- | Mw (unit |
| | | | Terminal | (% by | content | bution | ten |
| Copolymer | Initiator | Monomer component | modifier | mass) | (mol %) | Mw/Mn | thousand) |
| Copolymer (33) | Initiator (2) | Styrene, 1,3-Butadiene, Modifier (1) | Modifier (5) | 30 | 57 | 1.18 | 27.1 |
| Copolymer (34) | Initiator (3) | Styrene, 1,3-Butadiene, Modifier (1) | Modifier (5) | 30 | 56 | 1.16 | 26.3 |
| Copolymer (35) | Initiator (2) | Styrene, 1,3-Butadiene, Modifier (1) | Modifier (5) | 45 | 56 | 1.16 | 24.6 |
| Copolymer (36) | Initiator (1) | Styrene, 1,3-Butadiene, Modifier (1) | Modifier (5) | 30 | 57 | 1.12 | 24.9 |
| Copolymer (37) | Initiator (1) | Styrene, 1,3-Butadiene, Modifier (1) | Modifier (5) | 30 | 56 | 1.13 | 26.7 |
| Copolymer (38) | Initiator (1) | Styrene, 1,3-Butadiene, Modifier (3) | Modifier (5) | 30 | 56 | 1.13 | 25.6 |
| Copolymer (39) | Initiator (1) | Styrene, 1,3-Butadiene, Modifier (3) | Modifier (5) | 30 | 56 | 1.10 | 25.5 |
| Copolymer (40) | Initiator (1) | Styrene, 1,3-Butadiene, Modifier (3) | Modifier (6) | 30 | 57 | 1.14 | 25.2 |
| Copolymer (41) | Initiator (1) | Styrene, 1,3-Butadiene, Modifier (3) | Modifier (7) | 30 | 56 | 1.15 | 25.9 |
| Copolymer (42) | n-Butyllithium solution | Styrene, 1,3-Butadiene | Modifier (5) | 30 | 55 | 1.09 | 26.3 |

TABLE 4
Examples in which a compound containing an alkoxysilyl group, a nitrogen atom and a carbonyl group is used as a Terminal modifier

| | | | | | | Molecular | Molecular |
|---|---|---|---|---|---|---|---|
| | | | | Styrene | | weight | weight |
| | | | | content | Vinyl | distri- | Mw (unit: |
| | | | Terminal | (% by | content | bution | ten |
| Copolymer | Initiator | Monomer component | modifier | mass) | (mol %) | Mw/Mn | thousand) |
| Copolymer (43) | Initiator (2) | Styrene, 1,3-Butadiene, Modifier (1) | Modifier (8) | 30 | 56 | 1.24 | 27.5 |
| Copolymer (44) | Initiator (3) | Styrene, 1,3-Butadiene, Modifier (1) | Modifier (8) | 30 | 56 | 1.22 | 28.3 |
| Copolymer (45) | Initiator (2) | Styrene, 1,3-Butadiene, Modifier (1) | Modifier (8) | 45 | 57 | 1.23 | 27.8 |
| Copolymer (46) | Initiator (1) | Styrene, 1,3-Butadiene, Modifier (1) | Modifier (8) | 30 | 56 | 1.20 | 28.5 |
| Copolymer (47) | Initiator (1) | Styrene, 1,3-Butadiene, Modifier (1) | Modifier (8) | 30 | 55 | 1.19 | 28.6 |
| Copolymer (48) | Initiator (1) | Styrene, 1,3-Butadiene, Modifier (3) | Modifier (8) | 30 | 56 | 1.22 | 28.3 |
| Copolymer (49) | Initiator (1) | Styrene, 1,3-Butadiene, Modifier (3) | Modifier (8) | 30 | 57 | 1.18 | 28.0 |
| Copolymer (50) | n-Butyllithium solution | Styrene, 1,3-Butadiene | Modifier (8) | 30 | 56 | 1.16 | 27.3 |

TABLE 5
Examples in which an N,N-dialkyl-substituted carboxylic acid amide dialkyl acetal compound is used as a Terminal modifier

| | | | | | | Molecular | Molecular |
|---|---|---|---|---|---|---|---|
| | | | | Styrene | | weight | weight |
| | | | | content | Vinyl | distri- | Mw (unit: |
| | | | Terminal | (% by | content | bution | ten |
| Copolymer | Initiator | Monomer component | modifier | mass) | (mol %) | Mw/Mn | thousand) |
| Copolymer (51) | Initiator (2) | Styrene, 1,3-Butadiene, Modifier (1) | Modifier (9) | 30 | 57 | 1.20 | 27.2 |
| Copolymer (52) | Initiator (3) | Styrene, 1,3-Butadiene, Modifier (1) | Modifier (9) | 30 | 56 | 1.21 | 27.3 |
| Copolymer (53) | Initiator (2) | Styrene, 1,3-Butadiene, Modifier (1) | Modifier (9) | 45 | 55 | 1.21 | 27.8 |
| Copolymer (54) | Initiator (1) | Styrene, 1,3-Butadiene, Modifier (1) | Modifier (9) | 30 | 56 | 1.20 | 27.6 |
| Copolymer (55) | Initiator (1) | Styrene, 1,3-Butadiene, Modifier (1) | Modifier (9) | 30 | 56 | 1.19 | 26.9 |
| Copolymer (56) | Initiator (1) | Styrene, 1,3-Butadiene, Modifier (3) | Modifier (9) | 30 | 57 | 1.18 | 26.8 |
| Copolymer (57) | Initiator (1) | Styrene, 1,3-Butadiene, Modifier (3) | Modifier (9) | 30 | 56 | 1.20 | 28.1 |
| Copolymer (58) | n-Butyllithium solution | Styrene, 1,3-Butadiene | Modifier (9) | 30 | 57 | 1.17 | 27.1 |

The following describes the chemicals used in the examples and comparative examples.

Copolymers (1) to (58): synthesized as above

### Natural Rubber: TSR20

High-cis polybutadiene (high-cis BR): Ubepol BR150B (cis
content: 97% by mass) produced by Ube Industries, Ltd.
Silica A: ULTRASIL VN3-G (N₂SA: 175 m²/g) produced by Evonik Degussa
Silica B: ZEOSIL 1205 MP (N₂SA: 200 m²/g) produced by Rhodia
Silica C: ULTRASIL 360 (N₂SA: 50 m²/g) produced by Evonik Degussa
Silane coupling agent A: Si69 (bis(3-triethoxysilylpropyl)tetrasulfide) produced by Evonik Degussa
Silane coupling agent B: Si363 produced by Evonik Degussa
Silane coupling agent C: NXT-Z45 (a compound containing linking unit A and linking unit B (linking unit A: 55 mol %,
linking unit B: 45 mol %)) produced by Momentive Performance Materials
Carbon black: Diablack N339 (N₂SA: 96 m²/g, DBP absorption: 124 mL/100 g) produced by Mitsubishi Chemical Corporation
Coumarone-indene resin (solid resin): NOVARES C90 (Tg: 90° C.) produced by Rutgers chemicals
Oil: X-140 produced by JX Nippon Oil & Energy Corporation
Antioxidant: Antigene 3C produced by Sumitomo Chemical Co., Ltd.
Stearic acid: TSUBAKI stearic acid beads produced by NOF Corporation
Zinc oxide: Zinc oxide #1 produced by Mitsui Mining & Smelting Co., Ltd.
Wax: Sunnoc N produced by Ouchi Shinko Chemical Industrial Co., Ltd.
Sulfur: sulfur powder produced by Tsurumi Chemical Industry Co., Ltd.
Vulcanization accelerator 1: Soxinol CZ produced by Sumitomo Chemical Co., Ltd.
Vulcanization accelerator 2: Soxinol D produced by Sumitomo Chemical Co., Ltd.

### Examples and Comparative Examples

According to each of the formulations shown in Tables 6 to 25, the materials other than the sulfur and vulcanization accelerators were kneaded for 5 minutes at 150° C. using a 1.7-L Banbury mixer (produced by Kobe Steel, Ltd.) to give a kneadate. The sulfur and vulcanization accelerators were then added to the kneadate, followed by kneading for 5 minutes at 80° C. using an open roll mill to give an unvulcanized rubber composition. The unvulcanized rubber composition was press-vulcanized for 20 minutes at 170° C. in a 0.5 mm-thick mold to obtain a vulcanized rubber composition.

Separately, the unvulcanized rubber composition was formed into a tread shape and assembled with other tire components on a tire building machine to build an unvulcanized tire. The unvulcanized tire was vulcanized for 12 minutes at 170° C. to prepare a test tire (DS-2 studless winter tire having a size of 195/65R15 for passenger vehicles).

### <Evaluation Items and Test Methods>

In the evaluations below, Comparative Example 1 was taken as a standard comparative example in Tables 6 to 12; Comparative Example 22 was taken as a standard comparative example in Tables 13 to 19; and Comparative Example 45 was taken as a standard comparative example in Tables 20 to 25.

### <Rubber Strength Index>

Each sample was subjected to a tensile test in accordance with JIS K 6251:2010 to measure the elongation at break. The measurement result is expressed as an index relative to that of a standard comparative example (=100). A higher index indicates higher rubber strength (tensile strength at break).

(Rubber strength index)=(Elongation at break of each formulation)/(Elongation at break of standard comparative example)×100

### <Low-Heat-Build-Up Property Index>

The tan δ of each vulcanized rubber composition was measured at a dynamic strain amplitude of 1%, a frequency of 10 Hz, and a temperature of 50° C. using a spectrometer (produced by Ueshima Seisakusho Co., Ltd.). The reciprocal of tan δ is expressed as an index relative to that of a standard comparative example (=100). A higher index indicates a smaller rolling resistance (less heat build-up), which in turn indicates better fuel economy.

### <Handling Performance Index>

The test tires were mounted on a front-engine, front-wheel drive (FF) vehicle (2000 cc, made in Japan), and the vehicle was driven on ice and snow under the conditions mentioned below. Sensory evaluation was performed on starting, accelerating, and stopping. The sensory evaluation was performed using a scoring method as follows. When compared to the performance of a standard comparative example (=100), for example, those with a rating of “clearly improved performance” from a test driver are given a score of 120; those with a rating of “high performance at a level as never before” are given a score of 140.

| | on ice | on snow |
|---|---|---|
| Test location | Test course in | ← |
| | Nayoro, Hokkaido | |
| Temperature | −6 to −1 C.° | −10 to −2 C.° |

### <Braking Performance on Ice Index>

The above-mentioned vehicle was driven on ice. The distance (brake stopping distance on ice) required for the vehicle to stop after the brake that locks up was applied at 30 km/h was measured. The result is expressed as an index relative to that of a standard comparative example (=100), using the equation below. A higher index indicates better braking performance on ice.

(Breaking performance on ice index)=(Brake stopping distance on ice of standard comparative example)/(Brake stopping distance on ice of each formulation)×100

### <Abrasion Resistance Index>

The test tires were mounted on a front-engine, front-wheel drive (FF) vehicle (made in Japan). The groove depth in the tire tread part was measured after the vehicle had run 8000 km. From the measured value, the running distance that decreased the tire groove depth by 1 mm was calculated. The result is expressed as an index relative to that of a standard comparative example (=100), using the equation below. A higher index indicates better abrasion resistance.

(Abrasion resistance index)=(Running distance of each formulation)/(Running distance of standard comparative example)×100

### <Wet-Grip Performance Index>

The test tires were mounted on all the wheels of a vehicle (front-engine, front-wheel drive (FF) vehicle, 2000 cc, made in Japan). The braking distance from an initial speed of 100 km/h was determined on a wet asphalt road. The result is expressed as an index. A higher index indicates better wet-skid performance (wet-grip performance). The index was calculated according to the following equation.

(Wet-grip performance index)=(Braking distance of standard comparative example)/(Braking distance of each formulation)×100

### <Dry Handling Stability>

The test tires were mounted on all the wheels of a front-engine, front-wheel drive (FF) vehicle (2000 cc, made in Japan). The dry handling stability on a test course (on a dry road) was evaluated based on the sensory evaluation by a driver. The evaluation was made on a scale of 1 to 10 (the best), relative to a standard comparative example taken as 4. A higher rating indicates better handling stability.

TABLE 6
Examples in which a compound represented by the formula (IIId) is used as a terminal modifier

| | | | | | | | | | | | | Comparative | |
|---|---|---|---|---|---|---|---|---|---|---|---|---|---|
| | | Example | | | | | | | | | | Example | |
| | | 1 | 2 | 3 | 4 | 5 | 6 | 7 | 8 | 9 | 10 | 1 | 2 |
| Formulation | Copolymer (1) | 20 | — | — | — | — | — | — | — | — | — | — | — |
| (parts by mass) | Copolymer (2) | — | 20 | — | — | — | — | — | — | — | — | — | — |
| | Copolymer (3) | — | — | 20 | — | — | — | — | — | — | — | — | — |
| | Copolymer (4) | — | — | — | 20 | — | — | — | — | — | — | — | — |
| | Copolymer (5) | — | — | — | — | 20 | — | — | — | — | — | — | — |
| | Copolymer (6) | — | — | — | — | — | — | — | 20 | — | — | — | — |
| | Copolymer (7) | — | — | — | — | — | 20 | — | — | — | — | — | — |
| | Copolymer (8) | — | — | — | — | — | — | — | 20 | 20 | 20 | 20 | — |
| | Copolymer (9) | — | — | — | — | — | — | — | — | — | — | — | — |
| | Copolymer (10) | — | — | — | — | — | — | — | — | — | — | — | 20 |
| | Copolymer (11) | — | — | — | — | — | — | — | — | — | — | — | — |
| | Copolymer (12) | — | — | — | — | — | — | — | — | — | — | — | — |
| | Copolymer (13) | — | — | — | — | — | — | 20 | — | — | — | — | — |
| | Copolymer (14) | — | — | — | — | — | — | — | — | — | — | — | — |
| | Copolymer (15) | — | — | — | — | — | — | — | — | — | — | — | — |
| | Copolymer (16) | — | — | — | — | — | — | — | — | — | — | — | — |
| | Copolymer (17) | — | — | — | — | — | — | — | — | — | — | — | — |
| | Copolymer (18) | — | — | — | — | — | — | — | — | 20 | — | — | — |
| | Copolymer (19) | — | — | — | — | — | — | — | — | — | — | — | — |
| | Copolymer (20) | — | — | — | — | — | — | — | — | — | — | — | — |
| | Copolymer (21) | — | — | — | — | — | — | — | — | — | 20 | — | — |
| | Natural rubber | 40 | 40 | 40 | 40 | 40 | 40 | 40 | 40 | 40 | 40 | 40 | 40 |
| | High-cis | 40 | 40 | 40 | 40 | 40 | 40 | 40 | 20 | 20 | 20 | 40 | 40 |
| | polybutadiene | | | | | | | | | | | | |
| | Silica A | 75 | 75 | 75 | 75 | 75 | 75 | 75 | 75 | 75 | 75 | 75 | 75 |
| | Silane coupling | — | — | — | — | — | — | — | — | — | — | — | — |
| | agent A | | | | | | | | | | | | |
| | Silane coupling | — | — | — | — | — | — | — | — | — | — | — | — |
| | agent B | | | | | | | | | | | | |
| | Silane coupling | 3.75 | 3.75 | 3.75 | 3.75 | 3.75 | 3.75 | 3.75 | 3.75 | 3.75 | 3.75 | 3.75 | 3.75 |
| | agent C | | | | | | | | | | | | |
| | Carbon black | 5 | 5 | 5 | 5 | 5 | 5 | 5 | 5 | 5 | 5 | 5 | 5 |
| | Oil | 40 | 40 | 40 | 40 | 40 | 40 | 40 | 40 | 40 | 40 | 40 | 40 |
| | Antioxidant | 1.5 | 1.5 | 1.5 | 1.5 | 1.5 | 1.5 | 1.5 | 1.5 | 1.5 | 1.5 | 1.5 | 1.5 |
| | Stearic acid | 2 | 2 | 2 | 2 | 2 | 2 | 2 | 2 | 2 | 2 | 2 | 2 |
| | Zinc oxide | 2.5 | 2.5 | 2.5 | 2.5 | 2.5 | 2.5 | 2.5 | 2.5 | 2.5 | 2.5 | 2.5 | 2.5 |
| | Wax | 1 | 1 | 1 | 1 | 1 | 1 | 1 | 1 | 1 | 1 | 1 | 1 |
| | Sulfur | 2 | 2 | 2 | 2 | 2 | 2 | 2 | 2 | 2 | 2 | 2 | 2 |
| | Vulcanization | 1.8 | 1.8 | 1.8 | 1.8 | 1.8 | 1.8 | 1.8 | 1.8 | 1.8 | 1.8 | 1.8 | 1.8 |
| | accelerator 1 | | | | | | | | | | | | |
| | Vulcanization | 1.2 | 1.2 | 1.2 | 1.2 | 1.2 | 1.2 | 1.2 | 1.2 | 1.2 | 1.2 | 1.2 | 1.2 |
| | accelerator 2 | | | | | | | | | | | | |
| Evaluation | Rubber strength | 103 | 104 | 105 | 102 | 101 | 101 | 104 | 101 | 100 | 102 | 100 | 103 |
| | index | | | | | | | | | | | | |
| | Low-heat- | 125 | 127 | 126 | 137 | 134 | 136 | 110 | 124 | 130 | 111 | 100 | 93 |
| | build-up | | | | | | | | | | | | |
| | property index | | | | | | | | | | | | |
| | Handling | 124 | 126 | 127 | 137 | 134 | 138 | 110 | 125 | 130 | 112 | 100 | 95 |
| | performance | | | | | | | | | | | | |
| | Braking | 107 | 109 | 110 | 113 | 114 | 116 | 113 | 107 | 104 | 105 | 100 | 99 |
| | performance | | | | | | | | | | | | |
| | on ice | | | | | | | | | | | | |
| | Abrasion | 105 | 107 | 105 | 103 | 105 | 106 | 106 | 104 | 104 | 103 | 100 | 102 |
| | resistance index | | | | | | | | | | | | |
| | Wet-grip | 110 | 111 | 110 | 110 | 110 | 112 | 109 | 108 | 109 | 107 | 100 | 102 |
| | performance | | | | | | | | | | | | |
| | index | | | | | | | | | | | | |
| | Dry handling | 4.25 | 4.25 | 4.25 | 4.25 | 4.25 | 4.25 | 4.25 | 4 | 4 | 4 | 4 | 4 |
| | stability | | | | | | | | | | | | |

| | | Comparative Example | | | | | | | | | | |
|---|---|---|---|---|---|---|---|---|---|---|---|---|
| | | 3 | 4 | 5 | 6 | 7 | 8 | 9 | 10 | 11 | 12 | 13 |
| Formulation | Copolymer (1) | — | — | — | — | — | — | — | — | — | — | — |
| (parts by mass) | Copolymer (2) | — | — | — | — | — | — | — | — | — | — | — |
| | Copolymer (3) | — | — | — | — | — | — | — | — | — | — | — |
| | Copolymer (4) | — | — | — | — | — | — | — | — | — | — | — |
| | Copolymer (5) | — | — | — | — | — | — | — | — | — | — | — |
| | Copolymer (6) | — | — | — | — | — | — | — | — | — | — | — |
| | Copolymer (7) | — | — | — | — | — | — | — | — | — | — | — |
| | Copolymer (8) | — | — | — | — | — | — | 20 | 20 | 20 | 20 | — |
| | Copolymer (9) | — | — | — | — | — | — | 20 | — | — | — | — |
| | Copolymer (10) | — | — | — | — | — | — | — | — | — | — | — |
| | Copolymer (11) | 20 | — | — | — | — | — | — | — | — | — | — |
| | Copolymer (12) | — | 20 | — | — | — | — | — | — | — | — | — |
| | Copolymer (13) | — | — | — | — | — | — | — | — | — | — | — |
| | Copolymer (14) | — | — | 20 | — | — | — | — | — | — | — | — |
| | Copolymer (15) | — | — | — | 20 | — | — | — | — | — | — | — |
| | Copolymer (16) | — | — | — | — | 20 | — | — | — | — | — | — |
| | Copolymer (17) | — | — | — | — | — | 20 | — | — | — | — | — |
| | Copolymer (18) | — | — | — | — | — | — | — | — | — | — | — |
| | Copolymer (19) | — | — | — | — | — | — | — | 20 | — | — | — |
| | Copolymer (20) | — | — | — | — | — | — | — | — | 20 | — | — |
| | Copolymer (21) | — | — | — | — | — | — | — | — | — | — | — |
| | Natural rubber | 40 | 40 | 40 | 40 | 40 | 40 | 40 | 40 | 40 | 40 | 40 |
| | High-cis polybutadiene | 40 | 40 | 40 | 40 | 40 | 40 | 20 | 20 | 20 | 40 | 60 |
| | Silica A | 75 | 75 | 75 | 75 | 75 | 75 | 75 | 75 | 75 | 75 | 75 |
| | Silane coupling agent A | — | — | — | — | — | — | — | — | — | 6 | — |
| | Silane coupling agent B | — | — | — | — | — | — | — | — | — | — | — |
| | Silane coupling agent C | 3.75 | 3.75 | 3.75 | 3.75 | 3.75 | 3.75 | 3.75 | 3.75 | 3.75 | — | 3.75 |
| | Carbon black | 5 | 5 | 5 | 5 | 5 | 5 | 5 | 5 | 5 | 5 | 5 |
| | Oil | 40 | 40 | 40 | 40 | 40 | 40 | 40 | 40 | 40 | 40 | 40 |
| | Antioxidant | 1.5 | 1.5 | 1.5 | 1.5 | 1.5 | 1.5 | 1.5 | 1.5 | 1.5 | 1.5 | 1.5 |
| | Stearic acid | 2 | 2 | 2 | 2 | 2 | 2 | 2 | 2 | 2 | 2 | 2 |
| | Zinc oxide | 2.5 | 2.5 | 2.5 | 2.5 | 2.5 | 2.5 | 2.5 | 2.5 | 2.5 | 2.5 | 2.5 |
| | Wax | 1 | 1 | 1 | 1 | 1 | 1 | 1 | 1 | 1 | 1 | 1 |
| | Sulfur | 2 | 2 | 2 | 2 | 2 | 2 | 2 | 2 | 2 | 2 | 2 |
| | Vulcanization accelerator 1 | 1.8 | 1.8 | 1.8 | 1.8 | 1.8 | 1.8 | 1.8 | 1.8 | 1.8 | 1.8 | 1.8 |
| | Vulcanization accelerator 2 | 1.2 | 1.2 | 1.2 | 1.2 | 1.2 | 1.2 | 1.2 | 1.2 | 1.2 | 1.2 | 1.2 |
| Evaluation | Rubber strength index | 101 | 106 | 101 | 100 | 102 | 100 | 97 | 97 | 99 | 93 | 97 |
| | Low-heat-build-up property | 96 | 91 | 103 | 97 | 95 | 102 | 103 | 104 | 96 | 103 | 114 |
| | index | | | | | | | | | | | |
| | Handling performance | 99 | 94 | 104 | 98 | 98 | 105 | 106 | 107 | 98 | 108 | 110 |
| | Braking performance on ice | 97 | 103 | 104 | 98 | 94 | 99 | 96 | 94 | 90 | 103 | 97 |
| | Abrasion resistance index | 100 | 97 | 95 | 92 | 98 | 90 | 103 | 104 | 98 | 100 | 115 |
| | Wet-grip performance | 102 | 98 | 96 | 96 | 96 | 100 | 107 | 106 | 102 | 97 | 80 |
| | index | | | | | | | | | | | |
| | Dry handling stability | 4 | 4 | 4 | 4 | 4 | 4 | 3.5 | 3.5 | 3.5 | 4.25 | 3 |

TABLE 7
Examples in which a compound represented by the formula (IVd) is used as a terminal modifier

| | | Example | | | | | | | Comparative Example | | | | | | Example | | |
|---|---|---|---|---|---|---|---|---|---|---|---|---|---|---|---|---|---|
| | | 11 | 12 | 13 | 14 | 15 | 16 | 17 | 14 | 1 | 4 | 5 | 6 | 15 | 18 | 19 | 20 |
| Formulation | Copolymer (8) | — | — | — | — | — | — | — | — | 20 | — | — | — | — | 10 | 10 | 10 |
| (parts by mass) | Copolymer (12) | — | — | — | — | — | — | — | — | — | 20 | — | — | — | — | — | — |
| | Copolymer (14) | — | — | — | — | — | — | — | — | — | — | 20 | — | — | — | — | — |
| | Copolymer (15) | — | — | — | — | — | — | — | — | — | — | — | 20 | 10 | — | — | — |
| | Copolymer (19) | — | — | — | — | — | — | — | — | — | — | — | — | 10 | — | — | — |
| | Copolymer (22) | 20 | — | — | — | — | — | — | — | — | — | — | — | — | — | — | — |
| | Copolymer (23) | — | 20 | — | — | — | — | — | — | — | — | — | — | — | — | — | — |
| | Copolymer (24) | — | — | 20 | — | — | — | — | — | — | — | — | — | — | — | — | — |
| | Copolymer (25) | — | — | — | 20 | — | — | — | — | — | — | — | — | — | — | — | — |
| | Copolymer (26) | — | — | — | — | 20 | — | — | — | — | — | — | — | — | — | — | — |
| | Copolymer (27) | — | — | — | — | — | — | — | — | — | — | — | — | — | 10 | — | — |
| | Copolymer (28) | — | — | — | — | — | 20 | — | — | — | — | — | — | — | — | — | — |
| | Copolymer (29) | — | — | — | — | — | — | 20 | — | — | — | — | — | — | — | — | — |
| | Copolymer (30) | — | — | — | — | — | — | — | 20 | — | — | — | — | — | — | — | — |
| | Copolymer (31) | — | — | — | — | — | — | — | — | — | — | — | — | — | — | 10 | — |
| | Copolymer (32) | — | — | — | — | — | — | — | — | — | — | — | — | — | — | — | 10 |
| | Natural rubber | 40 | 40 | 40 | 40 | 40 | 40 | 40 | 40 | 40 | 40 | 40 | 40 | 40 | 40 | 40 | 40 |
| | High-cis polybutadiene | 40 | 40 | 40 | 40 | 40 | 40 | 40 | 40 | 40 | 40 | 40 | 40 | 40 | 40 | 40 | 40 |
| | Silica A | 75 | 75 | 75 | 75 | 75 | 75 | 75 | 75 | 75 | 75 | 75 | 75 | 75 | 75 | 75 | 75 |
| | Silane coupling agent A | — | — | — | — | — | — | — | — | — | — | — | — | — | — | — | — |
| | Silane coupling agent B | — | — | — | — | — | — | — | — | — | — | — | — | — | — | — | — |
| | Silane coupling agent C | 3.75 | 3.75 | 3.75 | 3.75 | 3.75 | 3.75 | 3.75 | 3.75 | 3.75 | 3.75 | 3.75 | 3.75 | 3.75 | 3.75 | 3.75 | 3.75 |
| | Carbon black | 5 | 5 | 5 | 5 | 5 | 5 | 5 | 5 | 5 | 5 | 5 | 5 | 5 | 5 | 5 | 5 |
| | Oil | 40 | 40 | 40 | 40 | 40 | 40 | 40 | 40 | 40 | 40 | 40 | 40 | 40 | 40 | 40 | 40 |
| | Antioxidant | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 |
| | Stearic acid | 2 | 2 | 2 | 2 | 2 | 2 | 2 | 2 | 2 | 2 | 2 | 2 | 2 | 2 | 2 | 2 |
| | Zinc oxide | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 |
| | Wax | 1 | 1 | 1 | 1 | 1 | 1 | 1 | 1 | 1 | 1 | 1 | 1 | 1 | 1 | 1 | 1 |
| | Sulfur | 2 | 2 | 2 | 2 | 2 | 2 | 2 | 2 | 2 | 2 | 2 | 2 | 2 | 2 | 2 | 2 |
| | Vulcanization accelerator 1 | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 |
| | Vulcanization accelerator 2 | 1.2 | 1.2 | 1.2 | 1.2 | 1.2 | 1.2 | 1.2 | 1.2 | 1.2 | 1.2 | 1.2 | 1.2 | 1.2 | 1.2 | 1.2 | 1.2 |
| Evaluation | Rubber strength index | 107 | 106 | 105 | 107 | 108 | 105 | 109 | 95 | 100 | 106 | 101 | 100 | 97 | 105 | 105 | 104 |
| | Low-heat-build-up property index | 130 | 125 | 126 | 126 | 121 | 123 | 113 | 103 | 100 | 91 | 103 | 97 | 107 | 109 | 110 | 108 |
| | Handling performance | 130 | 128 | 127 | 126 | 125 | 125 | 115 | 100 | 100 | 94 | 104 | 98 | 110 | 113 | 112 | 110 |
| | Braking performance on ice | 105 | 100 | 100 | 105 | 105 | 100 | 100 | 98 | 100 | 103 | 104 | 98 | 95 | 103 | 105 | 105 |
| | Abrasion resistance index | 113 | 110 | 115 | 113 | 110 | 112 | 114 | 95 | 100 | 97 | 95 | 92 | 105 | 106 | 113 | 115 |
| | Wet-grip performance index | 107 | 106 | 104 | 108 | 109 | 108 | 106 | 94 | 100 | 98 | 96 | 96 | 95 | 107 | 108 | 105 |
| | Dry handling stability | 4 | 4 | 4 | 4 | 4 | 4 | 4 | 4 | 4 | 4 | 4 | 4 | 3.5 | 4 | 4 | 4 |

TABLE 8
Examples in which a compound represented by the formula (IIId) is used as a terminal modifier

| | | Comparative | | | | | | | |
|---|---|---|---|---|---|---|---|---|---|
| | | Example | | Example | | | | | |
| | | 1 | 4 | 6 | 21 | 22 | 23 | 24 | 25 |
| Formulation | Copolymer (7) | — | — | 20 | 20 | 20 | 20 | 20 | 20 |
| (parts by mass) | Copolymer (8) | 20 | — | — | — | — | — | — | — |
| | Copolymer (12) | — | 20 | — | — | — | — | — | — |
| | Natural rubber | 40 | 40 | 40 | 40 | 40 | 40 | 40 | 55 |
| | High-cis polybutadiene | 40 | 40 | 40 | 40 | 40 | 40 | 40 | 25 |
| | Silica A | 75 | 75 | 75 | 75 | 75 | 75 | 75 | 75 |
| | Silane coupling aeent A | — | — | — | — | — | 3 | — | — |
| | Silane coupling agent B | — | — | — | 6 | — | — | 3 | — |
| | Silane coupling agent C | 3.75 | 3.75 | 3.75 | — | 10 | 2 | 2 | 3.75 |
| | Carbon black | 5 | 5 | 5 | 5 | 5 | 5 | 5 | 5 |
| | Oil | 40 | 40 | 40 | 40 | 40 | 40 | 40 | 40 |
| | Antioxidant | 1.5 | 1.5 | 1.5 | 1.5 | 1.5 | 1.5 | 1.5 | 1.5 |
| | Stearic acid | 2 | 2 | 2 | 2 | 2 | 2 | 2 | 2 |
| | Zinc oxide | 2.5 | 2.5 | 2.5 | 2.5 | 2.5 | 2.5 | 2.5 | 2.5 |
| | Wax | 1 | 1 | 1 | 1 | 1 | 1 | 1 | 1 |
| | Sulfur | 2 | 2 | 2 | 2 | 2 | 2 | 2 | 2 |
| | Vulcanization accelerator 1 | 1.8 | 1.8 | 1.8 | 1.8 | 1.8 | 1.8 | 1.8 | 1.8 |
| | Vulcanization accelerator 2 | 1.2 | 1.2 | 1.2 | 1.2 | 1.2 | 1.2 | 1.2 | 1.2 |
| Evaluation | Rubber strength index | 100 | 106 | 101 | 101 | 107 | 105 | 106 | 115 |
| | Low-heat-build-up property index | 100 | 93 | 136 | 133 | 132 | 131 | 135 | 131 |
| | Handling performance | 100 | 93 | 138 | 136 | 132 | 134 | 137 | 132 |
| | Braking performance on ice | 100 | 102 | 116 | 113 | 110 | 115 | 118 | 101 |
| | Abrasion resistance index | 100 | 97 | 106 | 102 | 104 | 103 | 105 | 103 |
| | Wet-grip performance index | 100 | 98 | 112 | 114 | 121 | 113 | 115 | 104 |
| | Dry handling stability | 4 | 4 | 4.25 | 4.25 | 4 | 4.25 | 4.5 | 4.25 |

TABLE 9
Examples in which a compound represented by the formula (IIId) is used as a terminal modifier

| | | Com. | | | | |
|---|---|---|---|---|---|---|
| | | Ex. | Ex. | | | |
| | | 1 | 6 | 26 | 27 | 28 |
| Formulation | Copolymer (7) | — | 20 | 20 | 20 | 20 |
| (parts by mass) | Copolymer (8) | 20 | — | — | — | — |
| | Copolymer (12) | — | — | — | — | — |
| | Natural rubber | 40 | 40 | 40 | 40 | 40 |
| | High-cis polybutadiene | 40 | 40 | 40 | 40 | 40 |
| | Silica A | 75 | 75 | — | 75 | — |
| | Silica B | — | — | 55 | — | 55 |
| | Silica C | — | — | 20 | — | 20 |
| | Silane coupling aeent A | — | — | — | — | — |
| | Silane coupling agent B | — | — | — | — | — |
| | Silane coupling agent C | 3.75 | 3.75 | 3.75 | 3.75 | 3.75 |
| | Carbon black | 5 | 5 | 5 | 5 | 5 |
| | Oil | 40 | 40 | 40 | 40 | 40 |
| | Coumarone indene resin | — | — | — | 5 | 5 |
| | Antioxidant | 1.5 | 1.5 | 1.5 | 1.5 | 1.5 |
| | Stearic acid | 2 | 2 | 2 | 2 | 2 |
| | Zinc oxide | 2.5 | 2.5 | 2.5 | 2.5 | 2.5 |
| | Wax | 1 | 1 | 1 | 1 | 1 |
| | Sulfur | 2 | 2 | 2 | 2 | 2 |
| | Vulcanization accelerator 1 | 1.8 | 1.8 | 1.8 | 1.8 | 1.8 |
| | Vulcanization accelerator 2 | 1.2 | 1.2 | 1.2 | 1.2 | 1.2 |
| Evaluation | Rubber strength index | 100 | 101 | 100 | 106 | 106 |
| | Low-heat-build-up property index | 100 | 136 | 158 | 135 | 160 |
| | Handling performance | 100 | 138 | 145 | 139 | 147 |
| | Braking performance on ice | 100 | 116 | 129 | 132 | 136 |
| | Abrasion resistance index | 100 | 106 | 105 | 111 | 116 |
| | Wet-grip performance index | 100 | 112 | 123 | 139 | 143 |
| | Dry handling stability | 4 | 4.25 | 4.25 | 4.25 | 4.25 |

TABLE 10
Examples in which a compound represented by the formula (IIIb) is used as a terminal modifier

| | | Example | | | | | | | | | Comparative Example | | | | | |
|---|---|---|---|---|---|---|---|---|---|---|---|---|---|---|---|---|
| | | 29 | 30 | 31 | 32 | 33 | 34 | 35 | 36 | 37 | 16 | 1 | 4 | 5 | 6 | 17 |
| Formulation (parts by | Copolymer (8) | — | — | — | — | — | — | — | — | — | — | 20 | — | — | — | — |
| mass) | Copolymer (12) | — | — | — | — | — | — | — | — | — | — | — | 20 | — | — | — |
| | Copolymer (14) | — | — | — | — | — | — | — | — | — | — | — | — | 20 | — | — |
| | Copolymer (15) | — | — | — | — | — | — | — | — | — | — | — | — | — | 20 | 10 |
| | Copolymer (19) | — | — | — | — | — | — | — | — | — | — | — | — | — | — | 10 |
| | Copolymer (33) | 20 | — | — | — | — | — | — | — | — | — | — | — | — | — | — |
| | Copolymer (34) | — | 20 | — | — | — | — | — | — | — | — | — | — | — | — | — |
| | Copolymer (35) | — | — | 20 | — | — | — | — | — | — | — | — | — | — | — | — |
| | Copolymer (36) | — | — | — | 20 | — | — | — | — | — | — | — | — | — | — | — |
| | Copolymer (37) | — | — | — | — | 20 | — | — | — | — | — | — | — | — | — | — |
| | Copolymer (38) | — | — | — | — | — | 20 | — | — | — | — | — | — | — | — | — |
| | Copolymer (39) | — | — | — | — | — | — | 20 | — | — | — | — | — | — | — | — |
| | Copolymer (40) | — | — | — | — | — | — | — | 20 | — | — | — | — | — | — | — |
| | Copolymer (41) | — | — | — | — | — | — | — | — | 20 | — | — | — | — | — | — |
| | Copolymer (42) | — | — | — | — | — | — | — | — | — | 20 | — | — | — | — | — |
| | Natural rubber | 40 | 40 | 40 | 40 | 40 | 40 | 40 | 40 | 40 | 40 | 40 | 40 | 40 | 40 | 40 |
| | High-cis polybutadiene | 40 | 40 | 40 | 40 | 40 | 40 | 40 | 40 | 40 | 40 | 40 | 40 | 40 | 40 | 40 |
| | Silica A | 75 | 75 | 75 | 75 | 75 | 75 | 75 | 75 | 75 | 75 | 75 | 75 | 75 | 75 | 75 |
| | Silane coupling agent A | — | — | — | — | — | — | — | — | — | — | — | — | — | — | — |
| | Silane coupling agent B | — | — | — | — | — | — | — | — | — | — | — | — | — | — | — |
| | Silane coupling agent C | 3.75 | 3.75 | 3.75 | 3.75 | 3.75 | 3.75 | 3.75 | 3.75 | 3.75 | 3.75 | 3.75 | 3.75 | 3.75 | 3.75 | 3.75 |
| | Carbon black | 5 | 5 | 5 | 5 | 5 | 5 | 5 | 5 | 5 | 5 | 5 | 5 | 5 | 5 | 5 |
| | Oil | 40 | 40 | 40 | 40 | 40 | 40 | 40 | 40 | 40 | 40 | 40 | 40 | 40 | 40 | 40 |
| | Antioxidant | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 |
| | Stearic acid | 2 | 2 | 2 | 2 | 2 | 2 | 2 | 2 | 2 | 2 | 2 | 2 | 2 | 2 | 2 |
| | Zinc oxide | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 |
| | Wax | 1 | 1 | 1 | 1 | 1 | 1 | 1 | 1 | 1 | 1 | 1 | 1 | 1 | 1 | 1 |
| | Sulfur | 2 | 2 | 2 | 2 | 2 | 2 | 2 | 2 | 2 | 2 | 2 | 2 | 2 | 2 | 2 |
| | Vulcanization accelerator 1 | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 |
| | Vulcanization accelerator 2 | 1.2 | 1.2 | 1.2 | 1.2 | 1.2 | 1.2 | 1.2 | 1.2 | 1.2 | 1.2 | 1.2 | 1.2 | 1.2 | 1.2 | 1.2 |
| Evaluation | Rubber strength index | 102 | 103 | 101 | 101 | 101 | 101 | 101 | 101 | 100 | 103 | 100 | 106 | 101 | 100 | 97 |
| | Low-heat-build-up property index | 120 | 124 | 110 | 108 | 109 | 111 | 110 | 111 | 104 | 120 | 100 | 91 | 103 | 97 | 107 |
| | Handling performance | 121 | 125 | 110 | 108 | 110 | 112 | 110 | 112 | 105 | 121 | 100 | 94 | 104 | 98 | 110 |
| | Braking performance on ice | 102 | 101 | 106 | 103 | 104 | 102 | 101 | 102 | 106 | 100 | 100 | 103 | 104 | 98 | 95 |
| | Abrasion resistance index | 107 | 107 | 106 | 116 | 106 | 105 | 115 | 109 | 112 | 97 | 100 | 97 | 95 | 92 | 105 |
| | Wet-grip performance index | 103 | 104 | 111 | 106 | 108 | 105 | 104 | 106 | 108 | 99 | 100 | 98 | 96 | 96 | 95 |
| | Dry handling stability | 4 | 4 | 4 | 4 | 4 | 4 | 4 | 4 | 4 | 4 | 4 | 4 | 4 | 4 | 4 |

TABLE 11
Examples in which a compound containing an alkoxysilyl group, a nitrogen atom and a
carbonyl group is used as a terminal modifier

| | | Example | | | | | | |
|---|---|---|---|---|---|---|---|---|
| | | 38 | 39 | 40 | 41 | 42 | 43 | 44 |
| Formulation | Copolymer (8) | — | — | — | — | — | — | — |
| (parts by mass) | Copolymer (12) | — | — | — | — | — | — | — |
| | Copolymer (14) | — | — | — | — | — | — | — |
| | Copolymer (15) | — | — | — | — | — | — | — |
| | Copolymer (19) | — | — | — | — | — | — | — |
| | Copolymer (43) | 20 | — | — | — | — | — | — |
| | Copolymer (44) | — | 20 | — | — | — | — | — |
| | Copolymer (45) | — | — | 20 | — | — | — | — |
| | Copolymer (46) | — | — | — | 20 | — | — | — |
| | Copolymer (47) | — | — | — | — | 20 | — | — |
| | Copolymer (48) | — | — | — | — | — | 20 | — |
| | Copolymer (49) | — | — | — | — | — | — | 20 |
| | Copolymer (50) | — | — | — | — | — | — | — |
| | Natural rubber | 40 | 40 | 40 | 40 | 40 | 40 | 40 |
| | High-cis polybutadiene | 40 | 40 | 40 | 40 | 40 | 40 | 40 |
| | Silica A | 75 | 75 | 75 | 75 | 75 | 75 | 75 |
| | Silane coupling agent A | — | — | — | — | — | — | — |
| | Silane coupling agent B | — | — | — | — | — | — | — |
| | Silane coupling agent C | 3.75 | 3.75 | 3.75 | 3.75 | 3.75 | 3.75 | 3.75 |
| | Carbon black | 5 | 5 | 5 | 5 | 5 | 5 | 5 |
| | Oil | 40 | 40 | 40 | 40 | 40 | 40 | 40 |
| | Antioxidant | 1.5 | 1.5 | 1.5 | 1.5 | 1.5 | 1.5 | 1.5 |
| | Stearic acid | 2 | 2 | 2 | 2 | 2 | 2 | 2 |
| | Zinc oxide | 2.5 | 2.5 | 2.5 | 2.5 | 2.5 | 2.5 | 2.5 |
| | Wax | 1 | 1 | 1 | 1 | 1 | 1 | 1 |
| | Sulfur | 2 | 2 | 2 | 2 | 2 | 2 | 2 |
| | Vulcanization accelerator 1 | 1.8 | 1.8 | 1.8 | 1.8 | 1.8 | 1.8 | 1.8 |
| | Vulcanization accelerator 2 | 1.2 | 1.2 | 1.2 | 1.2 | 1.2 | 1.2 | 1.2 |
| Evaluation | Rubber strength index | 104 | 103 | 104 | 104 | 105 | 103 | 103 |
| | Low-heat-build-up | 106 | 104 | 107 | 107 | 108 | 105 | 105 |
| | property index | | | | | | | |
| | Handling performance | 107 | 105 | 107 | 108 | 110 | 106 | 105 |
| | Braking performance on ice | 101 | 107 | 106 | 105 | 108 | 107 | 108 |
| | Abrasion resistance index | 110 | 109 | 105 | 106 | 107 | 105 | 106 |
| | Wet-grip performance index | 104 | 110 | 108 | 111 | 112 | 110 | 112 |
| | Dry handling stability | 4 | 4 | 4 | 4 | 4 | 4 | 4 |

| | | Comparative Example | | | | | |
|---|---|---|---|---|---|---|---|
| | | 18 | 1 | 4 | 5 | 6 | 19 |
| Formulation | Copolymer (8) | — | 20 | — | — | — | — |
| (parts by mass) | Copolymer (12) | — | — | 20 | — | — | — |
| | Copolymer (14) | — | — | — | 20 | — | — |
| | Copolymer (15) | — | — | — | — | 20 | 10 |
| | Copolymer (19) | — | — | — | — | — | 10 |
| | Copolymer (43) | — | — | — | — | — | — |
| | Copolymer (44) | — | — | — | — | — | — |
| | Copolymer (45) | — | — | — | — | — | — |
| | Copolymer (46) | — | — | — | — | — | — |
| | Copolymer (47) | — | — | — | — | — | — |
| | Copolymer (48) | — | — | — | — | — | — |
| | Copolymer (49) | — | — | — | — | — | — |
| | Copolymer (50) | 20 | — | — | — | — | — |
| | Natural rubber | 40 | 40 | 40 | 40 | 40 | 40 |
| | High-cis polybutadiene | 40 | 40 | 40 | 40 | 40 | 40 |
| | Silica A | 75 | 75 | 75 | 75 | 75 | 75 |
| | Silane coupling agent A | — | — | — | — | — | — |
| | Silane coupling agent B | — | — | — | — | — | — |
| | Silane coupling agent C | 3.75 | 3.75 | 3.75 | 3.75 | 3.75 | 3.75 |
| | Carbon black | 5 | 5 | 5 | 5 | 5 | 5 |
| | Oil | 40 | 40 | 40 | 40 | 40 | 40 |
| | Antioxidant | 1.5 | 1.5 | 1.5 | 1.5 | 1.5 | 1.5 |
| | Stearic acid | 2 | 2 | 2 | 2 | 2 | 2 |
| | Zinc oxide | 2.5 | 2.5 | 2.5 | 2.5 | 2.5 | 2.5 |
| | Wax | 1 | 1 | 1 | 1 | 1 | 1 |
| | Sulfur | 2 | 2 | 2 | 2 | 2 | 2 |
| | Vulcanization accelerator 1 | 1.8 | 1.8 | 1.8 | 1.8 | 1.8 | 1.8 |
| | Vulcanization accelerator 2 | 1.2 | 1.2 | 1.2 | 1.2 | 1.2 | 1.2 |
| Evaluation | Rubber strength index | 100 | 100 | 106 | 101 | 100 | 97 |
| | Low-heat-build-up | 106 | 100 | 91 | 103 | 97 | 107 |
| | property index | | | | | | |
| | Handling performance | 106 | 100 | 94 | 104 | 98 | 110 |
| | Braking performance on ice | 100 | 100 | 103 | 104 | 98 | 95 |
| | Abrasion resistance index | 100 | 100 | 97 | 95 | 92 | 105 |
| | Wet-grip performance index | 101 | 100 | 98 | 96 | 96 | 95 |
| | Dry handling stability | 4 | 4 | 4 | 4 | 4 | 3.5 |

TABLE 12
Examples in which an N,N-dialkyl-substituted carboxylic acid amide dialkyl
acetal compound is used as a terminal modifier

| | | Example | | | | | | |
|---|---|---|---|---|---|---|---|---|
| | | 45 | 46 | 47 | 48 | 49 | 50 | 51 |
| Formulation | Copolymer (8) | — | — | — | — | — | — | — |
| (parts by mass) | Copolymer (12) | — | — | — | — | — | — | — |
| | Copolymer (14) | — | — | — | — | — | — | — |
| | Copolymer (15) | — | — | — | — | — | — | — |
| | Copolymer (19) | — | — | — | — | — | — | — |
| | Copolymer (51) | 20 | — | — | — | — | — | — |
| | Copolymer (52) | — | 20 | — | — | — | — | — |
| | Copolymer (53) | — | — | 20 | — | — | — | — |
| | Copolymer (54) | — | — | — | 20 | — | — | — |
| | Copolymer (55) | — | — | — | — | 20 | — | — |
| | Copolymer (56) | — | — | — | — | — | 20 | — |
| | Copolymer (57) | — | — | — | — | — | — | 20 |
| | Copolymer (58) | — | — | — | — | — | — | — |
| | Natural rubber | 40 | 40 | 40 | 40 | 40 | 40 | 40 |
| | High-cis polybutadiene | 40 | 40 | 40 | 40 | 40 | 40 | 40 |
| | Silica A | 75 | 75 | 75 | 75 | 75 | 75 | 75 |
| | Silane coupling agent A | — | — | — | — | — | — | — |
| | Silane coupling agent B | — | — | — | — | — | — | — |
| | Silane coupling agent C | 3.75 | 3.75 | 3.75 | 3.75 | 3.75 | 3.75 | 3.75 |
| | Carbon black | 5 | 5 | 5 | 5 | 5 | 5 | 5 |
| | Oil | 40 | 40 | 40 | 40 | 40 | 40 | 40 |
| | Antioxidant | 1.5 | 1.5 | 1.5 | 1.5 | 1.5 | 1.5 | 1.5 |
| | Stearic acid | 2 | 2 | 2 | 2 | 2 | 2 | 2 |
| | Zinc oxide | 2.5 | 2.5 | 2.5 | 2.5 | 2.5 | 2.5 | 2.5 |
| | Wax | 1 | 1 | 1 | 1 | 1 | 1 | 1 |
| | Sulfur | 2 | 2 | 2 | 2 | 2 | 2 | 2 |
| | Vulcanization accelerator 1 | 1.8 | 1.8 | 1.8 | 1.8 | 1.8 | 1.8 | 1.8 |
| | Vulcanization accelerator 2 | 1.2 | 1.2 | 1.2 | 1.2 | 1.2 | 1.2 | 1.2 |
| Evaluation | Rubber strength index | 104 | 104 | 104 | 104 | 105 | 101 | 103 |
| | Low-heat-build-up | 106 | 106 | 105 | 106 | 109 | 103 | 104 |
| | property index | | | | | | | |
| | Handling performance | 108 | 107 | 106 | 106 | 111 | 105 | 104 |
| | Braking performance on ice | 101 | 105 | 108 | 106 | 110 | 106 | 108 |
| | Abrasion resistance index | 111 | 110 | 106 | 105 | 106 | 105 | 105 |
| | Wet-grip performance index | 103 | 108 | 112 | 109 | 114 | 109 | 111 |
| | Dry handling stability | 4 | 4 | 4 | 4 | 4 | 4 | 4 |

| | | Comparative Example | | | | | |
|---|---|---|---|---|---|---|---|
| | | 20 | 1 | 4 | 5 | 6 | 21 |
| Formulation | Copolymer (8) | — | 20 | — | — | — | — |
| (parts by mass) | Copolymer (12) | — | — | 20 | — | — | — |
| | Copolymer (14) | — | — | — | 20 | — | — |
| | Copolymer (15) | — | — | — | — | 20 | 10 |
| | Copolymer (19) | — | — | — | — | — | 10 |
| | Copolymer (51) | — | — | — | — | — | — |
| | Copolymer (52) | — | — | — | — | — | — |
| | Copolymer (53) | — | — | — | — | — | — |
| | Copolymer (54) | — | — | — | — | — | — |
| | Copolymer (55) | — | — | — | — | — | — |
| | Copolymer (56) | — | — | — | — | — | — |
| | Copolymer (57) | — | — | — | — | — | — |
| | Copolymer (58) | 20 | — | — | — | — | — |
| | Natural rubber | 40 | 40 | 40 | 40 | 40 | 40 |
| | High-cis polybutadiene | 40 | 40 | 40 | 40 | 40 | 40 |
| | Silica A | 75 | 75 | 75 | 75 | 75 | 75 |
| | Silane coupling agent A | — | — | — | — | — | — |
| | Silane coupling agent B | — | — | — | — | — | — |
| | Silane coupling agent C | 3.75 | 3.75 | 3.75 | 3.75 | 3.75 | 3.75 |
| | Carbon black | 5 | 5 | 5 | 5 | 5 | 5 |
| | Oil | 40 | 40 | 40 | 40 | 40 | 40 |
| | Antioxidant | 1.5 | 1.5 | 1.5 | 1.5 | 1.5 | 1.5 |
| | Stearic acid | 2 | 2 | 2 | 2 | 2 | 2 |
| | Zinc oxide | 2.5 | 2.5 | 2.5 | 2.5 | 2.5 | 2.5 |
| | Wax | 1 | 1 | 1 | 1 | 1 | 1 |
| | Sulfur | 2 | 2 | 2 | 2 | 2 | 2 |
| | Vulcanization accelerator 1 | 1.8 | 1.8 | 1.8 | 1.8 | 1.8 | 1.8 |
| | Vulcanization accelerator 2 | 1.2 | 1.2 | 1.2 | 1.2 | 1.2 | 1.2 |
| Evaluation | Rubber strength index | 100 | 100 | 106 | 101 | 100 | 97 |
| | Low-heat-build-up property index | 105 | 100 | 91 | 103 | 97 | 107 |
| | Handling performance | 105 | 100 | 94 | 104 | 98 | 110 |
| | Braking performance on ice | 99 | 100 | 103 | 104 | 98 | 95 |
| | Abrasion resistance index | 101 | 100 | 97 | 95 | 92 | 105 |
| | Wet-grip performance index | 100 | 100 | 98 | 96 | 96 | 95 |
| | Dry handling stability | 4 | 4 | 4 | 4 | 4 | 3.5 |

TABLE 13
Examples in which a compound represented by the formula (IIId)
is used as a terminal modifier

| | | | | | | | | | | | | Comparative | |
|---|---|---|---|---|---|---|---|---|---|---|---|---|---|
| | | Example | | | | | | | | | | Example | |
| | | 52 | 53 | 54 | 55 | 56 | 57 | 58 | 59 | 60 | 61 | 22 | 23 |
| Formulation | Copolymer (1) | 20 | — | — | — | — | — | — | — | — | — | — | — |
| (parts by mass) | Copolymer (2) | — | 20 | — | — | — | — | — | — | — | — | — | — |
| | Copolymer (3) | — | — | 20 | — | — | — | — | — | — | — | — | — |
| | Copolymer (4) | — | — | — | 20 | — | — | — | — | — | — | — | — |
| | Copolymer (5) | — | — | — | — | 20 | — | — | — | — | — | — | — |
| | Copolymer (6) | — | — | — | — | — | — | — | 20 | — | — | — | — |
| | Copolymer (7) | — | — | — | — | — | 20 | — | — | — | — | — | — |
| | Copolymer (8) | — | — | — | — | — | — | — | 20 | 20 | 20 | 20 | — |
| | Copolymer (9) | — | — | — | — | — | — | — | — | — | — | — | — |
| | Copolymer (10) | — | — | — | — | — | — | — | — | — | — | — | 20 |
| | Copolymer (11) | — | — | — | — | — | — | — | — | — | — | — | — |
| | Copolymer (12) | — | — | — | — | — | — | — | — | — | — | — | — |
| | Copolymer (13) | — | — | — | — | — | — | 20 | — | — | — | — | — |
| | Copolymer (14) | — | — | — | — | — | — | — | — | — | — | — | — |
| | Copolymer (15) | — | — | — | — | — | — | — | — | — | — | — | — |
| | Copolymer (16) | — | — | — | — | — | — | — | — | — | — | — | — |
| | Copolymer (17) | — | — | — | — | — | — | — | — | — | — | — | — |
| | Copolymer (18) | — | — | — | — | — | — | — | — | 20 | — | — | — |
| | Copolymer (19) | — | — | — | — | — | — | — | — | — | — | — | — |
| | Copolymer (20) | — | — | — | — | — | — | — | — | — | — | — | — |
| | Copolymer (21) | — | — | — | — | — | — | — | — | — | 20 | — | — |
| | Natural rubber | 40 | 40 | 40 | 40 | 40 | 40 | 40 | 40 | 40 | 40 | 40 | 40 |
| | High-cis | 40 | 40 | 40 | 40 | 40 | 40 | 40 | 20 | 20 | 20 | 40 | 40 |
| | polybutadiene | | | | | | | | | | | | |
| | Silica A | — | — | — | — | — | — | — | — | — | — | — | — |
| | Silica B | 55 | 55 | 55 | 55 | 55 | 55 | 55 | 55 | 55 | 55 | 55 | 55 |
| | Silica C | 20 | 20 | 20 | 20 | 20 | 20 | 20 | 20 | 20 | 20 | 20 | 20 |
| | Silane coupling | 6 | 6 | 6 | 6 | 6 | 6 | 6 | 6 | 6 | 6 | 6 | 6 |
| | agent A | | | | | | | | | | | | |
| | Carbon black | 5 | 5 | 5 | 5 | 5 | 5 | 5 | 5 | 5 | 5 | 5 | 5 |
| | Oil | 40 | 40 | 40 | 40 | 40 | 40 | 40 | 40 | 40 | 40 | 40 | 40 |
| | Antioxidant | 1.5 | 1.5 | 1.5 | 1.5 | 1.5 | 1.5 | 1.5 | 1.5 | 1.5 | 1.5 | 1.5 | 1.5 |
| | Stearic acid | 2 | 2 | 2 | 2 | 2 | 2 | 2 | 2 | 2 | 2 | 2 | 2 |
| | Zinc oxide | 2.5 | 2.5 | 2.5 | 2.5 | 2.5 | 2.5 | 2.5 | 2.5 | 2.5 | 2.5 | 2.5 | 2.5 |
| | Wax | 1 | 1 | 1 | 1 | 1 | 1 | 1 | 1 | 1 | 1 | 1 | 1 |
| | Sulfur | 2 | 2 | 2 | 2 | 2 | 2 | 2 | 2 | 2 | 2 | 2 | 2 |
| | Vulcanization | 1.8 | 1.8 | 1.8 | 1.8 | 1.8 | 1.8 | 1.8 | 1.8 | 1.8 | 1.8 | 1.8 | 1.8 |
| | accelerator 1 | | | | | | | | | | | | |
| | Vulcanization | 1.2 | 1.2 | 1.2 | 1.2 | 1.2 | 1.2 | 1.2 | 1.2 | 1.2 | 1.2 | 1.2 | 1.2 |
| | accelerator 2 | | | | | | | | | | | | |
| Evaluation | Rubber strength | 103 | 104 | 105 | 102 | 101 | 103 | 107 | 105 | 101 | 103 | 100 | 105 |
| | index | | | | | | | | | | | | |
| | Low-heat-build- | 129 | 131 | 130 | 141 | 138 | 139 | 114 | 127 | 133 | 114 | 100 | 97 |
| | up property index | | | | | | | | | | | | |
| | Handling | 124 | 126 | 127 | 137 | 134 | 137 | 108 | 122 | 125 | 110 | 100 | 91 |
| | performance | | | | | | | | | | | | |
| | Braking | 107 | 109 | 110 | 113 | 114 | 116 | 113 | 107 | 104 | 105 | 100 | 99 |
| | performance | | | | | | | | | | | | |
| | on ice | | | | | | | | | | | | |
| | Abrasion | 105 | 107 | 105 | 103 | 105 | 106 | 106 | 103 | 102 | 100 | 100 | 100 |
| | resistance index | | | | | | | | | | | | |
| | Wet-grip | 110 | 111 | 110 | 110 | 110 | 113 | 111 | 110 | 110 | 109 | 100 | 103 |
| | performance | | | | | | | | | | | | |
| | index | | | | | | | | | | | | |
| | Dry handling | 4.25 | 4.25 | 4.25 | 4.25 | 4.25 | 4.25 | 4.25 | 4 | 4 | 4 | 4 | 4 |
| | stability | | | | | | | | | | | | |

| | | Comparative Example | | | | | | | | | | |
|---|---|---|---|---|---|---|---|---|---|---|---|---|
| | | 24 | 25 | 26 | 27 | 28 | 29 | 30 | 31 | 32 | 33 | 34 |
| Formulation | Copolymer (1) | — | — | — | — | — | — | — | — | — | — | — |
| (parts by | Copolymer (2) | — | — | — | — | — | — | — | — | — | — | — |
| mass) | Copolymer (3) | — | — | — | — | — | — | — | — | — | — | — |
| | Copolymer (4) | — | — | — | — | — | — | — | — | — | — | — |
| | Copolymer (5) | — | — | — | — | — | — | — | — | — | — | — |
| | Copolymer (6) | — | — | — | — | — | — | — | — | — | — | — |
| | Copolymer (7) | — | — | — | — | — | — | — | — | — | — | — |
| | Copolymer (8) | — | — | — | — | — | — | 20 | 20 | 20 | 20 | — |
| | Copolymer (9) | — | — | — | — | — | — | 20 | — | — | — | — |
| | Copolymer (10) | — | — | — | — | — | — | — | — | — | — | — |
| | Copolymer (11) | 20 | — | — | — | — | — | — | — | — | — | — |
| | Copolymer (12) | — | 20 | — | — | — | — | — | — | — | — | — |
| | Copolymer (13) | — | — | — | — | — | — | — | — | — | — | — |
| | Copolymer (14) | — | — | 20 | — | — | — | — | — | — | — | — |
| | Copolymer (15) | — | — | — | 20 | — | — | — | — | — | — | — |
| | Copolymer (16) | — | — | — | — | 20 | — | — | — | — | — | — |
| | Copolymer (17) | — | — | — | — | — | 20 | — | — | — | — | — |
| | Copolymer (18) | — | — | — | — | — | — | — | — | — | — | — |
| | Copolymer (19) | — | — | — | — | — | — | — | 20 | — | — | — |
| | Copolymer (20) | — | — | — | — | — | — | — | — | 20 | — | — |
| | Copolymer (21) | — | — | — | — | — | — | — | — | — | — | — |
| | Natural rubber | 40 | 40 | 40 | 40 | 40 | 40 | 40 | 40 | 40 | 40 | 40 |
| | High-cis polybutadiene | 40 | 40 | 40 | 40 | 40 | 40 | 20 | 20 | 20 | 40 | 60 |
| | Silica A | — | — | — | — | — | — | — | — | — | 75 | — |
| | Silica B | 55 | 55 | 55 | 55 | 55 | 55 | 55 | 55 | 55 | — | 55 |
| | Silica C | 20 | 20 | 20 | 20 | 20 | 20 | 20 | 20 | 20 | — | 20 |
| | Silane coupling agent A | 6 | 6 | 6 | 6 | 6 | 6 | 6 | 6 | 6 | 6 | 6 |
| | Carbon black | 5 | 5 | 5 | 5 | 5 | 5 | 5 | 5 | 5 | 5 | 5 |
| | Oil | 40 | 40 | 40 | 40 | 40 | 40 | 40 | 40 | 40 | 40 | 40 |
| | Antioxidant | 1.5 | 1.5 | 1.5 | 1.5 | 1.5 | 1.5 | 1.5 | 1.5 | 1.5 | 1.5 | 1.5 |
| | Stearic acid | 2 | 2 | 2 | 2 | 2 | 2 | 2 | 2 | 2 | 2 | 2 |
| | Zinc oxide | 2.5 | 2.5 | 2.5 | 2.5 | 2.5 | 2.5 | 2.5 | 2.5 | 2.5 | 2.5 | 2.5 |
| | Wax | 1 | 1 | 1 | 1 | 1 | 1 | 1 | 1 | 1 | 1 | 1 |
| | Sulfur | 2 | 2 | 2 | 2 | 2 | 2 | 2 | 2 | 2 | 2 | 2 |
| | Vulcanization accelerator 1 | 18 | 1.8 | 1.8 | 1.8 | 1.8 | 1.8 | 1.8 | 1.8 | 1.8 | 1.8 | 1.8 |
| | Vulcanization accelerator 2 | 1.2 | 1.2 | 1.2 | 1.2 | 1.2 | 1.2 | 1.2 | 1.2 | 1.2 | 1.2 | 1.2 |
| Evaluation | Rubber strength index | 103 | 106 | 103 | 101 | 105 | 102 | 98 | 99 | 100 | 95 | 99 |
| | Low-heat-build-up | 98 | 94 | 105 | 99 | 98 | 102 | 106 | 107 | 99 | 107 | 117 |
| | property index | | | | | | | | | | | |
| | Handling performance | 95 | 90 | 100 | 94 | 94 | 101 | 102 | 104 | 95 | 105 | 105 |
| | Braking performance on ice | 97 | 103 | 104 | 98 | 94 | 99 | 96 | 94 | 90 | 103 | 97 |
| | Abrasion resistance index | 98 | 95 | 93 | 90 | 95 | 88 | 103 | 104 | 95 | 98 | 110 |
| | Wet-grip performance index | 102 | 99 | 97 | 97 | 97 | 100 | 108 | 107 | 103 | 97 | 82 |
| | Dry handling stability | 4 | 4 | 4 | 4 | 4 | 4 | 3.5 | 3.5 | 3.5 | 4.25 | 3 |

TABLE 14
Examples in which a compound represented by the formula (IV) is used as a terminal modifier

| | | Example | | | | | | | Comparative Example | | | | | | Example | | |
|---|---|---|---|---|---|---|---|---|---|---|---|---|---|---|---|---|---|
| | | 62 | 63 | 64 | 65 | 66 | 67 | 68 | 35 | 22 | 25 | 26 | 27 | 36 | 69 | 70 | 71 |
| Formulation | Copolymer (8) | — | — | — | — | — | — | — | — | 20 | — | — | — | — | 10 | 10 | 10 |
| (parts | Copolymer (12) | — | — | — | — | — | — | — | — | — | 20 | — | — | — | — | — | — |
| by mass) | Copolymer (14) | — | — | — | — | — | — | — | — | — | — | 20 | — | — | — | — | — |
| | Copolymer (15) | — | — | — | — | — | — | — | — | — | — | — | 20 | 10 | — | — | — |
| | Copolymer (19) | — | — | — | — | — | — | — | — | — | — | — | — | 10 | — | — | — |
| | Copolymer (22) | 20 | — | — | — | — | — | — | — | — | — | — | — | — | — | — | — |
| | Copolymer (23) | — | 20 | — | — | — | — | — | — | — | — | — | — | — | — | — | — |
| | Copolymer (24) | — | — | 20 | — | — | — | — | — | — | — | — | — | — | — | — | — |
| | Copolymer (25) | — | — | — | 20 | — | — | — | — | — | — | — | — | — | — | — | — |
| | Copolymer (26) | — | — | — | — | 20 | — | — | — | — | — | — | — | — | — | — | — |
| | Copolymer (27) | — | — | — | — | — | — | — | — | — | — | — | — | — | 10 | — | — |
| | Copolymer (28) | — | — | — | — | — | 20 | — | — | — | — | — | — | — | — | — | — |
| | Copolymer (29) | — | — | — | — | — | — | 20 | — | — | — | — | — | — | — | — | — |
| | Copolymer (30) | — | — | — | — | — | — | — | 20 | — | — | — | — | — | — | — | — |
| | Copolymer (31) | — | — | — | — | — | — | — | — | — | — | — | — | — | — | 10 | — |
| | Copolymer (32) | — | — | — | — | — | — | — | — | — | — | — | — | — | — | — | 10 |
| | Natural rubber | 40 | 40 | 40 | 40 | 40 | 40 | 40 | 40 | 40 | 40 | 40 | 40 | 40 | 40 | 40 | 40 |
| | High-cis | 40 | 40 | 40 | 40 | 40 | 40 | 40 | 40 | 40 | 40 | 40 | 40 | 40 | 40 | 40 | 40 |
| | polybutadiene | | | | | | | | | | | | | | | | |
| | Silica A | — | — | — | — | — | — | — | — | — | — | — | — | — | — | — | — |
| | Silica B | 55 | 55 | 55 | 55 | 55 | 55 | 55 | 55 | 55 | 55 | 55 | 55 | 55 | 55 | 55 | 55 |
| | Silica C | 20 | 20 | 20 | 20 | 20 | 20 | 20 | 20 | 20 | 20 | 20 | 20 | 20 | 20 | 20 | 20 |
| | Silane coupling | 6 | 6 | 6 | 6 | 6 | 6 | 6 | 6 | 6 | 6 | 6 | 6 | 6 | 6 | 6 | 6 |
| | agent A | | | | | | | | | | | | | | | | |
| | Carbon black | 5 | 5 | 5 | 5 | 5 | 5 | 5 | 5 | 5 | 5 | 5 | 5 | 5 | 5 | 5 | 5 |
| | Oil | 40 | 40 | 40 | 40 | 40 | 40 | 40 | 40 | 40 | 40 | 40 | 40 | 40 | 40 | 40 | 40 |
| | Antioxidant | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 |
| | Stearic acid | 2 | 2 | 2 | 2 | 2 | 2 | 2 | 2 | 2 | 2 | 2 | 2 | 2 | 2 | 2 | 2 |
| | Zinc oxide | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 |
| | Wax | 1 | 1 | 1 | 1 | 1 | 1 | 1 | 1 | 1 | 1 | 1 | 1 | 1 | 1 | 1 | 1 |
| | Sulfur | 2 | 2 | 2 | 2 | 2 | 2 | 2 | 2 | 2 | 2 | 2 | 2 | 2 | 2 | 2 | 2 |
| | Vulcanization | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 |
| | accelerator 1 | | | | | | | | | | | | | | | | |
| | Vulcanization | 1.2 | 1.2 | 1.2 | 1.2 | 1.2 | 1.2 | 1.2 | 1.2 | 1.2 | 1.2 | 1.2 | 1.2 | 1.2 | 1.2 | 1.2 | 1.2 |
| | accelerator 2 | | | | | | | | | | | | | | | | |
| Evaluation | Rubber strength | 107 | 106 | 105 | 107 | 108 | 107 | 111 | 95 | 100 | 106 | 103 | 101 | 101 | 103 | 106 | 106 |
| | index | | | | | | | | | | | | | | | | |
| | Low-heat-build-up | 130 | 125 | 126 | 126 | 121 | 126 | 116 | 99 | 100 | 94 | 105 | 99 | 109 | 110 | 111 | 109 |
| | property index | | | | | | | | | | | | | | | | |
| | Handling | 130 | 128 | 127 | 126 | 125 | 125 | 115 | 101 | 100 | 90 | 100 | 94 | 110 | 106 | 112 | 110 |
| | performance | | | | | | | | | | | | | | | | |
| | Braking | 105 | 100 | 100 | 105 | 105 | 100 | 100 | 98 | 100 | 103 | 104 | 98 | 96 | 105 | 107 | 107 |
| | performance on ice | | | | | | | | | | | | | | | | |
| | Abrasion resistance | 113 | 110 | 115 | 113 | 110 | 110 | 111 | 95 | 100 | 95 | 93 | 90 | 102 | 108 | 110 | 111 |
| | index | | | | | | | | | | | | | | | | |
| | Wet-grip | 107 | 106 | 104 | 108 | 109 | 107 | 105 | 97 | 100 | 99 | 97 | 97 | 94 | 108 | 107 | 106 |
| | performance index | | | | | | | | | | | | | | | | |
| | Dry handling | 4 | 4 | 4 | 4 | 4 | 4 | 4 | 4 | 4 | 4 | 4 | 4 | 3.5 | 4 | 4 | 4 |
| | stability | | | | | | | | | | | | | | | | |

TABLE 15
Examples in which a compound represented by the formula (IIId) is used as a terminal modifier

| | | Com. Ex. | | Ex. | | | | | | Com. Ex. | | Ex. |
|---|---|---|---|---|---|---|---|---|---|---|---|---|
| | | 22 | 25 | 57 | 72 | 73 | 74 | 75 | 76 | 37 | 38 | 77 |
| Formulation (parts by | Copolymer (7) | — | — | 20 | 20 | 20 | 20 | 20 | 20 | 20 | 20 | 20 |
| mass) | Copolymer (8) | 20 | — | — | — | — | — | — | — | — | — | — |
| | Copolymer (12) | — | 20 | — | — | — | — | — | — | — | — | — |
| | Natural rubber | 40 | 40 | 40 | 40 | 40 | 40 | 40 | 40 | 40 | 40 | 55 |
| | High-cis polybutadiene | 40 | 40 | 40 | 40 | 40 | 40 | 40 | 40 | 40 | 40 | 25 |
| | Silica A | — | — | — | — | — | — | 10 | 10 | — | — | — |
| | Silica B | 55 | 55 | 55 | 70 | 60 | 40 | 45 | 55 | 130 | 3 | 55 |
| | Silica C | 20 | 20 | 20 | 5 | 15 | 35 | 20 | 10 | 30 | 1 | 20 |
| | Silane coupling agent A | 6 | 6 | 6 | 6 | 6 | 6 | 6 | 6 | 6 | 6 | 6 |
| | Carbon black | 5 | 5 | 5 | 5 | 5 | 5 | 5 | 5 | 5 | 5 | 5 |
| | Oil | 40 | 40 | 40 | 40 | 40 | 40 | 40 | 40 | 40 | 40 | 40 |
| | Antioxidant | 1.5 | 1.5 | 1.5 | 1.5 | 1.5 | 1.5 | 1.5 | 1.5 | 1.5 | 1.5 | 1.5 |
| | Stearic acid | 2 | 2 | 2 | 2 | 2 | 2 | 2 | 2 | 2 | 2 | 2 |
| | Zinc oxide | 2.5 | 2.5 | 2.5 | 2.5 | 2.5 | 2.5 | 2.5 | 2.5 | 2.5 | 2.5 | 2.5 |
| | Wax | 1 | 1 | 1 | 1 | 1 | 1 | 1 | 1 | 1 | 1 | 1 |
| | Sulfur | 2 | 2 | 2 | 2 | 2 | 2 | 2 | 2 | 2 | 2 | 2 |
| | Vulcanization accelerator 1 | 1.8 | 1.8 | 1.8 | 1.8 | 1.8 | 1.8 | 1.8 | 1.8 | 1.8 | 1.8 | 1.8 |
| | Vulcanization accelerator 2 | 1.2 | 1.2 | 1.2 | 1.2 | 1.2 | 1.2 | 1.2 | 1.2 | 1.2 | 1.2 | 1.2 |
| Evaluation | Rubber strength index | 100 | 106 | 103 | 110 | 105 | 107 | 104 | 108 | 58 | 86 | 115 |
| | Low-heat-build-up property index | 100 | 94 | 139 | 118 | 133 | 142 | 140 | 135 | 95 | 148 | 138 |
| | Handling performance | 100 | 90 | 137 | 130 | 133 | 135 | 139 | 138 | 98 | 86 | 135 |
| | Braking performance on ice | 100 | 103 | 116 | 105 | 113 | 121 | 115 | 116 | 90 | 84 | 103 |
| | Abrasion resistance index | 100 | 95 | 106 | 109 | 105 | 105 | 108 | 106 | 85 | 66 | 100 |
| | Wet-grip performance index | 100 | 99 | 113 | 102 | 116 | 121 | 118 | 116 | 127 | 118 | 104 |
| | Dry handling stability | 4 | 4 | 4.25 | 4.25 | 4.25 | 4 | 4.25 | 4.5 | 3 | 3 | 4.25 |

TABLE 16
Examples in which a compound represented by the
formula (IIId) is used as a terminal modifier

| | | Com. | | |
|---|---|---|---|---|
| | | Ex. | Ex. | |
| | | 22 | 57 | 78 |
| Formulation | Copolymer (7) | — | 20 | 20 |
| (parts by | Copolymer (8) | 20 | — | — |
| mass) | Copolymer (12) | — | — | — |
| | Natural rubber | 40 | 40 | 40 |
| | High-cis polybutadiene | 40 | 40 | 40 |
| | Silica A | 20 | 20 | 20 |
| | Silica B | 55 | 55 | 55 |
| | Silica C | — | — | — |
| | Silane coupling agent A | 6 | 6 | 6 |
| | Carbon black | 5 | 5 | 5 |
| | Oil | 40 | 40 | 40 |
| | Coumarone indene resin | — | — | 5 |
| | Antioxidant | 1.5 | 1.5 | 1.5 |
| | Stearic acid | 2 | 2 | 2 |
| | Zinc oxide | 2.5 | 2.5 | 2.5 |
| | Wax | 1 | 1 | 1 |
| | Sulfur | 2 | 2 | 2 |
| | Vulcanization accelerator 1 | 1.8 | 1.8 | 1.8 |
| | Vulcanization accelerator 2 | 1.2 | 1.2 | 1.2 |
| Evaluation | Rubber strength index | 100 | 103 | 107 |
| | Low-heat-build-up property | 100 | 139 | 139 |
| | index | | | |
| | Handling performance | 100 | 137 | 138 |
| | Braking performance on ice | 100 | 116 | 135 |
| | Abrasion resistance index | 100 | 106 | 112 |
| | Wet-grip performance index | 100 | 113 | 140 |
| | Dry handling stability | 4 | 4.25 | 4.25 |

TABLE 17
Examples in which a compound represented by the formula (IIIb) is used as a terminal modifier

| | | Example | | | | | | | | | Comparative Example | | | | | |
|---|---|---|---|---|---|---|---|---|---|---|---|---|---|---|---|---|
| | | 79 | 80 | 81 | 82 | 83 | 84 | 85 | 86 | 87 | 39 | 22 | 25 | 26 | 27 | 40 |
| Formulation | Copolymer (8) | — | — | — | — | — | — | — | — | — | — | 20 | — | — | — | — |
| (parts by mass) | Copolymer (12) | — | — | — | — | — | — | — | — | — | — | — | 20 | — | — | — |
| | Copolymer (14) | — | — | — | — | — | — | — | — | — | — | — | — | 20 | — | — |
| | Copolymer (15) | — | — | — | — | — | — | — | — | — | — | — | — | — | 20 | 10 |
| | Copolymer (19) | — | — | — | — | — | — | — | — | — | — | — | — | — | — | 10 |
| | Copolymer (33) | 20 | — | — | — | — | — | — | — | — | — | — | — | — | — | — |
| | Copolymer (34) | — | 20 | — | — | — | — | — | — | — | — | — | — | — | — | — |
| | Copolymer (35) | — | — | 20 | — | — | — | — | — | — | — | — | — | — | — | — |
| | Copolymer (36) | — | — | — | 20 | — | — | — | — | — | — | — | — | — | — | — |
| | Copolymer (37) | — | — | — | — | 20 | — | — | — | — | — | — | — | — | — | — |
| | Copolymer (38) | — | — | — | — | — | 20 | — | — | — | — | — | — | — | — | — |
| | Copolymer (39) | — | — | — | — | — | — | 20 | — | — | — | — | — | — | — | — |
| | Copolymer (40) | — | — | — | — | — | — | — | 20 | — | — | — | — | — | — | — |
| | Copolymer (41) | — | — | — | — | — | — | — | — | 20 | — | — | — | — | — | — |
| | Copolymer (42) | — | — | — | — | — | — | — | — | — | 20 | — | — | — | — | — |
| | Natural rubber | 40 | 40 | 40 | 40 | 40 | 40 | 40 | 40 | 40 | 40 | 40 | 40 | 40 | 40 | 40 |
| | High-cis polybutadiene | 40 | 40 | 40 | 40 | 40 | 40 | 40 | 40 | 40 | 40 | 40 | 40 | 40 | 40 | 40 |
| | Silica A | — | — | — | — | — | — | — | — | — | — | — | — | — | — | — |
| | Silica B | 55 | 55 | 55 | 55 | 55 | 55 | 55 | 55 | 55 | 55 | 55 | 55 | 55 | 55 | 55 |
| | Silica C | 20 | 20 | 20 | 20 | 20 | 20 | 20 | 20 | 20 | 20 | 20 | 20 | 20 | 20 | 20 |
| | Silane coupling agent A | 6 | 6 | 6 | 6 | 6 | 6 | 6 | 6 | 6 | 6 | 6 | 6 | 6 | 6 | 6 |
| | Carbon black | 5 | 5 | 5 | 5 | 5 | 5 | 5 | 5 | 5 | 5 | 5 | 5 | 5 | 5 | 5 |
| | Oil | 40 | 40 | 40 | 40 | 40 | 40 | 40 | 40 | 40 | 40 | 40 | 40 | 40 | 40 | 40 |
| | Antioxidant | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 |
| | Stearic acid | 2 | 2 | 2 | 2 | 2 | 2 | 2 | 2 | 2 | 2 | 2 | 2 | 2 | 2 | 2 |
| | Zinc oxide | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 |
| | Wax | 1 | 1 | 1 | 1 | 1 | 1 | 1 | 1 | 1 | 1 | 1 | 1 | 1 | 1 | 1 |
| | Sulfur | 2 | 2 | 2 | 2 | 2 | 2 | 2 | 2 | 2 | 2 | 2 | 2 | 2 | 2 | 2 |
| | Vulcanization | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 |
| | accelerator 1 | | | | | | | | | | | | | | | |
| | Vulcanization | 1.2 | 1.2 | 1.2 | 1.2 | 1.2 | 1.2 | 1.2 | 1.2 | 1.2 | 1.2 | 1.2 | 1.2 | 1.2 | 1.2 | 1.2 |
| | accelerator 2 | | | | | | | | | | | | | | | |
| Evaluation | Rubber strength index | 104 | 105 | 103 | 103 | 103 | 103 | 103 | 103 | 102 | 105 | 100 | 106 | 103 | 101 | 99 |
| | Low-heat-build-up | 118 | 122 | 108 | 106 | 107 | 109 | 108 | 109 | 102 | 118 | 100 | 94 | 105 | 99 | 105 |
| | property index | | | | | | | | | | | | | | | |
| | Handling performance | 120 | 124 | 109 | 107 | 109 | 110 | 108 | 111 | 103 | 120 | 100 | 90 | 100 | 94 | 105 |
| | Braking performance on | 101 | 103 | 109 | 104 | 106 | 105 | 102 | 105 | 106 | 99 | 100 | 103 | 104 | 98 | 95 |
| | ice | | | | | | | | | | | | | | | |
| | Abrasion resistance index | 109 | 109 | 108 | 118 | 108 | 107 | 117 | 111 | 114 | 99 | 100 | 95 | 93 | 90 | 107 |
| | Wet-grip performance | 104 | 105 | 112 | 107 | 109 | 106 | 105 | 107 | 109 | 100 | 100 | 99 | 97 | 97 | 96 |
| | index | | | | | | | | | | | | | | | |
| | Dry handling stability | 4 | 4 | 4 | 4 | 4 | 4 | 4 | 4 | 4 | 4 | 4 | 4 | 4 | 4 | 3.5 |

TABLE 18
Examples in which a compound containing an alkoxysilyl group, a nitrogen atom and a carbonyl group is used as a terminal modifier

| | | Example | | | | | | | Comparative Example | | | | | |
|---|---|---|---|---|---|---|---|---|---|---|---|---|---|---|
| | | 88 | 89 | 90 | 91 | 92 | 93 | 94 | 41 | 22 | 25 | 26 | 27 | 42 |
| Formulation (parts | Copolymer (8) | — | — | — | — | — | — | — | — | 20 | — | — | — | — |
| by mass) | Copolymer (12) | — | — | — | — | — | — | — | — | — | 20 | — | — | — |
| | Copolymer (14) | — | — | — | — | — | — | — | — | — | — | 20 | — | — |
| | Copolymer (15) | — | — | — | — | — | — | — | — | — | — | — | 20 | 10 |
| | Copolymer (19) | — | — | — | — | — | — | — | — | — | — | — | — | 10 |
| | Copolymer (43) | 20 | — | — | — | — | — | — | — | — | — | — | — | — |
| | Copolymer (44) | — | 20 | — | — | — | — | — | — | — | — | — | — | — |
| | Copolymer (45) | — | — | 20 | — | — | — | — | — | — | — | — | — | — |
| | Copolymer (46) | — | — | — | 20 | — | — | — | — | — | — | — | — | — |
| | Copolymer (47) | — | — | — | — | 20 | — | — | — | — | — | — | — | — |
| | Copolymer (48) | — | — | — | — | — | 20 | — | — | — | — | — | — | — |
| | Copolymer (49) | — | — | — | — | — | — | 20 | — | — | — | — | — | — |
| | Copolymer (50) | — | — | — | — | — | — | — | 20 | — | — | — | — | — |
| | Natural rubber | 40 | 40 | 40 | 40 | 40 | 40 | 40 | 40 | 40 | 40 | 40 | 40 | 40 |
| | High-cis polybutadiene | 40 | 40 | 40 | 40 | 40 | 40 | 40 | 40 | 40 | 40 | 40 | 40 | 40 |
| | Silica A | — | — | — | — | — | — | — | — | — | — | — | — | — |
| | Silica B | 55 | 55 | 55 | 55 | 55 | 55 | 55 | 55 | 55 | 55 | 55 | 55 | 55 |
| | Silica C | 20 | 20 | 20 | 20 | 20 | 20 | 20 | 20 | 20 | 20 | 20 | 20 | 20 |
| | Silane coupling agent A | 6 | 6 | 6 | 6 | 6 | 6 | 6 | 6 | 6 | 6 | 6 | 6 | 6 |
| | Carbon black | 5 | 5 | 5 | 5 | 5 | 5 | 5 | 5 | 5 | 5 | 5 | 5 | 5 |
| | Oil | 40 | 40 | 40 | 40 | 40 | 40 | 40 | 40 | 40 | 40 | 40 | 40 | 40 |
| | Antioxidant | 1.5 | 1.5 | 1.5 | 1.5 | 1.5 | 1.5 | 1.5 | 1.5 | 1.5 | 1.5 | 1.5 | 1.5 | 1.5 |
| | Stearic acid | 2 | 2 | 2 | 2 | 2 | 2 | 2 | 2 | 2 | 2 | 2 | 2 | 2 |
| | Zinc oxide | 2.5 | 2.5 | 2.5 | 2.5 | 2.5 | 2.5 | 2.5 | 2.5 | 2.5 | 2.5 | 2.5 | 2.5 | 2.5 |
| | Wax | 1 | 1 | 1 | 1 | 1 | 1 | 1 | 1 | 1 | 1 | 1 | 1 | 1 |
| | Sulfur | 2 | 2 | 2 | 2 | 2 | 2 | 2 | 2 | 2 | 2 | 2 | 2 | 2 |
| | Vulcanization accelerator 1 | 1.8 | 1.8 | 1.8 | 1.8 | 1.8 | 1.8 | 1.8 | 1.8 | 1.8 | 1.8 | 1.8 | 1.8 | 1.8 |
| | Vulcanization accelerator 2 | 1.2 | 1.2 | 1.2 | 1.2 | 1.2 | 1.2 | 1.2 | 1.2 | 1.2 | 1.2 | 1.2 | 1.2 | 1.2 |
| Evaluation | Rubber strength index | 106 | 105 | 106 | 106 | 107 | 105 | 105 | 102 | 100 | 106 | 103 | 101 | 99 |
| | Low-heat-build-up property index | 105 | 103 | 106 | 106 | 107 | 104 | 104 | 105 | 100 | 94 | 105 | 99 | 106 |
| | Handling performance | 106 | 104 | 108 | 106 | 107 | 105 | 105 | 105 | 100 | 90 | 100 | 94 | 107 |
| | Braking performance on ice | 103 | 109 | 106 | 108 | 108 | 107 | 109 | 100 | 100 | 103 | 104 | 98 | 95 |
| | Abrasion resistance index | 112 | 111 | 107 | 108 | 109 | 107 | 108 | 102 | 100 | 95 | 93 | 90 | 107 |
| | Wet-grip performance index | 105 | 111 | 109 | 112 | 113 | 111 | 113 | 102 | 100 | 99 | 97 | 97 | 96 |
| | Dry handling stability | 4 | 4 | 4 | 4 | 4 | 4 | 4 | 4 | 4 | 4 | 4 | 4 | 3.5 |

TABLE 19
Examples in which an N,N-dialkyl-substituted carboxylic acid amide dialkyl acetal compound is used as a terminal modifier

| | | Example | | | | | | | Comparative Example | | | | | |
|---|---|---|---|---|---|---|---|---|---|---|---|---|---|---|
| | | 95 | 96 | 97 | 98 | 99 | 100 | 101 | 43 | 22 | 25 | 26 | 27 | 44 |
| Formulation (parts | Copolymer (8) | — | — | — | — | — | — | — | — | 20 | — | — | — | — |
| by mass) | Copolymer (12) | — | — | — | — | — | — | — | — | — | 20 | — | — | — |
| | Copolymer (14) | — | — | — | — | — | — | — | — | — | — | 20 | — | — |
| | Copolymer (15) | — | — | — | — | — | — | — | — | — | — | — | 20 | 10 |
| | Copolymer (19) | — | — | — | — | — | — | — | — | — | — | — | — | 10 |
| | Copolymer (51) | 20 | — | — | — | — | — | — | — | — | — | — | — | — |
| | Copolymer (52) | — | 20 | — | — | — | — | — | — | — | — | — | — | — |
| | Copolymer (53) | — | — | 20 | — | — | — | — | — | — | — | — | — | — |
| | Copolymer (54) | — | — | — | 20 | — | — | — | — | — | — | — | — | — |
| | Copolymer (55) | — | — | — | — | 20 | — | — | — | — | — | — | — | — |
| | Copolymer (56) | — | — | — | — | — | 20 | — | — | — | — | — | — | — |
| | Copolymer (57) | — | — | — | — | — | — | 20 | — | — | — | — | — | — |
| | Copolymer (58) | — | — | — | — | — | — | — | 20 | — | — | — | — | — |
| | Natural rubber | 40 | 40 | 40 | 40 | 40 | 40 | 40 | 40 | 40 | 40 | 40 | 40 | 40 |
| | High-cis polybutadiene | 40 | 40 | 40 | 40 | 40 | 40 | 40 | 40 | 40 | 40 | 40 | 40 | 40 |
| | Silica A | — | — | — | — | — | — | — | — | — | — | — | — | — |
| | Silica B | 55 | 55 | 55 | 55 | 55 | 55 | 55 | 55 | 55 | 55 | 55 | 55 | 55 |
| | Silica C | 20 | 20 | 20 | 20 | 20 | 20 | 20 | 20 | 20 | 20 | 20 | 20 | 20 |
| | Silane coupling agent A | 6 | 6 | 6 | 6 | 6 | 6 | 6 | 6 | 6 | 6 | 6 | 6 | 6 |
| | Carbon black | 5 | 5 | 5 | 5 | 5 | 5 | 5 | 5 | 5 | 5 | 5 | 5 | 5 |
| | Oil | 40 | 40 | 40 | 40 | 40 | 40 | 40 | 40 | 40 | 40 | 40 | 40 | 40 |
| | Antioxidant | 1.5 | 1.5 | 1.5 | 1.5 | 1.5 | 1.5 | 1.5 | 1.5 | 1.5 | 1.5 | 1.5 | 1.5 | 1.5 |
| | Stearic acid | 2 | 2 | 2 | 2 | 2 | 2 | 2 | 2 | 2 | 2 | 2 | 2 | 2 |
| | Zinc oxide | 2.5 | 2.5 | 2.5 | 2.5 | 2.5 | 2.5 | 2.5 | 2.5 | 2.5 | 2.5 | 2.5 | 2.5 | 2.5 |
| | Wax | 1 | 1 | 1 | 1 | 1 | 1 | 1 | 1 | 1 | 1 | 1 | 1 | 1 |
| | Sulfur | 2 | 2 | 2 | 2 | 2 | 2 | 2 | 2 | 2 | 2 | 2 | 2 | 2 |
| | Vulcanization accelerator 1 | 1.8 | 1.8 | 1.8 | 1.8 | 1.8 | 1.8 | 1.8 | 1.8 | 1.8 | 1.8 | 1.8 | 1.8 | 1.8 |
| | Vulcanization accelerator 2 | 1.2 | 1.2 | 1.2 | 1.2 | 1.2 | 1.2 | 1.2 | 1.2 | 1.2 | 1.2 | 1.2 | 1.2 | 1.2 |
| Evaluation | Rubber strength index | 106 | 106 | 106 | 106 | 107 | 103 | 105 | 102 | 100 | 106 | 103 | 101 | 99 |
| | Low-heat-build-up property index | 105 | 105 | 104 | 105 | 108 | 102 | 103 | 104 | 100 | 94 | 105 | 99 | 106 |
| | Handling performance | 106 | 107 | 106 | 105 | 111 | 103 | 103 | 105 | 100 | 90 | 100 | 94 | 108 |
| | Braking performance on ice | 102 | 106 | 107 | 107 | 110 | 105 | 107 | 99 | 100 | 103 | 104 | 98 | 95 |
| | Abrasion resistance index | 113 | 112 | 108 | 107 | 108 | 107 | 107 | 103 | 100 | 95 | 93 | 90 | 107 |
| | Wet-grip performance index | 104 | 109 | 113 | 110 | 115 | 110 | 112 | 101 | 100 | 99 | 97 | 97 | 96 |
| | Dry handling stability | 4 | 4 | 4 | 4 | 4 | 4 | 4 | 4 | 4 | 4 | 4 | 4 | 3.5 |

TABLE 20
Examples in which a compound represented by the formula (IIId) is used as a terminal modifier

| | | Example | | | | | | | | | | Comparative Example | | | | | | | | | | | | |
|---|---|---|---|---|---|---|---|---|---|---|---|---|---|---|---|---|---|---|---|---|---|---|---|---|
| | | 102 | 103 | 104 | 105 | 106 | 107 | 108 | 109 | 110 | 111 | 45 | 46 | 47 | 48 | 49 | 50 | 51 | 52 | 53 | 54 | 55 | 56 | 57 |
| Formu- | Copolymer (1) | 20 | — | — | — | — | — | — | — | — | — | — | — | — | — | — | — | — | — | — | — | — | — | — |
| lation | Copolymer (2) | — | 20 | — | — | — | — | — | — | — | — | — | — | — | — | — | — | — | — | — | — | — | — | — |
| (parts | Copolymer (3) | — | — | 20 | — | — | — | — | — | — | — | — | — | — | — | — | — | — | — | — | — | — | — | — |
| by | Copolymer (4) | — | — | — | 20 | — | — | — | — | — | — | — | — | — | — | — | — | — | — | — | — | — | — | — |
| mass) | Copolymer (5) | — | — | — | — | 20 | — | — | — | — | — | — | — | — | — | — | — | — | — | — | — | — | — | — |
| | Copolymer (6) | — | — | — | — | — | — | — | 20 | — | — | — | — | — | — | — | — | — | — | — | — | — | — | — |
| | Copolymer (7) | — | — | — | — | — | 20 | — | — | — | — | — | — | — | — | — | — | — | — | — | — | — | — | — |
| | Copolymer (8) | — | — | — | — | — | — | — | 20 | 20 | 20 | 20 | — | — | — | — | — | — | — | 20 | 20 | 20 | 20 | — |
| | Copolymer (9) | — | — | — | — | — | — | — | — | — | — | — | — | — | — | — | — | — | — | 20 | — | — | — | — |
| | Copolymer (10) | — | — | — | — | — | — | — | — | — | — | — | 20 | — | — | — | — | — | — | — | — | — | — | — |
| | Copolymer (11) | — | — | — | — | — | — | — | — | — | — | — | — | 20 | — | — | — | — | — | — | — | — | — | — |
| | Copolymer (12) | — | — | — | — | — | — | — | — | — | — | — | — | — | 20 | — | — | — | — | — | — | — | — | — |
| | Copolymer (13) | — | — | — | — | — | — | 20 | — | — | — | — | — | — | — | — | — | — | — | — | — | — | — | — |
| | Copolymer (14) | — | — | — | — | — | — | — | — | — | — | — | — | — | — | 20 | — | — | — | — | — | — | — | — |
| | Copolymer (15) | — | — | — | — | — | — | — | — | — | — | — | — | — | — | — | 20 | — | — | — | — | — | — | — |
| | Copolymer (16) | — | — | — | — | — | — | — | — | — | — | — | — | — | — | — | — | 20 | — | — | — | — | — | — |
| | Copolymer (17) | — | — | — | — | — | — | — | — | — | — | — | — | — | — | — | — | — | 20 | — | — | — | — | — |
| | Copolymer (18) | — | — | — | — | — | — | — | — | 20 | — | — | — | — | — | — | — | — | — | — | — | — | — | — |
| | Copolymer (19) | — | — | — | — | — | — | — | — | — | — | — | — | — | — | — | — | — | — | — | 20 | — | — | — |
| | Copolymer (20) | — | — | — | — | — | — | — | — | — | — | — | — | — | — | — | — | — | — | — | — | 20 | — | — |
| | Copolymer (21) | — | — | — | — | — | — | — | — | — | — | — | — | — | — | — | — | — | — | — | — | — | — | — |
| | Natural rubber | 40 | 40 | 40 | 40 | 40 | 40 | 40 | 40 | 40 | 40 | 40 | 40 | 40 | 40 | 40 | 40 | 40 | 40 | 40 | 40 | 40 | 40 | 40 |
| | High-cis polybutadiene | 40 | 40 | 40 | 40 | 40 | 40 | 40 | 20 | 20 | 20 | 40 | 40 | 40 | 40 | 40 | 40 | 40 | 40 | 20 | 20 | 20 | 40 | 60 |
| | Silica A | 75 | 75 | 75 | 75 | 75 | 75 | 75 | 75 | 75 | 75 | 75 | 75 | 75 | 75 | 75 | 75 | 75 | 75 | 75 | 75 | 75 | 75 | 75 |
| | Silane coupling | 6 | 6 | 6 | 6 | 6 | 6 | 6 | 6 | 6 | 6 | 6 | 6 | 6 | 6 | 6 | 6 | 6 | 6 | 6 | 6 | 6 | 6 | 6 |
| | agent A | | | | | | | | | | | | | | | | | | | | | | | |
| | Carbon black | 5 | 5 | 5 | 5 | 5 | 5 | 5 | 5 | 5 | 5 | 5 | 5 | 5 | 5 | 5 | 5 | 5 | 5 | 5 | 5 | 5 | 5 | 5 |
| | Oil | 40 | 40 | 40 | 40 | 40 | 40 | 40 | 40 | 40 | 40 | 40 | 40 | 40 | 40 | 40 | 40 | 40 | 40 | 40 | 40 | 40 | 40 | 40 |
| | Coumarone indene | 5 | 5 | 5 | 5 | 5 | 5 | 5 | 5 | 5 | 5 | 5 | 5 | 5 | 5 | 5 | 5 | 5 | 5 | 5 | 5 | 5 | — | — |
| | resin 1 (Tg: 90° C.) | | | | | | | | | | | | | | | | | | | | | | | |
| | Coumarone indene | — | — | — | — | — | — | — | — | — | — | — | — | — | — | — | — | — | — | — | — | — | — | — |
| | resin 2 (Tg: 10° C.) | | | | | | | | | | | | | | | | | | | | | | | |
| | Coumarone indene | — | — | — | — | — | — | — | — | — | — | — | — | — | — | — | — | — | — | — | — | — | — | — |
| | resin 3 (Tg: −30° C.) | | | | | | | | | | | | | | | | | | | | | | | |
| | α-Methyl styrene | — | — | — | — | — | — | — | — | — | — | — | — | — | — | — | — | — | — | — | — | — | — | — |
| | resin (Tg: 95° C.) | | | | | | | | | | | | | | | | | | | | | | | |
| | Antioxidant | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 |
| | Stearic acid | 2 | 2 | 2 | 2 | 2 | 2 | 2 | 2 | 2 | 2 | 2 | 2 | 2 | 2 | 2 | 2 | 2 | 2 | 2 | 2 | 2 | 2 | 2 |
| | Zinc oxide | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 |
| | Wax | 1 | 1 | 1 | 1 | 1 | 1 | 1 | 1 | 1 | 1 | 1 | 1 | 1 | 1 | 1 | 1 | 1 | 1 | 1 | 1 | 1 | 1 | 1 |
| | Sulfur | 2 | 2 | 2 | 2 | 2 | 2 | 2 | 2 | 2 | 2 | 2 | 2 | 2 | 2 | 2 | 2 | 2 | 2 | 2 | 2 | 2 | 2 | 2 |
| | Vulcanization | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 |
| | accelerator 1 | | | | | | | | | | | | | | | | | | | | | | | |
| | Vulcanization | 1.2 | 1.2 | 1.2 | 17 | 1.2 | 1.2 | 1.2 | 1.2 | 1.2 | 1.2 | 1.2 | 1.2 | 1.2 | 1.2 | 1.2 | 1.2 | 1.2 | 1.2 | 1.2 | 1.2 | 1.2 | 1.2 | 1.2 |
| | accelerator 2 | | | | | | | | | | | | | | | | | | | | | | | |
| Eval- | Rubber strength index | 103 | 104 | 105 | 102 | 101 | 101 | 104 | 101 | 100 | 102 | 100 | 103 | 101 | 106 | 101 | 100 | 102 | 100 | 97 | 97 | 99 | 93 | 97 |
| uation | Low-heat-build-up | 120 | 122 | 121 | 133 | 130 | 132 | 104 | 120 | 125 | 106 | 100 | 91 | 94 | 88 | 100 | 94 | 93 | 101 | 102 | 103 | 93 | 103 | 110 |
| | property index | | | | | | | | | | | | | | | | | | | | | | | |
| | Handling performance | 125 | 127 | 126 | 138 | 135 | 137 | 109 | 125 | 130 | 111 | 100 | 96 | 99 | 93 | 105 | 99 | 98 | 106 | 107 | 108 | 98 | 108 | 110 |
| | Braking performance | 108 | 109 | 110 | 115 | 114 | 116 | 112 | 107 | 105 | 106 | 100 | 99 | 98 | 102 | 104 | 98 | 95 | 100 | 95 | 95 | 90 | 103 | 95 |
| | on ice | | | | | | | | | | | | | | | | | | | | | | | |
| | Abrasion resistance | 103 | 104 | 103 | 101 | 102 | 104 | 103 | 102 | 104 | 100 | 100 | 101 | 99 | 97 | 93 | 92 | 96 | 88 | 101 | 102 | 95 | 98 | 115 |
| | index | | | | | | | | | | | | | | | | | | | | | | | |
| | Wet-grip | 111 | 111 | 110 | 109 | 109 | 112 | 107 | 106 | 107 | 105 | 100 | 101 | 101 | 96 | 96 | 97 | 96 | 100 | 105 | 104 | 102 | 97 | 82 |
| | performance index | | | | | | | | | | | | | | | | | | | | | | | |
| | Dry handling stability | 4.25 | 4.25 | 4.25 | 4.25 | 4.25 | 4.25 | 4.25 | 4 | 4 | 4 | 4 | 4 | 4 | 4 | 4 | 4 | 4 | 4 | 3.5 | 3.5 | 3.5 | 4.25 | 3 |

TABLE 21
Examples in which a compound represented by the formula (IV) is used as a terminal modifier

| | | Example | | | | | | | Comparative Example | | | | | | Example | | |
|---|---|---|---|---|---|---|---|---|---|---|---|---|---|---|---|---|---|
| | | 112 | 113 | 114 | 115 | 116 | 117 | 118 | 58 | 45 | 48 | 49 | 50 | 59 | 119 | 120 | 121 |
| Formu- | Copolymer (8) | — | — | — | — | — | — | — | — | 20 | — | — | — | — | 10 | 10 | 10 |
| lation | Copolymer (12) | — | — | — | — | — | — | — | — | — | 20 | — | — | — | — | — | — |
| (parts | Copolymer (14) | — | — | — | — | — | — | — | — | — | — | 20 | — | — | — | — | — |
| by | Copolymer (15) | — | — | — | — | — | — | — | — | — | — | — | 20 | 10 | — | — | — |
| mass) | Copolymer (19) | — | — | — | — | — | — | — | — | — | — | — | — | 10 | — | — | — |
| | Copolymer (22) | 20 | — | — | — | — | — | — | — | — | — | — | — | — | — | — | — |
| | Copolymer (23) | — | 20 | — | — | — | — | — | — | — | — | — | — | — | — | — | — |
| | Copolymer (24) | — | — | 20 | — | — | — | — | — | — | — | — | — | — | — | — | — |
| | Copolymer (25) | — | — | — | 20 | — | — | — | — | — | — | — | — | — | — | — | — |
| | Copolymer (26) | — | — | — | — | 20 | — | — | — | — | — | — | — | — | — | — | — |
| | Copolymer (27) | — | — | — | — | — | — | — | — | — | — | — | — | — | 10 | — | — |
| | Copolymer (28) | — | — | — | — | — | 20 | — | — | — | — | — | — | — | — | — | — |
| | Copolymer (29) | — | — | — | — | — | — | 20 | — | — | — | — | — | — | — | — | — |
| | Copolymer (30) | — | — | — | — | — | — | — | 20 | — | — | — | — | — | — | — | — |
| | Copolymer (31) | — | — | — | — | — | — | — | — | — | — | — | — | — | — | 10 | — |
| | Copolymer (32) | — | — | — | — | — | — | — | — | — | — | — | — | — | — | — | 10 |
| | Natural rubber | 40 | 40 | 40 | 40 | 40 | 40 | 40 | 40 | 40 | 40 | 40 | 40 | 40 | 40 | 40 | 40 |
| | High-cis polybutadiene | 40 | 40 | 40 | 40 | 40 | 40 | 40 | 40 | 40 | 40 | 40 | 40 | 40 | 40 | 40 | 40 |
| | Silica A | 75 | 75 | 75 | 75 | 75 | 75 | 75 | 75 | 75 | 75 | 75 | 75 | 75 | 75 | 75 | 75 |
| | Silane coupling agent A | 6 | 6 | 6 | 6 | 6 | 6 | 6 | 6 | 6 | 6 | 6 | 6 | 6 | 6 | 6 | 6 |
| | Carbon black | 5 | 5 | 5 | 5 | 5 | 5 | 5 | 5 | 5 | 5 | 5 | 5 | 5 | 5 | 5 | 5 |
| | Oil | 40 | 40 | 40 | 40 | 40 | 40 | 40 | 40 | 40 | 40 | 40 | 40 | 40 | 40 | 40 | 40 |
| | Coumarone indene | 5 | 5 | 5 | 5 | 5 | 5 | 5 | 5 | 5 | 5 | 5 | 5 | 5 | 5 | 5 | 5 |
| | resin 1 (Tg: 90° C.) | | | | | | | | | | | | | | | | |
| | Coumarone indene | — | — | — | — | — | — | — | — | — | — | — | — | — | — | — | — |
| | resin 2 (Tg: 10° C.) | | | | | | | | | | | | | | | | |
| | Coumarone indene | — | — | — | — | — | — | — | — | — | — | — | — | — | — | — | — |
| | resin 3 (Tg: −30° C.) | | | | | | | | | | | | | | | | |
| | α-Methyl styrene | — | — | — | — | — | — | — | — | — | — | — | — | — | — | — | — |
| | resin (Tg: 95° C.) | | | | | | | | | | | | | | | | |
| | Antioxidant | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 |
| | Stearic acid | 2 | 2 | 2 | 2 | 2 | 2 | 2 | 2 | 2 | 2 | 2 | 2 | 2 | 2 | 2 | 2 |
| | Zinc oxide | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 |
| | Wax | 1 | 1 | 1 | 1 | 1 | 1 | 1 | 1 | 1 | 1 | 1 | 1 | 1 | 1 | 1 | 1 |
| | Sulfur | 2 | 2 | 2 | 2 | 2 | 2 | 2 | 2 | 2 | 2 | 2 | 2 | 2 | 2 | 2 | 2 |
| | Vulcanization | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 |
| | accelerator 1 | | | | | | | | | | | | | | | | |
| | Vulcanization | 1.2 | 1.2 | 1.2 | 1.2 | 1.2 | 1.2 | 1.2 | 1.2 | 1.2 | 1.2 | 1.2 | 1.2 | 1.2 | 1.2 | 1.2 | 1.2 |
| | accelerator 2 | | | | | | | | | | | | | | | | |
| Eval- | Rubber strength index | 107 | 106 | 105 | 107 | 108 | 105 | 109 | 95 | 100 | 106 | 101 | 100 | 97 | 104 | 105 | 104 |
| uation | Low-heat-build-up | 124 | 121 | 122 | 121 | 117 | 118 | 108 | 101 | 100 | 88 | 100 | 94 | 103 | 108 | 105 | 103 |
| | property index | | | | | | | | | | | | | | | | |
| | Handling performance | 129 | 126 | 127 | 126 | 122 | 123 | 113 | 102 | 100 | 93 | 105 | 99 | 108 | 110 | 110 | 108 |
| | Braking | 105 | 100 | 100 | 105 | 105 | 100 | 100 | 98 | 100 | 102 | 104 | 98 | 95 | 103 | 105 | 105 |
| | performance on ice | | | | | | | | | | | | | | | | |
| | Abrasion resistance index | 111 | 108 | 112 | 111 | 109 | 110 | 112 | 100 | 100 | 97 | 93 | 92 | 102 | 104 | 110 | 112 |
| | Wet-grip | 107 | 106 | 105 | 108 | 109 | 107 | 106 | 105 | 100 | 96 | 96 | 97 | 95 | 105 | 107 | 105 |
| | performance index | | | | | | | | | | | | | | | | |
| | Dry handling stability | 4 | 4 | 4 | 4 | 4 | 4 | 4 | 4 | 4 | 4 | 4 | 4 | 3.5 | 4 | 4 | 4 |

TABLE 22
Examples in which a compound represented by the formula (IIId) is used as a terminal modifier

| | | Com. | | | | | | | Com. | |
|---|---|---|---|---|---|---|---|---|---|---|
| | | Ex. | | Ex. | | | | | Ex. | Ex. |
| | | 45 | 48 | 107 | 122 | 123 | 124 | 125 | 60 | 126 |
| Formu- | Copolymer (7) | — | — | 20 | 20 | 20 | 20 | 20 | 50 | 20 |
| lation | Copolymer (8) | 20 | — | — | — | — | — | — | — | — |
| (parts by | Copolymer (12) | — | 20 | — | — | — | — | — | — | — |
| mass) | Natural rubber | 40 | 40 | 40 | 40 | 40 | 40 | 40 | 40 | 55 |
| | High-cis polybutadiene rubber | 40 | 40 | 40 | 40 | 40 | 40 | 40 | 10 | 25 |
| | Silica A | 75 | 75 | 75 | 75 | 75 | 75 | 75 | 75 | 75 |
| | Silane coupling agent A | 6 | 6 | 6 | 6 | 6 | 6 | 6 | 6 | 6 |
| | Carbon black | 5 | 5 | 5 | 5 | 5 | 5 | 5 | 5 | 5 |
| | Oil | 40 | 40 | 40 | 40 | 40 | 40 | 40 | 40 | 40 |
| | Coumarone indene resin 1 | 5 | 5 | 5 | — | 15 | 5 | 5 | 5 | 5 |
| | (Tg: 90° C.) | | | | | | | | | |
| | Coumarone indene resin 2 | — | — | — | — | — | 5 | — | — | — |
| | (Tg: 10° C.) | | | | | | | | | |
| | Coumarone indene resin 3 | — | — | — | — | — | — | 5 | — | — |
| | (Tg: −30° C.) | | | | | | | | | |
| | α-Methyl styrene resin | — | — | — | 5 | — | — | — | — | — |
| | (Tg: 95° C.) | | | | | | | | | |
| | Antioxidant | 1.5 | 1.5 | 1.5 | 1.5 | 1.5 | 1.5 | 1.5 | 1.5 | 1.5 |
| | Stearic acid | 2 | 2 | 2 | 2 | 2 | 2 | 2 | 2 | 2 |
| | Zinc oxide | 2.5 | 2.5 | 2.5 | 2.5 | 2.5 | 2.5 | 2.5 | 2.5 | 2.5 |
| | Wax | 1 | 1 | 1 | 1 | 1 | 1 | 1 | 1 | 1 |
| | Sulfur | 2 | 2 | 2 | 2 | 2 | 2 | 2 | 2 | 2 |
| | Vulcanization accelerator 1 | 1.8 | 1.8 | 1.8 | 1.8 | 1.8 | 1.8 | 1.8 | 1.8 | 1.8 |
| | Vulcanization accelerator 2 | 1.2 | 1.2 | 1.2 | 1.2 | 1.2 | 1.2 | 1.2 | 1.2 | 1.2 |
| Eval- | Rubber strength index | 100 | 106 | 101 | 101 | 107 | 105 | 106 | 106 | 115 |
| uation | Low-heat-build-up property | 100 | 88 | 132 | 131 | 127 | 129 | 132 | 110 | 127 |
| | index | | | | | | | | | |
| | Handling performance | 100 | 93 | 137 | 136 | 132 | 134 | 137 | 118 | 132 |
| | Braking performance on ice | 100 | 102 | 116 | 113 | 110 | 115 | 118 | 88 | 101 |
| | Abrasion resistance index | 100 | 97 | 104 | 100 | 102 | 102 | 105 | 83 | 103 |
| | Wet-grip performance index | 100 | 96 | 112 | 114 | 121 | 112 | 114 | 130 | 102 |
| | Dry handling stability | 4 | 4 | 4.25 | 4.25 | 4 | 4.25 | 4.5 | 4.5 | 4.25 |

TABLE 23
Examples in which a compound represented by the formula (IIIb) is used as a terminal modifier

| | | Example | | | | | | | | | Comparative Example | | | | | |
|---|---|---|---|---|---|---|---|---|---|---|---|---|---|---|---|---|
| | | 127 | 128 | 129 | 130 | 131 | 132 | 133 | 134 | 135 | 61 | 45 | 48 | 49 | 50 | 62 |
| Formu- | Copolymer (8) | — | — | — | — | — | — | — | — | — | — | 20 | — | — | — | — |
| lation | Copolymer (12) | — | — | — | — | — | — | — | — | — | — | — | 20 | — | — | — |
| (parts by | Copolymer (14) | — | — | — | — | — | — | — | — | — | — | — | — | 20 | — | — |
| mass) | Copolymer (15) | — | — | — | — | — | — | — | — | — | — | — | — | — | 20 | 10 |
| | Copolymer (19) | — | — | — | — | — | — | — | — | — | — | — | — | — | — | 10 |
| | Copolymer (33) | 20 | — | — | — | — | — | — | — | — | — | — | — | — | — | — |
| | Copolymer (34) | — | 20 | — | — | — | — | — | — | — | — | — | — | — | — | — |
| | Copolymer (35) | — | — | 20 | — | — | — | — | — | — | — | — | — | — | — | — |
| | Copolymer (36) | — | — | — | 20 | — | — | — | — | — | — | — | — | — | — | — |
| | Copolymer (37) | — | — | — | — | 20 | — | — | — | — | — | — | — | — | — | — |
| | Copolymer (38) | — | — | — | — | — | 20 | — | — | — | — | — | — | — | — | — |
| | Copolymer (39) | — | — | — | — | — | — | 20 | — | — | — | — | — | — | — | — |
| | Copolymer (40) | — | — | — | — | — | — | — | 20 | — | — | — | — | — | — | — |
| | Copolymer (41) | — | — | — | — | — | — | — | — | 20 | — | — | — | — | — | — |
| | Copolymer (42) | — | — | — | — | — | — | — | — | — | 20 | — | — | — | — | — |
| | Natural rubber | 40 | 40 | 40 | 40 | 40 | 40 | 40 | 40 | 40 | 40 | 40 | 40 | 40 | 40 | 40 |
| | High-cis polybutadiene | 40 | 40 | 40 | 40 | 40 | 40 | 40 | 40 | 40 | 40 | 40 | 40 | 40 | 40 | 40 |
| | Silica A | 75 | 75 | 75 | 75 | 75 | 75 | 75 | 75 | 75 | 75 | 75 | 75 | 75 | 75 | 75 |
| | Silane coupling agent A | 6 | 6 | 6 | 6 | 6 | 6 | 6 | 6 | 6 | 6 | 6 | 6 | 6 | 6 | 6 |
| | Carbon black | 5 | 5 | 5 | 5 | 5 | 5 | 5 | 5 | 5 | 5 | 5 | 5 | 5 | 5 | 5 |
| | Oil | 40 | 40 | 40 | 40 | 40 | 40 | 40 | 40 | 40 | 40 | 40 | 40 | 40 | 40 | 40 |
| | Coumarone indene resin 1 | 5 | 5 | 5 | 5 | 5 | 5 | 5 | 5 | 5 | 5 | 5 | 5 | 5 | 5 | 5 |
| | (Tg: 90° C.) | | | | | | | | | | | | | | | |
| | Coumarone indene resin 2 | — | — | — | — | — | — | — | — | — | — | — | — | — | — | — |
| | (Tg: 10° C.) | | | | | | | | | | | | | | | |
| | Coumarone indene resin 3 | — | — | — | — | — | — | — | — | — | — | — | — | — | — | — |
| | (Tg: −30° C.) | | | | | | | | | | | | | | | |
| | α-Methyl styrene resin | — | — | — | — | — | — | — | — | — | — | — | — | — | — | — |
| | (Tg: 95° C.) | | | | | | | | | | | | | | | |
| | Antioxidant | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 |
| | Stearic acid | 2 | 2 | 2 | 2 | 2 | 2 | 2 | 2 | 2 | 2 | 2 | 2 | 2 | 2 | 2 |
| | Zinc oxide | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 |
| | Wax | 1 | 1 | 1 | 1 | 1 | 1 | 1 | 1 | 1 | 1 | 1 | 1 | 1 | 1 | 1 |
| | Sulfur | 2 | 2 | 2 | 2 | 2 | 2 | 2 | 2 | 2 | 2 | 2 | 2 | 2 | 2 | 2 |
| | Vulcanization accelerator 1 | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 |
| | Vulcanization accelerator 2 | 1.2 | 1.2 | 1.2 | 1.2 | 1.2 | 1.2 | 1.2 | 1.2 | 1.2 | 1.2 | 1.2 | 1.2 | 1.2 | 1.2 | 1.2 |
| Eval- | Rubber strength index | 102 | 103 | 101 | 101 | 101 | 101 | 101 | 101 | 100 | 103 | 100 | 106 | 101 | 100 | 97 |
| uation | Low-heat-build-up property | 118 | 122 | 108 | 106 | 107 | 109 | 108 | 109 | 102 | 118 | 100 | 88 | 100 | 94 | 105 |
| | index | | | | | | | | | | | | | | | |
| | Handling performance | 120 | 125 | 109 | 108 | 107 | 112 | 109 | 111 | 104 | 120 | 100 | 93 | 105 | 99 | 107 |
| | Braking performance on ice | 103 | 104 | 110 | 105 | 106 | 103 | 104 | 105 | 107 | 100 | 100 | 102 | 104 | 98 | 98 |
| | Abrasion resistance index | 110 | 110 | 109 | 119 | 109 | 108 | 118 | 112 | 115 | 100 | 100 | 97 | 93 | 92 | 108 |
| | Wet-grip performance index | 106 | 107 | 114 | 109 | 111 | 108 | 107 | 109 | 111 | 102 | 100 | 96 | 96 | 97 | 98 |
| | Dry handling stability | 4 | 4 | 4 | 4 | 4 | 4 | 4 | 4 | 4 | 4 | 4 | 4 | 4 | 4 | 3.5 |

TABLE 24
Examples in which a compound containing an alkoxysilyl group, a
nitrogen atom and a carbonyl group is used as a terminal modifier

| | | Example | | | | | | | Comparative Example | | | | | |
|---|---|---|---|---|---|---|---|---|---|---|---|---|---|---|
| | | 136 | 137 | 138 | 139 | 140 | 141 | 142 | 63 | 45 | 48 | 49 | 50 | 64 |
| Formu- | Copolymer (8) | — | — | — | — | — | — | — | — | 20 | — | — | — | — |
| lation | Copolymer (12) | — | — | — | — | — | — | — | — | — | 20 | — | — | — |
| (parts by | Copolymer (14) | — | — | — | — | — | — | — | — | — | — | 20 | — | — |
| mass) | Copolymer (15) | — | — | — | — | — | — | — | — | — | — | — | 20 | 10 |
| | Copolymer (19) | — | — | — | — | — | — | — | — | — | — | — | — | 10 |
| | Copolymer (43) | 20 | — | — | — | — | — | — | — | — | — | — | — | — |
| | Copolymer (44) | — | 20 | — | — | — | — | — | — | — | — | — | — | — |
| | Copolymer (45) | — | — | 20 | — | — | — | — | — | — | — | — | — | — |
| | Copolymer (46) | — | — | — | 20 | — | — | — | — | — | — | — | — | — |
| | Copolymer (47) | — | — | — | — | 20 | — | — | — | — | — | — | — | — |
| | Copolymer (48) | — | — | — | — | — | 20 | — | — | — | — | — | — | — |
| | Copolymer (49) | — | — | — | — | — | — | 20 | — | — | — | — | — | — |
| | Copolymer (50) | — | — | — | — | — | — | — | 20 | — | — | — | — | — |
| | Natural rubber | 40 | 40 | 40 | 40 | 40 | 40 | 40 | 40 | 40 | 40 | 40 | 40 | 40 |
| | High-cis polybutadiene | 40 | 40 | 40 | 40 | 40 | 40 | 40 | 40 | 40 | 40 | 40 | 40 | 40 |
| | Silica A | 75 | 75 | 75 | 75 | 75 | 75 | 75 | 75 | 75 | 75 | 75 | 75 | 75 |
| | Silane coupling agent A | 6 | 6 | 6 | 6 | 6 | 6 | 6 | 6 | 6 | 6 | 6 | 6 | 6 |
| | Carbon black | 5 | 5 | 5 | 5 | 5 | 5 | 5 | 5 | 5 | 5 | 5 | 5 | 5 |
| | Oil | 40 | 40 | 40 | 40 | 40 | 40 | 40 | 40 | 40 | 40 | 40 | 40 | 40 |
| | Coumarone indene resin 1 | 5 | 5 | 5 | 5 | 5 | 5 | 5 | 5 | 5 | 5 | 5 | 5 | 5 |
| | (Tg: 90° C.) | | | | | | | | | | | | | |
| | Coumarone indene resin 2 | — | — | — | — | — | — | — | — | — | — | — | — | — |
| | (Tg: 10° C.) | | | | | | | | | | | | | |
| | Coumarone indene resin 3 | — | — | — | — | — | — | — | — | — | — | — | — | — |
| | (Tg: −30° C.) | | | | | | | | | | | | | |
| | α-Methyl styrene resin | — | — | — | — | — | — | — | — | — | — | — | — | — |
| | (Tg: 95° C.) | | | | | | | | | | | | | |
| | Antioxidant | 1.5 | 1.5 | 1.5 | 1.5 | 1.5 | 1.5 | 1.5 | 1.5 | 1.5 | 1.5 | 1.5 | 1.5 | 1.5 |
| | Stearic acid | 2 | 2 | 2 | 2 | 2 | 2 | 2 | 2 | 2 | 2 | 2 | 2 | 2 |
| | Zinc oxide | 2.5 | 2.5 | 2.5 | 2.5 | 2.5 | 2.5 | 2.5 | 2.5 | 2.5 | 2.5 | 2.5 | 2.5 | 2.5 |
| | Wax | 1 | 1 | 1 | 1 | 1 | 1 | 1 | 1 | 1 | 1 | 1 | 1 | 1 |
| | Sulfur | 2 | 2 | 2 | 2 | 2 | 2 | 2 | 2 | 2 | 2 | 2 | 2 | 2 |
| | Vulcanization accelerator 1 | 1.8 | 1.8 | 1.8 | 1.8 | 1.8 | 1.8 | 1.8 | 1.8 | 1.8 | 1.8 | 1.8 | 1.8 | 1.8 |
| | Vulcanization accelerator 2 | 1.2 | 1.2 | 1.2 | 1.2 | 1.2 | 1.2 | 1.2 | 1.2 | 1.2 | 1.2 | 1.2 | 1.2 | 1.2 |
| Eval- | (Rubber strength index | 104 | 103 | 104 | 104 | 105 | 103 | 103 | 100 | 100 | 106 | 101 | 100 | 97 |
| uation | Low-heat-build-up property | 105 | 103 | 106 | 106 | 107 | 104 | 104 | 105 | 100 | 88 | 100 | 94 | 106 |
| | index | | | | | | | | | | | | | |
| | Handling performance | 107 | 105 | 108 | 107 | 108 | 105 | 105 | 106 | 100 | 93 | 105 | 99 | 108 |
| | Braking performance on ice | 104 | 107 | 106 | 108 | 109 | 108 | 110 | 100 | 100 | 102 | 104 | 98 | 98 |
| | Abrasion resistance index | 113 | 112 | 108 | 109 | 110 | 108 | 109 | 103 | 100 | 97 | 93 | 92 | 108 |
| | Wet-grip performance index | 107 | 113 | 111 | 114 | 115 | 113 | 115 | 104 | 100 | 96 | 96 | 97 | 98 |
| | Dry handling stability | 4 | 4 | 4 | 4 | 4 | 4 | 4 | 4 | 4 | 4 | 4 | 4 | 3.5 |

TABLE 25
Examples in which an N,N-dialkyl-substituted carboxylic acid amide dialkyl acetal compound is used as a terminal modifier

| | | Example | | | | | | | Comparative Example | | | | | |
|---|---|---|---|---|---|---|---|---|---|---|---|---|---|---|
| | | 143 | 144 | 145 | 146 | 147 | 148 | 149 | 65 | 45 | 48 | 49 | 50 | 66 |
| Formu- | Copolymer (8) | — | — | — | — | — | — | — | — | 20 | — | — | — | — |
| lation | Copolymer (12) | — | — | — | — | — | — | — | — | — | 20 | — | — | — |
| (parts by | Copolymer (14) | — | — | — | — | — | — | — | — | — | — | 20 | — | — |
| mass) | Copolymer (15) | — | — | — | — | — | — | — | — | — | — | — | 20 | 10 |
| | Copolymer (19) | — | — | — | — | — | — | — | — | — | — | — | — | 10 |
| | Copolymer (51) | 20 | — | — | — | — | — | — | — | — | — | — | — | — |
| | Copolymer (52) | — | 20 | — | — | — | — | — | — | — | — | — | — | — |
| | Copolymer (53) | — | — | 20 | — | — | — | — | — | — | — | — | — | — |
| | Copolymer (54) | — | — | — | 20 | — | — | — | — | — | — | — | — | — |
| | Copolymer (55) | — | — | — | — | 20 | — | — | — | — | — | — | — | — |
| | Copolymer (56) | — | — | — | — | — | 20 | — | — | — | — | — | — | — |
| | Copolymer (57) | — | — | — | — | — | — | 20 | — | — | — | — | — | — |
| | Copolymer (58) | — | — | — | — | — | — | — | 20 | — | — | — | — | — |
| | Natural rubber | 40 | 40 | 40 | 40 | 40 | 40 | 40 | 40 | 40 | 40 | 40 | 40 | 40 |
| | High-cis polybutadiene | 40 | 40 | 40 | 40 | 40 | 40 | 40 | 40 | 40 | 40 | 40 | 40 | 40 |
| | Silica A | 75 | 75 | 75 | 75 | 75 | 75 | 75 | 75 | 75 | 75 | 75 | 75 | 75 |
| | Silane coupling agent A | 6 | 6 | 6 | 6 | 6 | 6 | 6 | 6 | 6 | 6 | 6 | 6 | 6 |
| | Carbon black | 5 | 5 | 5 | 5 | 5 | 5 | 5 | 5 | 5 | 5 | 5 | 5 | 5 |
| | Oil | 40 | 40 | 40 | 40 | 40 | 40 | 40 | 40 | 40 | 40 | 40 | 40 | 40 |
| | Coumarone indene resin 1 | 5 | 5 | 5 | 5 | 5 | 5 | 5 | 5 | 5 | 5 | 5 | 5 | 5 |
| | (Tg: 90° C.) | | | | | | | | | | | | | |
| | Coumarone indene resin 2 | — | — | — | — | — | — | — | — | — | — | — | — | — |
| | (Tg: 10° C.) | | | | | | | | | | | | | |
| | Coumarone indene resin 3 | — | — | — | — | — | — | — | — | — | — | — | — | — |
| | (Tg: −30° C.) | | | | | | | | | | | | | |
| | α-Methyl styrene resin | — | — | — | — | — | — | — | — | — | — | — | — | — |
| | (Tg: 95° C.) | | | | | | | | | | | | | |
| | Antioxidant | 1.5 | 1.5 | 1.5 | 1.5 | 1.5 | 1.5 | 1.5 | 1.5 | 1.5 | 1.5 | 1.5 | 1.5 | 1.5 |
| | Stearic acid | 2 | 2 | 2 | 2 | 2 | 2 | 2 | 2 | 2 | 2 | 2 | 2 | 2 |
| | Zinc oxide | 2.5 | 2.5 | 2.5 | 2.5 | 2.5 | 2.5 | 2.5 | 2.5 | 2.5 | 2.5 | 2.5 | 2.5 | 2.5 |
| | Wax | 1 | 1 | 1 | 1 | 1 | 1 | 1 | 1 | 1 | 1 | 1 | 1 | 1 |
| | Sulfur | 2 | 2 | 2 | 2 | 2 | 2 | 2 | 2 | 2 | 2 | 2 | 2 | 2 |
| | Vulcanization accelerator 1 | 1.8 | 1.8 | 1.8 | 1.8 | 1.8 | 1.8 | 1.8 | 1.8 | 1.8 | 1.8 | 1.8 | 1.8 | 1.8 |
| | Vulcanization accelerator 2 | 1.2 | 1.2 | 1.2 | 1.2 | 1.2 | 1.2 | 1.2 | 1.2 | 1.2 | 1.2 | 1.2 | 1.2 | 1.2 |
| Eval- | Rubber strength index | 104 | 104 | 104 | 104 | 105 | 101 | 103 | 100 | 100 | 106 | 101 | 100 | 97 |
| uation | Low-heat-build-up property | 105 | 105 | 104 | 105 | 108 | 102 | 103 | 104 | 100 | 88 | 100 | 94 | 106 |
| | index | | | | | | | | | | | | | |
| | Handling performance | 106 | 107 | 105 | 105 | 110 | 103 | 104 | 105 | 100 | 93 | 105 | 99 | 106 |
| | Braking performance on ice | 102 | 108 | 111 | 109 | 113 | 109 | 110 | 101 | 100 | 102 | 104 | 98 | 98 |
| | Abrasion resistance index | 114 | 113 | 109 | 108 | 109 | 108 | 108 | 104 | 100 | 97 | 93 | 92 | 108 |
| | Wet-grip performance index | 106 | 111 | 115 | 112 | 117 | 112 | 114 | 103 | 100 | 96 | 96 | 97 | 98 |
| | Dry handling stability | 4 | 4 | 4 | 4 | 4 | 4 | 4 | 4 | 4 | 4 | 4 | 4 | 4 |

As shown in Tables 6 to 25, since each of the rubber compositions of the examples contains a specific amount of a conjugated diene copolymer having a specific amine structure at an initiation terminal, a structural unit derived from a silicon-containing compound at a main chain, and a structural unit derived from a compound containing a nitrogen atom and/or a silicon atom at a termination terminal, a specific amount of a high-cis polybutadiene having a cis microstructure content of not less than 95% by mass, a specific amount of a polyisoprene-based rubber, a specific amount of a silica, and a specific amount of a mercapto group-containing silane coupling agent, these rubber compositions exhibited balanced improvements in performance on ice and snow, abrasion resistance, rubber strength, fuel economy, wet-grip performance, and dry handling stability, as compared to the rubber compositions of the comparative examples. Moreover, the comparison between the conjugated diene polymer in which the three sites, the initiation terminal, main chain, and termination terminal, are modified by specific compounds, and a copolymer in which only one of the initiation terminal, main chain, and termination terminal is modified shows that the modification of the three sites, the initiation terminal, main chain, and termination terminal, synergistically increases the effects of improving those properties.

The rubber composition of Example 28, which contains the conjugated diene polymer mercapto group together with a mercapto group-containing silane coupling agent, two kinds of silica having specific nitrogen adsorption specific surface areas, and a solid resin having a specific glass transition temperature, exhibited particularly better properties than those in the other examples.

Each of the rubber compositions of Comparative Example 8, 29, and 52 contains, instead of the conjugated diene polymer, the copolymer (17) which has a structural unit derived from a silicon-containing compound at a main chain and a structural unit derived from a compound containing a nitrogen atom and/or a silicon atom at a termination terminal but does not have a specific amine structure at an initiation terminal. Thus, these rubber compositions exhibited inferior properties to those in the examples, and even had poorer abrasion resistance than that of the respective standard comparative examples.

1. A rubber composition, comprising:
a conjugated diene polymer,
a high-cis polybutadiene having a cis microstructure content of not less than 95% by mass,
a polyisoprene-based rubber, and
a silica having a nitrogen adsorption specific surface area of 40 to 400 m²/g,
the conjugated diene polymer being obtained by polymerizing a monomer component including a conjugated diene compound and a silicon-containing vinyl compound in the presence of a polymerization initiator represented by the following formula (I): 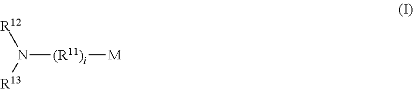
wherein i represents 0 or 1; R¹¹ represents a C₁₋₁₀₀ hydrocarbylene group; R¹² and R¹³ each represent an optionally substituted hydrocarbyl group or a trihydrocarbylsilyl group, or R¹² and R¹³ are bonded to each other to form a hydrocarbylene group optionally containing at least one, as a hetero atom, selected from the group consisting of a silicon atom, a nitrogen atom, and an oxygen atom; and M represents an alkali metal atom, to produce a copolymer, and
then reacting a compound containing at least one of a nitrogen atom and a silicon atom with an active terminal of the copolymer,
wherein the rubber composition comprises, based on 100% by mass of a rubber component, 1 to 45% by mass of the conjugated diene polymer, 20 to 64% by mass of the high-cis polybutadiene, and 35 to 60% by mass of the polyisoprene-based rubber, and
the rubber composition comprises 5 to 150 parts by mass of the silica for each 100 parts by mass of the rubber component.

2. The rubber composition according to claim 1,
wherein R¹¹ in the formula (I) is a group represented by the following formula (Ia): 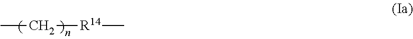
wherein R¹⁴ represents a hydrocarbylene group comprising at least one of a structural unit derived from a conjugated diene compound and a structural unit derived from an aromatic vinyl compound; and n represents an integer of 1 to 10.

3. The rubber composition according to claim 2,
wherein R¹⁴ in the formula (Ia) is a hydrocarbylene group comprising from one to ten isoprene-derived structural unit(s).

4. The rubber composition according to claim 1,
wherein the silicon-containing vinyl compound is a compound represented by the following formula (II): 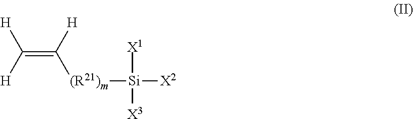
wherein m represents 0 or 1; R²¹ represents a hydrocarbylene group; and X¹, X², and X³ each represent a substituted amino group, a hydrocarbyloxy group, or an optionally substituted hydrocarbyl group.

5. The rubber composition according to claim 1,
wherein the conjugated diene polymer contains a structural unit derived from an aromatic vinyl compound.

6. The rubber composition according to claim 1,
wherein the silica includes silica (1) having a nitrogen adsorption specific surface area of at least 40 m²/g but less than 120 m²/g, and silica (2) having a nitrogen adsorption specific surface area of not less than 120 m²/g.

7. The rubber composition according to claim 1, comprising
a solid resin having a glass transition temperature of 60 to 120° C. in an amount of 1 to 30 parts by mass for each 100 parts by mass of the rubber component.

8. The rubber composition according to claim 1,
wherein the silica includes silica (1) having a nitrogen adsorption specific surface area of at least 40 m²/g but less than 120 m²/g, and silica (2) having a nitrogen adsorption specific surface area of not less than 120 m²/g, and
the rubber composition comprises a solid resin having a glass transition temperature of 60 to 120° C. in an amount of 1 to 30 parts by mass for each 100 parts by mass of the rubber component.

9. The rubber composition according to claim 1, comprising
a mercapto group-containing silane coupling agent in an amount of 0.5 to 20 parts by mass for each 100 parts by mass of the silica.

10. The rubber composition according to claim 1,
wherein the rubber composition comprises a mercapto group-containing silane coupling agent in an amount of 0.5 to 20 parts by mass for each 100 parts by mass of the silica, and
the silica includes silica (1) having a nitrogen adsorption specific surface area of at least 40 m²/g but less than 120 m²/g, and silica (2) having a nitrogen adsorption specific surface area of not less than 120 m²/g.

11. The rubber composition according to claim 1, comprising
a mercapto group-containing silane coupling agent in an amount of 0.5 to 20 parts by mass for each 100 parts by mass of the silica, and
a solid resin having a glass transition temperature of 60 to 120° C. in an amount of 1 to 30 parts by mass for each 100 parts by mass of the rubber component.

12. The rubber composition according to claim 1,
wherein the rubber composition comprises a mercapto group-containing silane coupling agent in an amount of 0.5 to 20 parts by mass for each 100 parts by mass of the silica,
the silica includes silica (1) having a nitrogen adsorption specific surface area of at least 40 m²/g but less than 120 m²/g, and silica (2) having a nitrogen adsorption specific surface area of not less than 120 m²/g, and
the rubber composition comprises a solid resin having a glass transition temperature of 60 to 120° C. in an amount of 1 to 30 parts by mass for each 100 parts by mass of the rubber component.

13. The rubber composition according to claim 1,
wherein the rubber composition comprises a mercapto group-containing silane coupling agent in an amount of 0.5 to 20 parts by mass for each 100 parts by mass of the silica, and
the silane coupling agent is at least one of a compound represented by the formula (1) below, and a compound containing a linking unit A represented by the formula (2) below and a linking unit B represented by the formula (3) below, 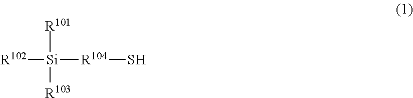
wherein R¹⁰¹ to R¹⁰³ each represent a branched or unbranched C₁₋₁₂ alkyl group, a branched or unbranched C₁₋₁₂ alkoxy group, or a group represented by —O—(R¹¹¹—O)_{z}—R¹¹² where z R¹¹¹s each represent a branched or unbranched C₁₋₃₀ divalent hydrocarbon group, and z R¹¹¹s may be the same as or different from one another; R¹¹² represents a branched or unbranched C₁₋₃₀ alkyl group, a branched or unbranched C₂₋₃₀ alkenyl group, a C₆₋₃₀ aryl group, or a C₇₋₃₀ aralkyl group; and z represents an integer of 1 to 30, and R¹⁰¹ to R¹⁰³ may be the same as or different from one another; and R¹⁰⁴ represents a branched or unbranched C₁₋₆ alkylene group; 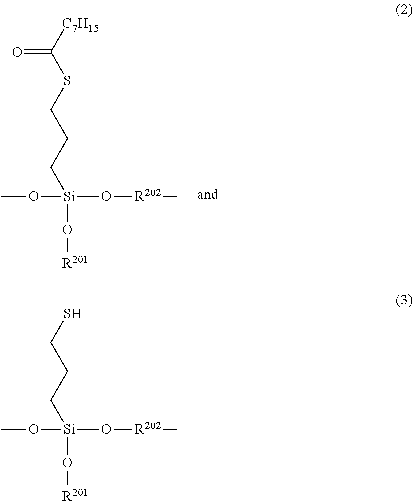
wherein R²⁰¹ represents a hydrogen atom, a halogen atom, a branched or unbranched C₁₋₃₀ alkyl group, a branched or unbranched C₂₋₃₀ alkenyl group, a branched or unbranched C₂₋₃₀ alkynyl group, or the alkyl group in which a terminal hydrogen atom is replaced with a hydroxy group or a carboxyl group; R²⁰² represents a branched or unbranched C₁₋₃₀ alkylene group, a branched or unbranched C₂₋₃₀ alkenylene group, or a branched or unbranched C₂₋₃₀ alkynylene group; and R²⁰¹ and R²⁰² may be joined together to form a cyclic structure.

14. The rubber composition according to claim 1,
wherein the silica includes silica (1) having a nitrogen adsorption specific surface area of at least 40 m²/g but less than 120 m²/g, and silica (2) having a nitrogen adsorption specific surface area of not less than 120 m²/g, and
the nitrogen adsorption specific surface areas and amounts of the silica (1) and the silica (2) satisfy the following inequalities:
(Nitrogen adsorption specific surface area of silica (2))/(Nitrogen adsorption specific surface area of silica (1))≧1.4, and
(Amount of silica (1))×0.06≦(Amount of silica (2))≦(Amount of silica (1))×15.

15. The rubber composition according to claim 1, which is for use in a tread of a studless winter tire.

16. A studless winter tire, formed from the rubber composition according to claim 1.

17. The rubber composition according to claim 2,
wherein the silicon-containing vinyl compound is a compound represented by the following formula (II): 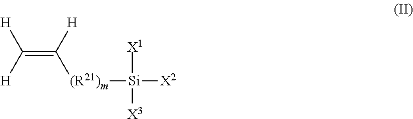
wherein m represents 0 or 1; R²¹ represents a hydrocarbylene group; and X¹, X², and X³ each represent a substituted amino group, a hydrocarbyloxy group, or an optionally substituted hydrocarbyl group.

18. The rubber composition according to claim 3,
wherein the silicon-containing vinyl compound is a compound represented by the following formula (II): 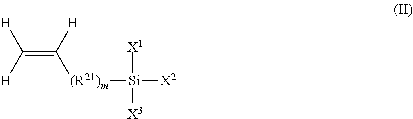
wherein m represents 0 or 1; R²¹ represents a hydrocarbylene group; and X¹, X², and X³ each represent a substituted amino group, a hydrocarbyloxy group, or an optionally substituted hydrocarbyl group.

19. The rubber composition according to claim 2,
wherein the conjugated diene polymer contains a structural unit derived from an aromatic vinyl compound.

20. The rubber composition according to claim 3,
wherein the conjugated diene polymer contains a structural unit derived from an aromatic vinyl compound.
